(19) United States
(12) Patent Application Publication
(10) Pub. No.: US 2019/0005421 A1
(43) Pub. Date: Jan. 3, 2019

(54) UTILIZING VOICE AND METADATA ANALYTICS FOR ENHANCING PERFORMANCE IN A CALL CENTER

(71) Applicant: Rank Miner Inc., Saint Petersburg, FL (US)

(72) Inventors: Erik Hammel, Tampa, FL (US); Bruce Peoples, Kissimmee, FL (US); Preston Faykus, Saint Petersburg, FL (US)

(73) Assignee: RankMiner Inc., Saint Petersburg, FL (US)

(21) Appl. No.: 16/019,908

(22) Filed: Jun. 27, 2018

Related U.S. Application Data
(60) Provisional application No. 62/525,924, filed on Jun. 28, 2017.

(51) Int. Cl. G06Q 10/06; H04M 3/51; G06F 15/18

(52) U.S. Cl. CPC G06Q 10/067; H04M 3/5175; G06F 15/18; G06Q 10/06393; H04M 3/5183

(57) ABSTRACT

A system and methods for utilizing automated machine learning techniques to dynamically analyze historical and current business data including call metadata, dynamically analyze actual voice interactions based on feature vectors associated with voice, and to dynamically utilize the derived information to accurately predict or evaluate business performance.

### CROSS REFERENCE TO RELATED APPLICATIONS

This application claims the benefit of U.S. Provisional Application No. 62/525,924 filed Jun. 28, 2017, the entire contents of which are incorporated herein by reference.

### BACKGROUND

Call Centers are business entities primarily focused on sales, collections, and customer service activities. Conventional call centers utilize several methods of implementing these activities such as e-mails, direct mail, social media, and web browser interactions. The primary method remains voice interactions between company Floor Agents and Customers.

Call Centers deal with both in-coming and out-going calls. In-coming calls are calls primarily concerned about complaints, sales, and requests coming from a large number of clients. Out-going calls are primarily concentrated around operations focused on various forms of debt collection, sales, marketing and customer surveys. These conversations can support several business processes, such as customer retention, sales, debt collection, fraud management, Floor Agent performance etc. For instance, in the case of an out-bound call debt collection business process, the Floor Agent confirms with a client a debt owed and attempts to collect on a debt. Inherent in the collection business process is not only what information is exchanged between the Floor Agent and the client, but also how the Floor Agent communicates with the client during the communication process. The how of the communication process is also known as the emotional behavior pattern and is rarely analyzed. In instances where the emotional behavior aspect is analyzed by a Call Center, the analysis process is usually a subjective analysis process performed by a human on a text version of the voices contained in the audio portion of the call. Additionally, conventional Call Centers do not analyze emotional behavior patterns in correlation with other available business data such as Caller ID, Agent ID, Campaign Codes, Books of Business, etc.

### SUMMARY

Briefly described, and according to one embodiment, aspects of the present disclosure generally relate to systems and methods for automated analysis of voice data contained in live or recorded audio calls, automated analysis of business data, automated cross validation analysis of voice data and business data, automated creation of data points and rule sets used to create data points, dynamic creation, training and selecting policies (models) to enhance a business process, automated implementation of selected policies, and/or dynamic update of policies over time.

According to one embodiment, the method begins with an automated process to perform data analysis. This concept comprises dynamically determining the Raw Feature Space from structured data, that may include but not limited to call data, call metadata, phone agent data, customer data, and any other pertinent sources, and/or unstructured data that may include but not limited to data related to voices contained in audio files. In certain embodiments, some structured data may become classified as Non-Feature Data, data used for filtering and correlating structured and unstructured data. Non-Feature Data may include but is not limited to audio file names, prediction classes, competency levels, books of business, etc. In certain embodiments, the system may store the Raw Feature Space and Non-Feature Data in a Knowledge Base.

In certain embodiments, the system may expand the Raw Feature Space by generating Derived Features. Derived Features comprise mathematical combinations of existing features in the Raw Feature Space. In one embodiment, the ensemble of calculations performed by the system to expand the Raw Feature Space is determined by one or more Initial Feature Derivation Ruleset(s). In certain embodiments, the system may store and maintain any and all Ruleset(s) within an Initial Master Rule Set. In certain embodiments, the system may update the Initial Master Rule Set contained in the Knowledge Base with utilized Initial Feature Derivation Ruleset(s). In certain embodiments, there may be multiple Derived Features. In certain embodiments, the system may update the Initial Feature Derivation Ruleset(s) contained in the Knowledge Base with utilized Initial Feature Derivation Ruleset(s). In certain embodiments, the system may expand the Raw Feature Space contained in the Knowledge Base to include Derived Feature(s).

In certain embodiments, there may be a grouped set of values within the unstructured data. Values may be grouped with respect to aspects including but not limited to signal-based characteristics such as frequency, waveform envelope, and temporal proximity, emotion-based characteristics such as valence, intensity, and complexity, and prosodic-based characteristics such as key shifts, pitch prominence, and pause patterns. In certain embodiments, the system selects and performs calculations to transform a grouped set of values identified in a call to a Singular Derived Feature. In one embodiment, the ensemble of calculations performed by the system to transform a grouped set of values within the unstructured data into a Singular Derived Feature in the Raw Feature Space is determined by one or more Initial Transformation Ruleset(s). In another embodiment, there may be multiple grouped sets of values within the unstructured data. In certain embodiments, the system selects and performs calculations to transform multiple grouped sets of values within the unstructured data into a series of Singular Derived Features. In one embodiment, the ensemble of calculations performed by the system on multiple grouped sets of values within the unstructured data is determined by one or more Initial Transformation Ruleset(s). In certain embodiments, the system may update the Initial Master Rule Set contained in the Knowledge Base with the Initial Transformation Ruleset(s) utilized. In certain embodiments, the system may expand the Raw Feature Space contained in the Knowledge Base to include Singular Derived Feature(s).

In certain embodiments, the Raw Feature Space is then dynamically analyzed in the context of Non-Feature Data to determine an Initial Feature Set which in turn describes individual feature vectors. In certain embodiments, not all Features in the Raw Feature Space will become part of the Initial Feature Set. Depending on dynamic system analysis such as correlation of features with Non-Feature Data, formation of the Initial Feature Set will vary according to the context of customer goals and business processes. In one embodiment, the determination of an Initial Feature Set is made by an Initial Feature Selection Ruleset. In certain embodiments, the system may update the Initial Master Rule Set contained in the Knowledge Base with the Initial Feature Selection Ruleset utilized. In certain embodiments, the system may store the Initial Feature Set in the Knowledge Base. In certain embodiments, the system may store the individual feature vectors in the Knowledge Base.

In certain embodiments, the system may align feature vectors with Prediction Classes. Prediction Classes comprise mathematical values designating a correct outcome or desired descriptor, also known as labels, targets, desired outputs, supervisory signals, response variables, or explained variables. In one embodiment, the system may utilize one or more Initial Mapping Ruleset(s) to align feature vectors with Prediction Classes. In certain embodiments, the Initial Mapping Ruleset defines the needed context(s) for determining Initial Data Points. In certain embodiments, the system may update the Initial Master Rule Set contained in the Knowledge Base with Initial Mapping Ruleset(s). In certain embodiments, the system may update the feature vectors contained in the Knowledge Base.

In certain embodiments, the system may identify an Initial Data Point as a single feature vector or an aggregate of feature vectors. In one embodiment, the system may designate a single feature vector as an Initial Data Point. In certain embodiments, the system may store the Initial Data Point in the Knowledge Base. In another embodiment, an Initial Data Point may be constructed by aggregating feature vectors. In this embodiment, feature vectors are aggregated corresponding to a specific Non-Feature Data value or range of values. In this embodiment, Initial Data Points are determined by the system utilizing one or more Initial Aggregation Ruleset(s). In certain embodiments, the system may store the Initial Data Point in the Knowledge Base. In certain embodiments, the Initial Aggregation Ruleset(s) also determines how many and which feature vectors to include in the creation of a particular Initial Data Point. In one embodiment, the system may update the Initial Master Rule Set contained in the Knowledge Base with Initial Aggregation Ruleset(s) utilized.

In certain embodiments, the system may dynamically identify one or more collections of Initial Data Points as Initial Data Point Structure(s). In one embodiment, the system automatically forms Initial Data Point Structure(s) by utilizing one or more Initial Data Point Structure Ruleset(s). In certain embodiments, the system may store Initial Data Point Structure(s) in a Knowledge Base. In certain embodiments, the system may update the Initial Master Rule Set contained in the Knowledge Base with Initial Data Point Structure Ruleset(s) utilized.

In certain embodiments, the system may create a mathematical model utilized as a basis for accurate prediction or evaluation using feature vectors in the Knowledge Base as input. In one embodiment, the system may utilize a learning algorithm with a fixed hyperparameter set as a basis for creating a model. In another embodiment, the system may utilize an ensemble method on multiple learning algorithms with fixed hyperparameter sets to create a model. In yet another embodiment, the system may utilize various ensemble methods on multiple learning algorithms with fixed hyperparameter sets to create multiple models. In certain embodiments, the system may store created model(s) in a Knowledge Base. In certain embodiments, the system may store utilized learning algorithm(s) in a Knowledge Base. In certain embodiments, the system may store hyperparameter set(s) in a Knowledge Base. In certain embodiments, the system may store utilized ensemble method(s) in a Knowledge Base.

In one embodiment, the system may utilize one or more Initial Data Point Structure(s) as training input to a model. In this embodiment, the output of model training is a mapping of data points to likelihoods of prediction class membership. The mapping is known as a Policy. In certain embodiments, the system may store created Policies in a Knowledge Base. In certain embodiments, the system may utilize one or more Initial Data Point Structure(s) as training input to multiple models. In this embodiment, the output of training multiple models is multiple Policies. In certain embodiments, the system may store created Policies in a Knowledge Base.

In certain embodiments, the system may utilize generated Policies to generate Predictive Outcomes or Evaluative Outcomes. In one embodiment, in the context of generating Predictive Outcomes, an individual Data Point used as input to a Policy is also referred to as a Prediction Point. In another embodiment, in the context of generating Evaluative Outcomes, an individual Data Point used as input to a Policy is also referred to as an Evaluation Point. In one embodiment, when the system is given a Prediction Point as input, the system dynamically applies a Policy. In this embodiment, an output is created which corresponds to a Prediction Point's most likely Predictive Outcome. Predictive Outcomes include but are not limited to possible sale of an item, possible collection of a debt, etc. In certain embodiments, the system may store generated Predictive Outcomes in a Knowledge Base. In another embodiment, when the system is given an Evaluative Point as input, the system dynamically applies a Policy. In this embodiment, an output is created which corresponds to an Evaluative Point's most likely Evaluative Outcome. Evaluative Outcomes include but are not limited to Floor Agent performance levels, Business performance, etc. In certain embodiments, the system may store generated Evaluative Outcomes in a Knowledge Base.

In certain embodiments, the system may validate generated Policies utilizing cross-validation processes. In one embodiment, the system may validate stored Predictive Policies by applying one or more Validation Data Point Structure(s) created for each Prediction Policy stored in a Knowledge Base. In this embodiment, the Validation Data Point Structure(s) may be formed in a similar manner to Initial Data Point Structures and/or as dictated by the utilized cross-validation process(s). In this embodiment, performance metrics are calculated on each set of the Predictive Outcome(s) generated by applying M number of Validation Data Point Structures to N number of Policies. In certain embodiments, the system may store performance metrics in a Knowledge Base. In another embodiment, the system may validate stored Evaluative Policies by applying one or more Validation Data Point Structures created for each Evaluative Policy stored in a Knowledge Base. In this embodiment, the Validation Data Point Structure(s) may be formed in a similar manner to Initial Data Point Structures and/or as dictated by the utilized cross-validation process(s). In this embodiment, performance metrics are calculated on each set of the Evaluative Outcome(s) generated by applying M number of Validation Data Point Structures to N number of Policies. In certain embodiments, the system may store performance metrics in a Knowledge Base.

In certain embodiments, the system may alter hyperparameter set(s) of a Predictive or Evaluative Model's learning algorithm(s) based on performance metrics. In one embodiment, the system may dynamically alter one or more Predictive Hyperparameter Set(s), to change algorithm behavior. In this embodiment, dynamic alteration of Hyperparameter Set(s) based on performance metrics may generate a new Model, resultant Predictive Policy, and performance metrics for prediction. In certain embodiments, the system may update a Knowledge Base with new Predictive Model(s). In certain embodiments, the system may update a Knowledge Base with new Predictive Policies. In certain embodiments, the system may update the Knowledge Base with new performance metrics. In another embodiment, the system may dynamically alter one or more Evaluative Hyperparameter Set(s), to change algorithm behavior. In this embodiment, dynamic alteration of Hyperparameter Set(s) may generate a new Evaluative Model, resultant Evaluative Policy, and performance metrics for evaluation. In certain embodiments, the system may update a Knowledge Base with new Evaluative Model(s). In certain embodiments, the system may update a Knowledge Base with new Evaluative Policies. In certain embodiments, the system may update the Knowledge Base with new performance metrics.

In certain embodiments, the system may dynamically add or delete learning algorithms to an existing Predictive or Evaluative Model's learning algorithm ensemble to change Predictive and/or Evaluative Policy behavior. In one embodiment, dynamic addition or deletion to an existing Predictive Model's learning algorithm ensemble may generate a new Predictive Model, resultant Predictive Policy, and performance metrics for prediction. In certain embodiments, the system may update a Knowledge Base with new Predictive Model(s). In certain embodiments, the system may update a Knowledge Base with new Predictive Policies. In certain embodiments, the system may update the Knowledge Base with new performance metrics.

In another embodiment, dynamic addition or deletion to an existing Evaluative Model's learning algorithm ensemble may generate a new Evaluative Model, resultant Evaluative Policy, and performance metrics for evaluation. In certain embodiments, the system may update a Knowledge Base with new Evaluative Model(s). In certain embodiments, the system may update a Knowledge Base with new Evaluative Policies. In certain embodiments, the system may update the Knowledge Base with new performance metrics.

In certain embodiments, the system may select and utilize another ensemble method to change Predictive and/or Evaluative Policy behavior. In one embodiment, utilization of another ensemble method may generate a new Predictive Model, resultant Predictive Policy, and performance metrics for prediction. In certain embodiments, the system may update a Knowledge Base with new Predictive Model(s). In certain embodiments, the system may update a Knowledge Base with new Predictive Policies. In certain embodiments, the system may update the Knowledge Base with new performance metrics. In certain embodiments, the system may update a Knowledge Base with the utilized ensemble method. In another embodiment, utilization of another ensemble method may generate a new Evaluative Model, resultant Evaluative Policy, and performance metrics for evaluation. In certain embodiments, the system may update a Knowledge Base with new Evaluative Model(s). In certain embodiments, the system may update a Knowledge Base with new Evaluative Policies. In certain embodiments, the system may update the Knowledge Base with new performance metrics. In certain embodiments, the system may update a Knowledge Base with the utilized ensemble method.

In certain embodiments, the system designates a Leading Candidate Policy corresponding to the best overall validation based on evaluation of generated performance metrics. In certain embodiments, the Leading Candidate Policy's performance metrics are known as the Target Function Evaluation. In certain embodiments, the system may update the Knowledge Base with the Leading Candidate Policy. In certain embodiments, the system may update the Knowledge Base with the Target Function Evaluation. In certain embodiments, the system may perform retraining on the model which produced the Leading Candidate Policy by refining one or more inputs based on Target Function Evaluation. In one embodiment, the system may utilize the Leading Candidate Policy's Target Function Evaluation as iterative feedback to dynamically determine a Refined Feature Space, Refined Feature Set(s), Refined Feature Vectors, Refined Data Points, Refined Data Point Structures, and Refined Master Rule Set (including Refined Feature Derivation Ruleset(s), Refined Transformation Ruleset(s), Refined Feature Selection Ruleset(s), Refined Mapping Ruleset(s), Refined Aggregation Ruleset(s), and/or Refined Data Point Structure Ruleset(s)). In certain embodiments, the system may store Refined Feature Space, Refined Feature Set(s), Refined Feature Vectors, Refined Data Points, Refined Data Point Structures, and Refined Master Rule Set (including Refined Feature Derivation Ruleset(s), Refined Transformation Ruleset(s), Refined Feature Selection Ruleset(s), Refined Mapping Ruleset(s), Refined Aggregation Ruleset(s), and/or Refined Data Point Structure Ruleset(s)) in a Knowledge Base. In certain embodiments, based on the refinements performed, the system may dynamically create new model(s), policy(s), Target Function Evaluation(s), and a new potential Leading Candidate Policy. In certain embodiments, the system may store new model(s), policy(s), Target Function Evaluation(s), and a new potential Leading Candidate Policy in a Knowledge Base. In certain embodiments, the system may compare Target Function Evaluation metrics generated from the previous Leading Candidate Policy training and validation iteration and the current potential Leading Candidate Policy training and validation iteration. In one embodiment, the system may accept a potential Leading Candidate Policy where Target Function Evaluation metrics increased in value. In another embodiment, the system may reject a potential Leading Candidate Policy where Target Function Evaluation metrics decreased in value. In certain embodiments, where Target Function Evaluation increases or no change in Target Function Evaluation metric values is detected by the system, the policy may be considered optimized. In certain embodiments, the system may store optimized policies in a Knowledge Base.

In certain embodiments, the system may dynamically implement one or more optimized policies for a Call Center. In one embodiment, the system may implement an Optimized Predictive Policy to produce Predictive Outcomes. In another embodiment, the system may implement an Optimized Evaluative Policy to produce Evaluative Outcomes. In certain embodiments, the system may process data and data values for evaluation by implemented policies.

In certain embodiments, based on the optimized policy utilized, the system may generate reports for use by a Call Center. In one embodiment, the system may generate predictions combined with other relevant data, known as Prediction Reports, based on a Predictive Policy. Prediction Reports may include but are not limited to a database table containing ranked predictions of entities to contact for sales, collection of debts, etc., a tabular text file containing ranked predictions of entities to contact for sales, collection of debts, etc. of a Call Center's dialing system with information on who to contact for sales, collection of debts, etc. In certain embodiments, the system may store Prediction Reports in a database. In another embodiment, the system may generate evaluations combined with other relevant data, known as Evaluation Reports, based on an Evaluative Policy. Evaluation Reports may include but are not limited to a database table containing evaluations of Floor Agent or customer emotional-based behaviors, a tabular text file containing evaluations of Floor Agent or customer emotional-based behaviors, update of a Call Center's Quality Assurance Application containing evaluations of Floor Agent or customer emotional-based behaviors, etc. In certain embodiments, the system may store Evaluation Reports in a database.

In one embodiment, the system may dynamically generate Periodic Report(s) summarizing Prediction Report(s) and recommended changes to Business Directives. In this embodiment, the system may store the Periodic Report(s) in a database. In another embodiment, the system may dynamically generate Periodic Report(s) summarizing Evaluation Report(s) and recommended changes to Business Directives. In this embodiment, the system may store the Periodic Report(s) in a database. In certain embodiments, the system may store the Periodic Report(s) in a Knowledge Base.

In certain embodiments, the system may dynamically recalibrate an optimized policy. In certain embodiments, the system may perform analysis of implemented optimized policies over time. In one embodiment, the system may use time-series analysis of the sequence of Prediction Reports for a Predictive Policy over the course of several reports. In this embodiment, time-series analysis may include but not limited to detection of large changes in prediction performance, finding unusual correlations between Structured and Unstructured data values and their Non-Feature data characteristics, etc. In certain embodiments, the system may store the time series data in a Knowledge Base. In certain embodiments, the system may store the time series data in a database. In another embodiment, the system may use time-series analysis of the sequence of Evaluation Reports for an Evaluative Policy over the course of several reports. In this embodiment, time-series analysis may include but not limited to detection of large changes in evaluative performance, finding unusual correlations between Structured and Unstructured data values and their Non-Feature data characteristics, etc. In certain embodiments, the system may store the time series data in a Knowledge Base. In certain embodiments, the system may store the time series data in a database.

In one embodiment, if the system dynamically determines recalibration of an optimized policy is necessary, the system may start with data analysis to create or modify a Refined Raw Feature Space and use the Refined Raw Feature Space as a basis of creating or modifying Refined Optimized Policies as described above. In another embodiment, the system may start with Refined Master Rule Set and adjust the Refined Master Rule Set. In this embodiment, the system may use Refined Master Rule Set as a basis for creating or modifying Refined Optimized Policies as described above.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates one embodiment of a system configured for automated analysis of voice data contained in live or recorded audio calls, automated analysis of business data, automated correlative analysis of voice data and business data, automated creation of data points and rule sets used to create data points, dynamic creation, training and selecting policies (models), automated implementation of selected policies, automated creation of prediction reports or evaluative reports, dynamic creation of periodic reports, and/or automated update of policies over time.

FIG. 2 illustrates one embodiment of an AI System Controller for management of process engines used in the methodologies.

FIG. 3 illustrates an example of a method for processing/analyzing a Call Center's Structured Data.

FIG. 4 illustrates an example of a method for processing/analyzing a Call Center's Unstructured Data.

FIG. 5 illustrates an example of a method for determining Non-Feature Data.

FIG. 6 illustrates an example of a method for expanding Raw Feature Space.

FIG. 7 illustrates an example of a method for computing Derived Feature Values from Unstructured Feature Values.

FIG. 8 illustrates an example of a method to determine an Initial Feature Set.

FIG. 9 illustrates an example of a method to determine Feature Vectors.

FIG. 10 illustrates an example of a method to Align Feature Vectors with Prediction Classes.

FIG. 11 illustrates an example of a method to create Initial Data Points from a Single Feature Vector.

FIG. 12 illustrates an example of a method to create Initial Data Points From Multiple Aligned Feature Vectors.

FIG. 13 illustrates an example of a method to create Initial Data Point Structures.

FIG. 14 illustrates an example of a method to create a Predictive or Evaluative Model using a single Learning Algorithm.

FIG. 15 illustrates an example of a method to create a Predictive or Evaluative Model using a single Ensemble Technique.

FIG. 16 illustrates an example of a method to train a Predictive or Evaluative Model.

FIG. 17 illustrates an example of a method to utilize Policies to generate Predictive Outcomes.

FIG. 18 illustrates an example of a method to utilize Policies to generate Evaluative Outcomes.

FIG. 19 illustrates an example of a method to validate Predictive Policies.

FIG. 20 illustrates an example of a method to validate Evaluative Policies.

FIG. 21 illustrates an example of a method to change Predictive Model/Policy Learning Algorithm(s) based on alteration of Hyperparameters.

FIG. 22 illustrates an example of a method to change Evaluative Model/Policy Learning Algorithm(s) based on alteration of Hyperparameters.

FIG. 23 illustrates an example of a method to change a Predictive Model/Policy by adding or deleting Learning Algorithms.

FIG. 24 illustrates an example of a method to change an Evaluative Model/Policy by adding or deleting Learning Algorithms.

FIG. 25 illustrates an example of a method to change a Predictive Model/Policy by changing Ensemble Techniques.

FIG. 26 illustrates an example of a method to change an Evaluative Model/Policy by changing Ensemble Techniques.

FIG. 27 illustrates an example of a method to identify a Leading Candidate Policy.

FIG. 28 illustrates an example of a method to perform Training Refinement.

FIG. 29 illustrates an example of a method to optimize a Policy.

FIG. 30 illustrates an example of a method to implement a Predictive Policy.

FIG. 31 illustrates an example of a method to implement an Evaluative Policy.

FIG. 32 illustrates an example of a method to generate a Periodic Report.

FIG. 33 illustrates an example of a method to recalibrate a Predictive Policy.

FIG. 34 illustrates an example of a method to recalibrate an Evaluative Policy.

FIG. 35 is a block diagram of an example computer that can perform at least a portion of the processing described herein.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for utilizing automated machine learning techniques to dynamically analyze historical and current business data including call metadata, dynamically analyze actual voice interactions based on feature vectors associated with voice, and to dynamically utilize the derived information to accurately predict or evaluate business performance.

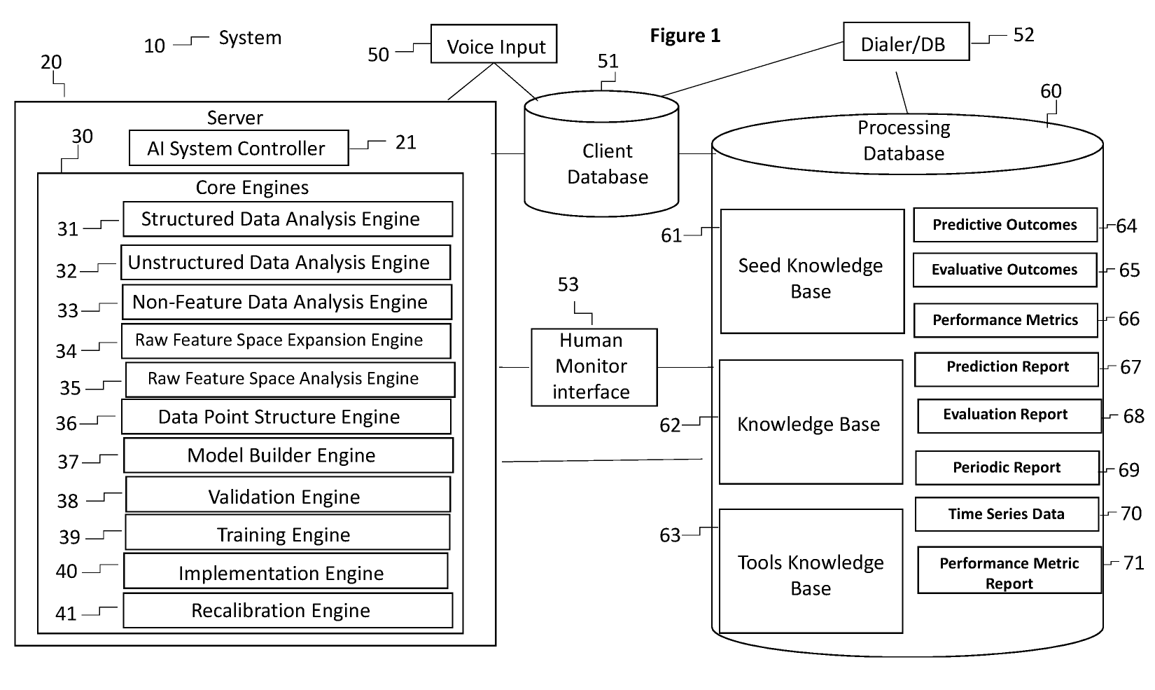

FIG. 1 illustrates one embodiment of a system 10 configured to execute methods depicted by figures. System 10 includes components found in computing devices, such as central processing units, graphic processing units, memory, non-volatile storage, interfaces, and network connections, although other components are possible for certain embodiments. Other information sources in lieu of or in addition to the servers and databases are within the scope of the claimed invention.

In the illustrative embodiment, System 10 may include, but not limited to, one or more of the following core components. 1) Server 20 used to host an Intelligent System Controller 21 and Core Engines 30, 2) Voice Input 50 used to input live voice inputs (Unstructured Data) to Server 20 and/or record live voice inputs for storage into Client Database 51. 3) Client Database 51 used to store and/or access recorded audio files (Unstructured Data) to/from Server 20 and/or Processing Database 60, Dialer/Database 42 used to access and/or store Structured Data to/from Client Database 51 and/or Processing Database 60, Human Monitor interface 53 used as an interface for human input and/or human intervention to/from Server 20 and/or Processing Database 60, and Processing Database 60 used to store/access data, information, and knowledge generated by Server 20, and/or Client Database 51, and/or Dialer Database 52, and/or Human Monitor interface 53.

In the illustrative embodiment, Server 20 may be connected to Processing Database 60 and various components in the Processing Database, Voice Input 50, Client Database 51, and Human Monitor interface 53.

In the illustrative embodiment, Processing Database may be connected to Server 20 and various components in the Server, Client Database 51, Dialer Database 52 and Human Monitor interface 53. Voice Input 50 may be connected to Server 20 and various components in the Server, and Client Database 51. Client Database 51 may be connected to Server 20 and various components in the Server, Voice Input 50, Dialer Database 52, and Processing Database 60 and various components in the Processing Database. Dialer Database 52 may be connected to Client Database 51 and Processing Database 60 and various components in the Processing Database. Human Monitor interface 53 may be connected to Server 20 and various components in the Server, and Processing Database 60 and various components in the Processing Database.

In the illustrative embodiment, Server 20 comprises various components that may include but not limited to the following: 1) AI System Controller 21 used to manage processes and methodologies. 2) Core Engines 30 comprises engines that may include but not limited to the following. 2A) Structured Data Analysis Engine 31 used to ingest, normalize, and analyze Structured Data from Client Database 51 and/or Processing Database 60, and store outputs in Processing Database 60. 2B) Unstructured Data Analysis Engine 32 used to process and analyze live spoken audio streams such as VOIP from Voice Input 50, and/or recorded spoken audio files from Client Database 51 and/or Processing Database 60, and store outputs in Processing Database 60. 2C) Non-Feature Data Analysis Engine 33 used to distinguish Non-Feature data within the Raw Feature Space contained in Processing Database 60, and store outputs in Processing Database 60. 2D) Raw Feature Space Expansion Engine 34 used to compute Derived Features from the Raw Feature Space contained in Processing Database 60, and store outputs in Processing Database 60. 2E) Raw Feature Space Analysis Engine 35 used to determine the Initial Feature Set from Raw Feature Space contained in Processing Database 60 and determine Feature Vectors, and store outputs in Process Database 60. 2F) Data Point Structure Engine 36 used to align Feature Vectors contained in Process Database 60 with Prediction Classes, create Initial Data Points from aligned Feature Vectors and create Data Point Structure(s), and store outputs in Process Database 60. 2G) Model Builder Engine 37 used to create Models from Feature Vectors, Learning Algorithm(s), Hyperparameter Set(s), and Prediction Classes contained in Processing Database 60, create predictive and/or evaluative outcomes from Policy(s) contained in Processing Database 60, and store outputs in Process Database 60. 2H) Validation Engine 38 used to generate Performance Metrics based on Policy(s) contained in Processing Database 60, verify Policy's predictive and/or evaluative performance, and store outputs in Processing Database 60. 2I) Training Engine 39 used to train Models and alter Hyperparameters, Learning Algorithms and Ensemble Techniques contained in Processing Database 60 to modify Model behavior(s), determine Leading Candidate Policies, determine Optimized Policies, and store outputs in Processing Database 60. 2J) Implementation Engine 40 used to implement Policy(s) contained in Processing Database 60, generate Periodic, Prediction and Evaluation reports, and store outputs in Processing Database 60. 2K) Recalibration Engine 41 used to adjust Model inputs contained in Processing Database 60, create or modify Refined Model(s), Policy(s), Target Function Evaluations, Leading Candidate Policy(s), and store output in Process Database 60.

In the illustrative embodiment, Processing Database 60 comprises 11 components that may include but not limited to the following: 1) Seed Knowledge Base 61 used to store items including but not limited to pre-existing Models, Policies, and related Learning Algorithms, Rulesets, Logic Constructs, etc., utilized as a starting point to create and/or modify Models and Policies. 2) Knowledge Base 62 used to store items including but not limited to Models, Policies, and related Learning Algorithms, Rulesets, data, Logic Constructs, etc. of Models and Policies under construction. 3) Tools Knowledge Base 63 is used to store pre-existing items including but not limited to Rulesets, Learning Algorithms, and Processing Algorithms etc., utilized to construct, validate and/or modify Models and Policies. 4) Predictive Outcomes 64 used to store possible Predictive Outcomes generated by the system. 5) Evaluative Outcomes 65 used to store possible Evaluative Outcomes generated by the system. 6) Performance Metrics 66 used to store Performance Metrics generated by the system. 7) Prediction Report 67 used to store Predictions generated by the system in a report form. 8) Evaluation Report 68 used to store Evaluations generated by the system in a report form. 9) Periodic Report 69 used to store summations of Prediction and/or Evaluation Reports, and recommended changes to Business Directives. 10) Time Series Data 70 used to store Time Series Data generated by the system. 11) Performance Metric Report 71 used to store a report of generated metrics generated by the system.

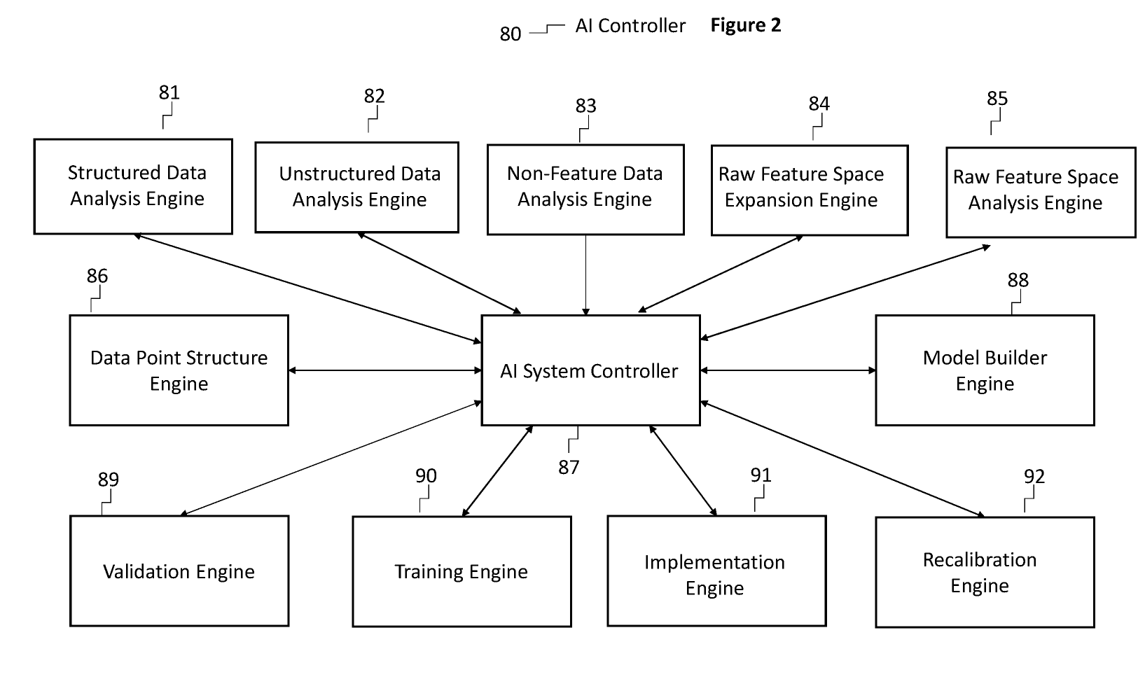

FIG. 2 illustrates one embodiment of AI System Controller 87 working in conjunction with Core Engines including but limited to Structured Data Analysis Engine 81, Unstructured Data Analysis Engine 82, Non-Feature Data Analysis Engine 83, Raw Feature Space Expansion Engine 84, Raw Feature Space Analysis Engine 85, Data Point Structure Engine 86, Model Builder Engine 88, Validation Engine 89, Training Engine 90, Implementation Engine 91, and Recalibration Engine 92 to create and/or modify, implement, and/or recalibrate Models, Policies, Predictions, and Evaluations for Call Centers based on extensive analysis of Structured, Unstructured and Non-Feature Data. In the illustrative embodiment, AI System Controller automatizes Core Engine functions in the dynamic creation and/or modification of data, information and knowledge produced by the methodologies contained in the disclosure.

In certain embodiments, AI System Controller 87 may configure Core Engines to perform specific tasks. For example, in one embodiment, AI System Controller 87 may access Tools Knowledge Base 63 to select Learning Algorithms and utilize configuration data for Learning Algorithms to form a partial configuration for Model Builder Engine 88. In another embodiment, AI System Controller 87 may access Seed Knowledge Base 61 to select a previously used Aggregation Ruleset and utilize configuration data for the Aggregation Ruleset to form a partial configuration for Data Point Structure Engine 86. In yet another embodiment, AI System Controller 87 may access Knowledge Base 62 to select Time Series Data and utilize configuration data for the Refined Master Rule Set to form a partial configuration for Recalibration Engine 92. Although the forgoing examples have been described in terms of certain embodiments, alterations and permutations of the embodiments will be apparent to those skilled in the art. Accordingly, the foregoing description of the embodiments does not constrain this disclosure. Other permutations of AI System Controller 87 configuration of Core Engines are contemplated.

In certain embodiments, AI System Controller 87 may provide logic for Core Engines. For example, in one embodiment, AI System Controller 87 may access Tools Knowledge Base 63 to select ensemble logic constructs for use by Model Builder Engine 88. In another embodiment, AI System Controller 87 may access Seed Knowledge Base 61 to select logic constructs for task sequencing performed by Raw Feature Space Analysis Engine 85. In yet another embodiment, AI System Controller 87 may receive logic constructs from Data Point Structure Engine 86 and load logic constructs into Validation Engine 89 for use in forming Validation Data Point Structure(s). Although the forgoing examples have been described in terms of certain embodiments, alterations and permutations of the embodiments will be apparent to those skilled in the art. Accordingly, the foregoing description of the embodiments does not constrain this disclosure. Other permutations of AI System Controller 87 providing logic constructs to Core Engines are possible.

In certain embodiments, AI System Controller 87 may specify the sequences of Core Engines utilized. For example, in one embodiment, AI System Controller 87 may direct different Core Engines to function in parallel, such as Structured Data Analysis Engine 81 performing Structured Data Analysis tasks, and Unstructured Data Analysis Engine 82 performing Unstructured Data Analysis tasks at the same time. In another embodiment, AI System Controller 87 may direct different Core Engines to function sequentially, such as Data Point Structure Engine 86 performing tasks followed by Model Builder Engine 88 performing tasks. In yet another embodiment, AI System Controller 87 may direct Core Engines to function in an order based on analysis data, such as analysis of Recalibration Engine 92 data followed by Raw Feature Space Analysis Engine performing task(s) to create or modify Refined Feature Vectors followed by Data Point Structure Engine 86 performing task(s) to create or modify Refined Data Point Structures. Although the forgoing examples have been described in terms of certain embodiments, alterations and permutations of the embodiments will be apparent to those skilled in the art. Accordingly, the foregoing description of the embodiments does not constrain this disclosure. Other permutations of AI System Controller 87 specifying the sequences of Core Engines utilized are possible.

In certain embodiments, AI System Controller 87 may modify functions of Core Engines utilized. For example, a function of Non-Feature Data Analysis Engine 83 is to designate Non-Feature Data. AI System Controller 87 may modify the function to designate Refined Non-Feature Data. In another example, a function of Data Point Structure Engine 86 is to create Initial Data Points. AI System Controller 87 may modify the function to create or modify Refined Data Points. In yet another example, a function of Training Engine 90 is to create an Optimized Policy. AI System Controller 87 may modify the function to create or modify a Refined Optimized Policy. Although the forgoing examples have been described in terms of certain embodiments, alterations and permutations of the embodiments will be apparent to those skilled in the art. Accordingly, the foregoing description of the embodiments does not constrain this disclosure. Other permutations of AI System Controller 87 modifying functions of Core Engines utilized are possible.

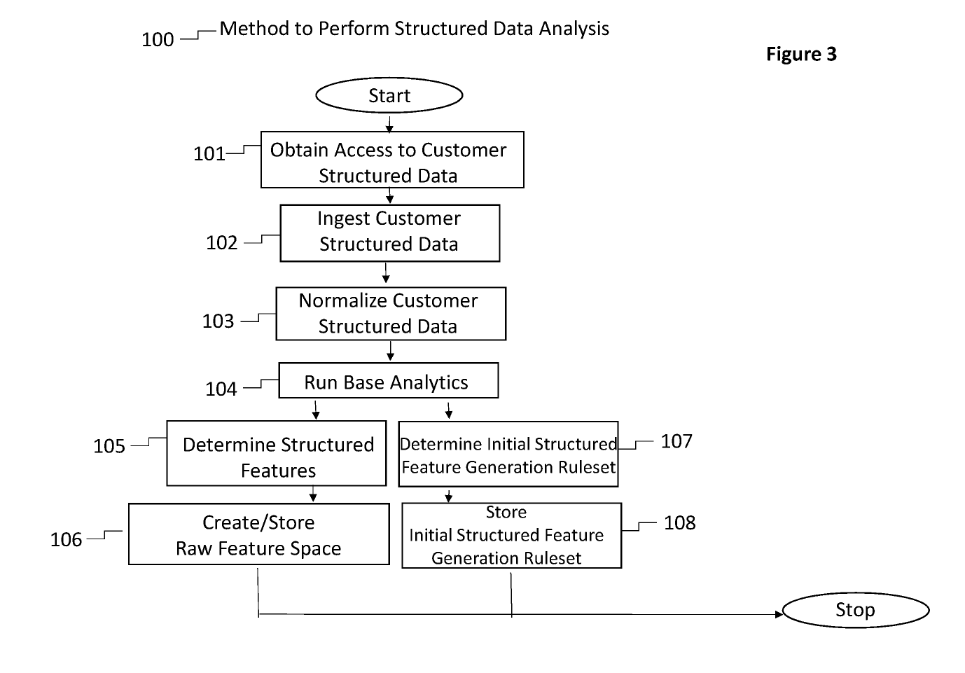

FIG. 3 illustrates one embodiment of AI System Controller 21 working in conjunction with Human Monitor interface 53, Structured Data Analysis Engine 31, Client Database 51, Tools Knowledge Base 63, and Knowledge Base 62 as exemplary Method 100, Method to Perform Structured Data Analysis.

In Step 101, access to Customer Structured Data is established. In one embodiment, Human Monitor interface 53 provides AI System Controller 21 access/log-in data to Client Database 51 and/or Knowledge Base 62. In another embodiment, AI System Controller may retrieve access/log-in data to Client Database 51 and/or Knowledge Base 62 from Knowledge Base 62. In one embodiment, AI System Controller 21 activates Structured Data Analysis Engine 31 and loads access/log-in data. Structured Data Analysis Engine 31 connects to Client Database 51 and/or Knowledge Base 62. Other processes may be used to access Customer Structured Data without departing from the spirit and scope of the exemplar method.

In Step 102, AI System Controller 21 initiates a process to ingest Customer Structured Data utilizing predetermined ingest scripts. Since each Customer's method of creating and storing Structured Data may be unique, ingest scripts are provided by Human Monitor interface 53 and may be stored in Tools Knowledge Base 63, or given directly to AI System Controller 21 for initiating ingestion of Customer Structured Data. In one embodiment, AI System Controller 21 may access Tools Knowledge Base 63, access appropriate ingest scripts, and provide appropriate ingest scripts to Structured Data Analysis Engine 31. In another embodiment, Human Monitor interface 53 may provide AI System Controller 21 with appropriate ingest scripts. AI System Controller 21 may send proper ingest scripts to Structured Data Analysis Engine 31 based on inputs provided by Human Monitor interface 53. In one embodiment, AI System Controller 21 may instruct Structured Data Analysis Engine 31 to store Customer Structured Data as Raw Feature Space in Knowledge Base 62. In another embodiment, AI System Controller 21 may instruct Structured Data Analysis Engine 31 to send Customer Structured Data to Human Monitor interface 53. Other processes may be used to ingest Customer Structured Data without departing from the spirit and scope of the exemplar method.

In Step 103, Structured Data Analysis Engine 31 normalizes Customer Structured Data. In one aspect, normalization is the process of mapping Customer Structured Data to a specific Data Schema. For example, call timestamps in call metadata may require merging of two separate fields and/or conversion to a single specific date-time format. Normalization may be done utilizing a pre-determined schema to map Customer Structured Data elements to exact or similar elements in the pre-determined schema. In certain embodiments, there are various methods to perform mappings. For example, in one embodiment, Human Monitor interface 53 utilizing Structured Data Analysis Engine 31 may perform manual mappings from Customer Structured Data to pre-determined schemas. In another embodiment, mappings may be performed automatically. AI System Controller may access may access Tools Knowledge Base 63, determine appropriate programmed mapping scripts, and provide appropriate provide appropriate programmed mapping scripts to Structured Data Analysis Engine 31. In one embodiment, once Customer Structured Data is normalized, AI System Controller may instruct Structured Data Analysis Engine to update Raw Feature Space in Knowledge Base 62 with Normalized Customer Structured Data. In another embodiment, once Customer Structured Data is normalized, AI System Controller may instruct Structured Data Analysis Engine to send Normalized Customer Structured Data to Human Monitor interface 53. Other processes may be used to normalize Customer Structured Data without departing from the spirit and scope of the exemplar method.

In Step 104, Structured Data Analysis Engine 31 performs analytics on normalized Customer Structured Data contained in Raw Feature Space contained in Knowledge Base 62. In certain embodiments, Structured Data Analysis Engine 31 may use various analysis techniques including, but not limited to computations, such as mean, median, variance, standard deviation, and/or principle component analysis in various business contexts run in a fixed or dynamically created sequence. In certain embodiments, these computations may be applied to numeric elements in structured data such as call duration or payments received. In one embodiment, AI System Controller 21 may access Tools Knowledge Base 63 and provide predefined analytic computation(s) to Structured Data Analysis Engine 31. In another embodiment, Human Monitor interface 53 may provide analytic computation(s) to Structured Data Analysis Engine 31. In certain embodiments, analytical outputs of Step 104 are immediately utilized as inputs to Step 105 and 107. Other processes may be used to perform analytics on Customer Structured Data without departing from the spirit and scope of the exemplar method.

In Step 105 Structured Features are determined based on analytical outputs generated in Step 104. In one embodiment, based on analytical outputs of Structured Feature Data Analysis, Structured Data Analysis Engine 31 may determine x number of Structured Features such as average call duration, prior probabilities of payment history, volatility of CSAT scores, etc., useful for identifying Feature Vectors. Structured Data Analysis Engine 31 may tag determined Structured Features with a unique identifier. In certain embodiments, Structured Features tagged with a unique identifier may be used by 130 Method to Determine Non-Feature Data, Method 140 Method to Expand Raw Feature Space, and/or 170 Method to Determine Initial Feature Set. In another embodiment, based on analytical outputs of Structured Feature Data Analysis, Human Monitor interface 53 may determine x number of Structured Features useful for identifying Feature Vectors. Structured Data Analysis Engine 31 may tag determined Structured Features with a unique identifier. In certain embodiments, Structured Features tagged with a unique identifier may be used by 130 Method to Determine Non-Feature Data, Method 140 Method to Expand Raw Feature Space, and/or 170 Method to Determine Initial Feature Set 170 Method to Determine Initial Feature Set. Other processes may be used to determine Structured Features without departing from the spirit and scope of the exemplar method.

In Step 106 Structured Features identified by a unique identifier are stored as Raw Feature Space in Knowledge Base 62 or sent to Human Monitor interface 53. In one embodiment, AI System Controller 21 may instruct Structured Data Analysis Engine 31 to create Raw Feature Space in Knowledge Base 62 and store Structured Features with unique identifiers in Raw Feature Space. In another embodiment, Human Monitor interface 53 may instruct Structured Data Analysis Engine 31 to create Raw Feature Space in Knowledge Base 62 and store Structured Features with unique identifiers in Raw Feature Space. Other processes may be used to store Structured Features identified by a unique identifier without departing from the spirit and scope of the exemplar method.

In Step 107 Initial Structured Feature Generation Ruleset(s) are determined based on analytical outputs generated in Step 104. In one embodiment, based on analytical outputs of Structured Feature Data Analysis, Structured Data Analysis Engine 31 may update or replace Initial Structured Feature Generation Rulesets to include the analytic computations used in step 104. In certain embodiments, Initial Structured Feature Generation Rulesets may be used by Method 140 Method to Expand Raw Feature Space, and for use in generating an Initial Master Rule Set. In another embodiment, based on analytical outputs of Structured Feature Data Analysis, Human Monitor interface 53 may convert analytic computations used in step 104 into Initial Structured Feature Generation Ruleset(s). In certain embodiments, Initial Structured Feature Generation Rulesets may be used by Method 140 Method to Expand Raw Feature Space, and for use in generating an Initial Master Rule Set. Other processes may be used to determine Initial Structured Feature Generation Rulesets without departing from the spirit and scope of the exemplar method.

In Step 108 the Initial Structured Feature Generation Ruleset(s) created in Step 107 is stored in Knowledge Base 62. In one embodiment, AI System Controller 21 may instruct Structured Data Analysis Engine 31 to store the Initial Structured Feature Generation Ruleset(s) in Knowledge Base 62 as part of Initial Master Rule Set. Structured Data Analysis Engine may tag a created Initial Master Rule Set with a unique identifier. In another embodiment, Human Monitor interface 53 may instruct Structured Data Analysis Engine 31 to store the Initial Structured Feature Generation Ruleset(s) in Knowledge Base 62 as part of Initial Master Rule Set. Structured Data Analysis Engine may tag a created Initial Master Rule Set with a unique identifier. Other processes may be used to store the Initial Structured Feature Generation Ruleset(s) without departing from the spirit and scope of the exemplar method.

Modifications, additions, or omissions may be made to 100 Method to Perform Structured Data Analysis 100 without departing from the scope of the method. The method may include more, fewer, or other steps. Additionally, steps may be performed in any suitable order.

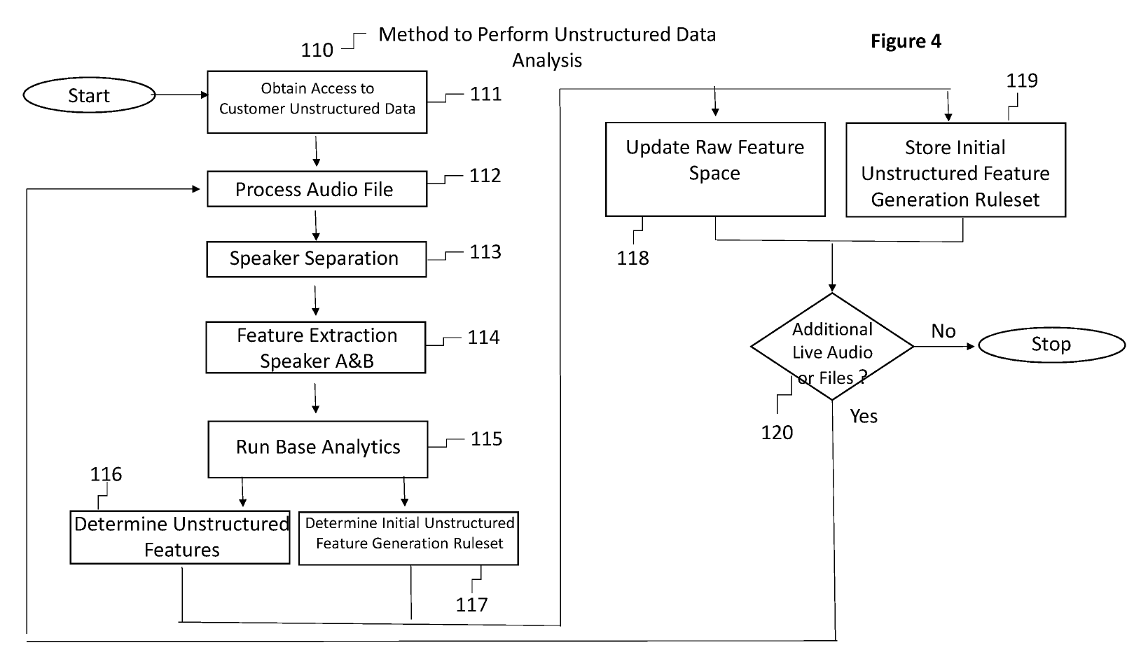

FIG. 4 illustrates one embodiment of AI System Controller 21 working in conjunction with Unstructured Data Analysis Engine 32, Voice Input 50, Client Database 51, Human Monitor interface 53, Seed Knowledge Base 61, Tools Knowledge Base 63, and Knowledge Base 62 as exemplary Method 110, Method to Perform Unstructured Data Analysis.

In Step 111, access to Customer Unstructured Data such as raw audio is established. In one embodiment, Human Monitor interface 53 provides AI System Controller 21 access/log-in data to Voice Input 50, Client Database 51, and/or Knowledge Base 62. In another embodiment, AI System Controller may retrieve access/log-in data to Voice Input 50, or Client Database 51 and/or Knowledge Base 62. In certain embodiments, AI System Controller 21 activates Unstructured Data Analysis Engine 32 and loads access/log-in data. Unstructured Data Analysis Engine 32 connects to Client Voice Input 50, or Client Database 51 and/or Knowledge Base 62. Other processes may be used to access Customer Unstructured Data without departing from the spirit and scope of the exemplar method.

In Step 112, AI System Controller 21 initiates a process utilizing Unstructured Data Analysis Engine 32 to process existing historical customer audio files contained in Client Database 51, Knowledge Base 62, or audio streamed from Voice Input 50. In certain embodiments, Unstructured Data Analysis Engine 32 may access Tools Knowledge Base 63 to select audio filters to obtain clear audio signals. In one embodiment, Unstructured Data Analysis Engine 32 working in conjunction with Tools Knowledge Base 63, may select and utilize a music model to filter out music from the audio signal. In another embodiment, Unstructured Data Analysis Engine 32 working in conjunction with Tools Knowledge Base 63, may select a noise model to filter out background noises such as door closing, sirens, traffic, or thunder. Other filters may be selected and used without departing from the spirit and scope of the exemplar method.

In Step 113, Unstructured Data Analysis Engine 32 separates customer voice from agent voice. In one embodiment, customer voice can be identified as Speaker A and agent voice can be identified as Speaker B. In another embodiment, agent voice can be identified as Speaker A and customer voice can be identified as Speaker B. In certain embodiments, Unstructured Data Analysis Engine 32 working in conjunction with Seed Knowledge Base 61 or Tools Knowledge Base 63, may select and utilize speaker separation techniques. Speaker Separation Techniques selected and used may vary and may include but not limited to the following example. In this example, speaker separation may be accomplished by a dividing process that produces chunks, i.e. 1-3-second pieces of the audio signal along minimal energy-level cutting points. Identification of the pieces may be accomplished with a learning algorithm as homogeneous human speech, simultaneous speech, or non-informative parts. For classification, KTM kernel-based non-linear learning process may be used. For the representation of Speaker A and Speaker B samples to be learned, extracted power spectral density features and the histogram of Mel Frequency Cepstral Coefficients' (MFCCs) changes may be used. Segments identified in homogeneous human speech may be partitioned into two types, which are customer and agent segments. To achieve this, a dissimilarity function relating to segment pairs with the help of machine learning may be used. This function assigns a value near 0 to segment pairs selected from the same speaker, and a value near 1 to segment pairs selected from a different speaker. In the learning process of the dissimilarity function, 10000 segment pairs belonging to the same speaker and 10000 belonging to another speaker may be used. On the basis of the learned dissimilarity function, a dissimilarity matrix of homogeneous voice segments for each pair may be created. Using an appropriate hierarchical clustering application such as agglomerative nesting, the segments may be divided into two classes, customer/agent. Segments containing heterogeneous speech excerpts from the conversation may be removed. Contraction of the parts belonging to the same speaker and correlating in time may be done. After contraction, obtaining an “ABABAB” type analysis of the conversation may be done, which prepares the data for Speaker A&B Feature Extraction in Step 114. In certain embodiments, AI Controller Engine 21 may instruct Unstructured Data Analysis Engine 32 to store Speaker A/Speaker B homogeneous voice segments in Knowledge Base 62. Other processes may be used to separate speakers without departing from the spirit and scope of the exemplar method.

In Step 114, AI System Controller 21 and/or Unstructured Data Analysis Engine 32 working in conjunction with Tools Knowledge Base 63, Seed Knowledge Base 61, and/or Human Monitor interface 53 extracts features from homogeneous voice segments created in Step 113. In this exemplar embodiment, feature extraction is focused on voice, how something is said, vs speech, what is being said. This may make exemplary embodiments language independent. In certain embodiments, different types of features may be extracted. In one embodiment, a feature type may be voice characteristic features extracted by algorithms. Voice characteristic features may include but not limited to mel-frequency cepstral coefficients, volume, tone, pitch, or speed. In another embodiment, a feature type may be communicational features. Communicational features may include but not limited to features based on voice tempo changes, length of consecutive agent-customer segments, and their different statistical functions of homogeneous voice segments. Statistical functions utilized in determining a communicational feature may include but not limited to minimum, maximum, median, mean, variance, and skewness analysis of volume, tone, pitch, or speed. Other feature types and related statistical functions may be utilized without departing from the spirit and scope of the exemplar method. In certain embodiments, AI System Controller 21 may instruct Unstructured Data Analysis Engine 32 to extract features from homogeneous voice segments. In one embodiment, AI Controller 21 may instruct Unstructured Data Analysis Engine 32 to access Seed Knowledge Base 61 and utilize specific algorithm ensembles and/or statistical functions for use in extracting one or more features from homogeneous voice segments. In another embodiment, AI System Controller 21 may instruct Unstructured Data Analysis Engine 32 to access Tools Knowledge Base 63 and utilize a specific algorithm ensemble and/or statistical function for use in extracting a specific feature from homogeneous voice segments. In yet another embodiment, Human Monitor interface 53 may provide Unstructured Data Analysis Engine 32 with a specific algorithm ensemble and/or statistical function for use in extracting one or more features from homogeneous voice segments. In certain embodiments, features extracted by Unstructured Data Analysis Engine 32 are used as input for analysis in Step 115. In certain embodiments, AI Controller Engine 21 may instruct Unstructured Data Analysis Engine 32 to store extracted features in Knowledge Base 62. Other processes may be used to extract features from homogeneous voice segments without departing from the spirit and scope of the exemplar method.

In Step 115, AI System Controller 21 and Unstructured Data Analysis Engine 32 working in conjunction with Knowledge Base 62, Tools Knowledge Base 63 and/or Seed Knowledge Base 61, analyzes features created in Step 114. In certain embodiments, analysis of features may include but not limited to determining emotions, emotional based behaviors, and/or emotional states associated with one or more extracted feature(s) from homogeneous voice segments created in Step 114. In one embodiment, AI System Controller 21 may instruct Unstructured Data Analysis Engine 32 to access Seed Knowledge Base 61 and utilize a pre-existing Emotional Model to analyze and determine emotions, emotional based behaviors, and/or emotional states from one or more extracted features from homogeneous voice segments. In another embodiment, AI System Controller 21 may instruct Unstructured Data Analysis Engine 32 to access statistical functions contained in Tools Knowledge Base 63 and dynamically build an Emotional Model. The dynamically built Emotional Model is used by Unstructured Data Analysis Engine 32 to analyze and determine emotions, emotional based behaviors, and/or emotional states based on one or more extracted features from homogeneous voice segments. In certain embodiments, based on emotional analysis, Unstructured Data Analysis Engine 32 may dynamically create Emotional Transition State features. Statistical analysis of Emotional Transition State features determines whether consecutive agent and/or customer homogeneous voice segments separately contain changes in different emotional states. For example, if the customer was angry at one moment, but spoke calmly after the agent spoke, it is considered an Emotional Transition State. In certain embodiments, AI Controller Engine 21 may instruct Unstructured Data Analysis Engine 32 to store analysis output and if created, Emotional State Transition features in Knowledge Base 62. In certain embodiments, results of feature analysis performed by Unstructured Data Analysis Engine 32 is used as input for determining Unstructured Features in Step 116 and Initial Unstructured Feature Generation Ruleset in Step 117. Other analysis processes may be used to analyze extracted features from homogeneous voice segments without departing from the spirit and scope of the exemplar method.

In Step 116 Unstructured Features are determined based on analytical outputs generated in Step 115. In one embodiment, based on analytical outputs of Unstructured Feature Data Analysis, Unstructured Data Analysis Engine 32 may determine x number of Unstructured Features useful for identifying Feature Vectors. Unstructured Data Analysis Engine 32 may tag determined Unstructured Features with a unique identifier. In certain embodiments, Structured Features tagged with a unique identifier may be used by 130 Method to Determine Non-Feature Data, Method 140 Method to Expand Raw Feature Space, and/or 170 Method to Determine Initial Feature Set. In another embodiment, based on analytical outputs of Unstructured Feature Data Analysis, Human Monitor interface 53 may determine x number of Unstructured Features useful for identifying Feature Vectors. Unstructured Data Analysis Engine 32 may tag determined Unstructured Features with a unique identifier. In certain embodiments, Structured Features tagged with a unique identifier may be used by 130 Method to Determine Non-Feature Data, Method 140 Method to Expand Raw Feature Space, and/or 170 Method to Determine Initial Feature Set. Other processes may be used to determine Unstructured Features without departing from the spirit and scope of the exemplar method.

In Step 117 Initial Unstructured Feature Generation Rulesets are determined based on analytical outputs generated in Step 115. In one embodiment, based on analytical outputs of Unstructured Feature Data Analysis, Unstructured Data Analysis Engine 32 may update or replace Initial Unstructured Feature Generation Ruleset(s) to include analytic computations used in Step 115. In certain embodiments, Initial Unstructured Feature Generation Rulesets(s) may be used by 130 Method to Determine Non-Feature Data, Method 140 Method to Expand Raw Feature Space, and/or 170 Method to Determine Initial Feature Set. In another embodiment, based on analytical outputs of Unstructured Feature Data Analysis, Human Monitor interface 53 may update or replace Initial Unstructured Feature Generation Ruleset(s) to include analytic computations used in step 115. In certain embodiments, Initial Unstructured Feature Generation Rulesets(s) may be used by 130 Method to Determine Non-Feature Data, Method 140 Method to Expand Raw Feature Space, and/or 170 Method to Determine Initial Feature Set. Other processes may be used to create Initial Unstructured Feature Generation Rulesets without departing from the spirit and scope of the exemplar method.

In Step 118 Unstructured Features identified by a unique identifier are stored as updates to the Raw Feature Space in Knowledge Base 62 or sent to Human Monitor interface 53. In one embodiment, AI System Controller 21 may instruct Unstructured Data Analysis Engine 32 to update the Raw Feature Space contained in Knowledge Base 62 with Unstructured Features and their unique identifiers. In another embodiment, Human Monitor interface 53 may instruct Unstructured Data Analysis Engine 32 to update the Raw Feature Space contained in Knowledge Base 62 with Unstructured Features and their unique identifiers. Other processes may be used to update the Raw Feature Space with Unstructured Features and their unique identifiers without departing from the spirit and scope of the exemplar method.

In Step 119, the Initial Unstructured Feature Generation Ruleset(s) created in Step 117 is stored in Knowledge Base 62 or sent to Human Monitor interface 53. In one embodiment, AI System Controller 21 may instruct Unstructured Data Analysis Engine 32 to update the Initial Master Rule Set contained in Knowledge Base 62 with the Initial Unstructured Feature Generation Ruleset(s). In another embodiment, Human Monitor interface 53 may instruct Unstructured Data Analysis Engine 32 to update the Initial Master Rule Set contained in Knowledge Base 62 with the Initial Unstructured Feature Generation Ruleset(s). Other processes may be used to store/update the Initial Master Rule Set with Initial Unstructured Feature Generation Ruleset(s) without departing from the spirit and scope of the exemplar method.

In Step 120, AI System Controller 21 determines if another audio file or audio stream is available for processing. If another audio file or audio stream is available, AI System Controller 21 instructs Unstructured Data Analysis Engine 32 to initiate Step 112. If no other processing is required, AI System Controller 21 instructs Unstructured Data Analysis Engine 32 to stop or perform other processing. Other processes may be used to determine if another audio file or audio stream is available for processing without departing from the spirit and scope of the exemplar method.

Modifications, additions, or omissions may be made to 110 Method to Perform Unstructured Data Analysis 110 without departing from the scope of the method. The method may include more, fewer, or other steps. Additionally, steps may be performed in any suitable order.

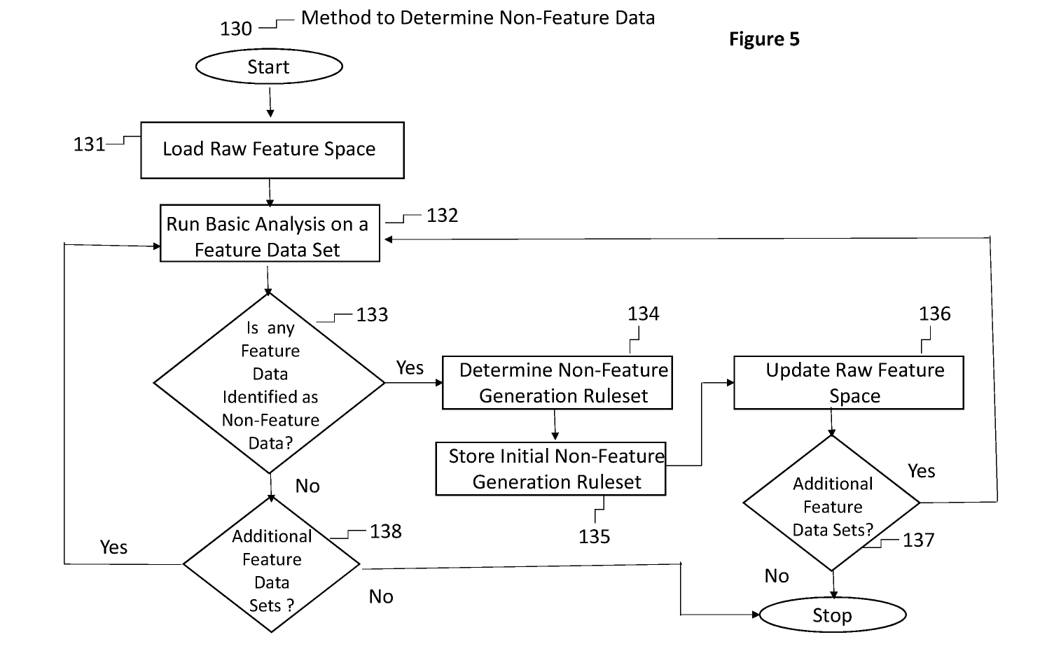

FIG. 5 illustrates one embodiment of AI System Controller 21 working in conjunction with Non-Feature Data Analysis Engine 33, Human Monitor interface 53, Seed Knowledge Base 61, Tools Knowledge Base 63, and Knowledge Base 62 as exemplary Method 130 Method to Determine Non-Feature Data. In certain Embodiments, Non-Feature Data may be used by Method 140 Method to Expand Raw Feature Space, and/or 170 Method to Determine Initial Feature Set.

In Step 131, AI System Controller 21 or Human Monitor interface 53 initiates a process to determine Non-Feature Data. In one embodiment, AI System Controller 21 may retrieve the Raw Feature Space from Knowledge Base 62 and provide the Raw Feature Space to Non-Feature Data Analysis Engine 33 for processing. Non-Feature Data Analysis Engine 33 may group Feature data contained in the Raw Feature Space into set(s) of Feature Data, for example, based on the prediction target of interest such as grouping features based on individual calls for a single agent that placed the calls. In another embodiment, Human Monitor interface 53 may access Knowledge Base 62, retrieve the Raw Feature Space, and provide the Raw Feature Space to Non-Feature Data Analysis Engine 33 for processing. Non-Feature Data Analysis Engine 33 may group Feature data contained in the Raw Feature Space into set(s) of Feature Data. Other processes may be used to load the Raw Feature Space without departing from the spirit and scope of the exemplar method.

In Step 132, Non-Feature Data Analysis Engine 33 performs analytics on Structured Feature Data Set(s) formed in Step 131 to determine Non-Feature Data. Non-Feature Data, is used for filtering and correlating Structured and Unstructured Data, and/or Structured and Unstructured Features. Non-Feature Data may include but not limited to prediction classes, competency levels, books of business, etc. In certain embodiments, Non-Feature Data Analysis Engine 33 may use various analysis techniques for analyzing a single Feature Data Set including but not limited to computations such as correlation coefficients, ANOVA, ANCOVA, one- and two-tailed F tests, T tests, Chi-squared test, any other tests against the null hypothesis, autocorrelation and other various time-series analysis tests, any of various Bayesian inference methods, and/or any methods for quantifying mutual information in various business contexts run in a fixed or dynamically created sequence. For example, dispersion statistics on the distribution of call durations may be used to determine a minimum threshold on which Feature Data Sets to consider. In one embodiment, AI System Controller 21 may access Tools Knowledge Base 63 and/or Seed Knowledge Base 61, determine analytic computation(s), and provide appropriate analytic computation(s) to Non-Feature Data Analysis Engine 33 to determine Non-Feature Data. For example, AI System Controller 21 may determine from summary statistics on agent performance scores that agent ID be used to filter out anomalous Feature Data Sets, and provide analytic computation(s) to Non-Feature Data Analysis Engine 33 to determine Non-Feature Data. In another embodiment, Human Monitor interface 53 may provide analytic computation(s) to Non-Feature Data Analysis Engine 33 to determine Non-Feature Data. For example, Human Monitor interface 53 may determine by analyzing summary statistics on agent performance scores that agent ID be used to filter out anomalous Feature Data Sets, and provide analytic computation to Non-Feature Data Analysis Engine 33 to determine Non-Feature Data. Other processes may be used to analyze Feature Data Set(s) without departing from the spirit and scope of the exemplar method.

In Step 133, Non-Feature Data Analysis Engine 33 determines if any Feature Data contained in the Feature Data Set was identified as Non-Feature Data in Step 1321f Non-Feature Data Analysis Engine 33 identified Non-Feature Data in the Feature Data Set, AI System Controller 21 instructs Non-Feature Data Analysis Engine 33 to tag identified Non-Feature Data with a unique identifier, and initiate Step 134. If Non-Feature Data Analysis Engine 33 identifies no Non-Feature Data in the feature Data Set, AI System Controller 21 instructs Non-Feature Data Analysis Engine 33 to Initiate Step 138. Other processes may be used to determine if Non-Feature Data exists without departing from the spirit and scope of the exemplar method.

In Step 138, AI System Controller 21 determines if any other Feature Data Set(s) exist for analysis. If more Feature Data Set(s) exist, AI System Controller 21 instructs Non-Feature Data Analysis Engine 33 to initiate Step 132. If no additional Feature Data Set(s) exists, AI System Controller 21, instructs Non-Feature Data Analysis Engine 33 to halt the method. Other processes may be used to determine if more Feature Data Set(s) exists without departing from the spirit and scope of the exemplar method.

In Step 134 Initial Non-Feature Generation Ruleset(s) are determined based on Non-Feature Data identified by analysis in Step 132. In one embodiment, based on identification of Non-Feature Data contained in a Feature Data Set, Non-Feature Data Analysis Engine 33 may use analytic computations identified in step 132 as Initial Non-Feature Generation Ruleset(s). In certain embodiments, Initial Non-Feature Generation Ruleset(s) may be used by Method 140 Method to Expand Raw Feature Space. In another embodiment, based on identification of Non-Feature Data contained in a Feature Data Set, Human Monitor interface 53 may use analytic computations identified in step 132 as Initial Non-Feature Generation Ruleset(s). In certain embodiments, Initial Non-Feature Generation Ruleset(s) may be used by Method 140 Method to Expand Raw Feature Space. Other processes may be used to determine Initial Non-Feature Generation Ruleset(s) without departing from the spirit and scope of the exemplar method.

In Step 135 the Initial Non-Feature Generation Ruleset(s) created in Step 134 is stored in Knowledge Base 62 or sent to Human Monitor interface 53. In one embodiment, AI System Controller 21 may instruct Non-Feature Data Analysis Engine 33 to update the Initial Master Rule Set contained in Knowledge Base 62 with the Initial Non-Feature Generation Ruleset(s). In another embodiment, Human Monitor interface 53 may instruct Non-Feature Data Analysis Engine 33 to update the Initial Master Rule Set contained in Knowledge Base 62 with the Initial Non-Feature Generation Ruleset(s). Other processes may be used to store/update the Initial Non-Feature Generation Ruleset(s) without departing from the spirit and scope of the exemplar method.

In Step 136, unique identifiers identifying Feature(s) as Non-Feature Data are stored as updates to the Raw Feature Space in Knowledge Base 62 or sent to Human Monitor interface 53. In one embodiment, AI System Controller 21 may instruct Non-Feature Data Analysis Engine 33 to replace unique identifiers for Structured Features or Unstructured Features in the Raw Feature Space contained in Knowledge Base 62 with unique identifiers indicating Non-Structured Data. In another embodiment, Human Monitor interface 53 may instruct Non-Feature Data Analysis Engine 33 to update the Raw Feature Space contained in Knowledge Base 62 replacing unique identifiers for Structured Features or Unstructured Features in the Raw Feature Space contained in Knowledge Base 62 with unique identifiers indicating Non-Structured Data. Other processes may be used to update the Raw Feature Space with Non-Feature Data without departing from the spirit and scope of the exemplar method.

In Step 137, AI System Controller 21 determines if any other Feature Data Set(s) exist for analysis. If more Feature Data Set(s) exist, AI System Controller 21 instructs Non-Feature Data Analysis Engine 33 to initiate Step 132. If no additional Feature Data Set(s) exists, AI System Controller 21, instructs Non-Feature Data Analysis Engine 33 to halt the method. Other processes may be used to determine if more Feature Data Set(s) exists without departing from the spirit and scope of the exemplar method.

Modifications, additions, or omissions may be made to 130 Method to Determine Non-Feature Data 130 without departing from the scope of the method. The method may include more, fewer, or other steps. Additionally, steps may be performed in any suitable order.

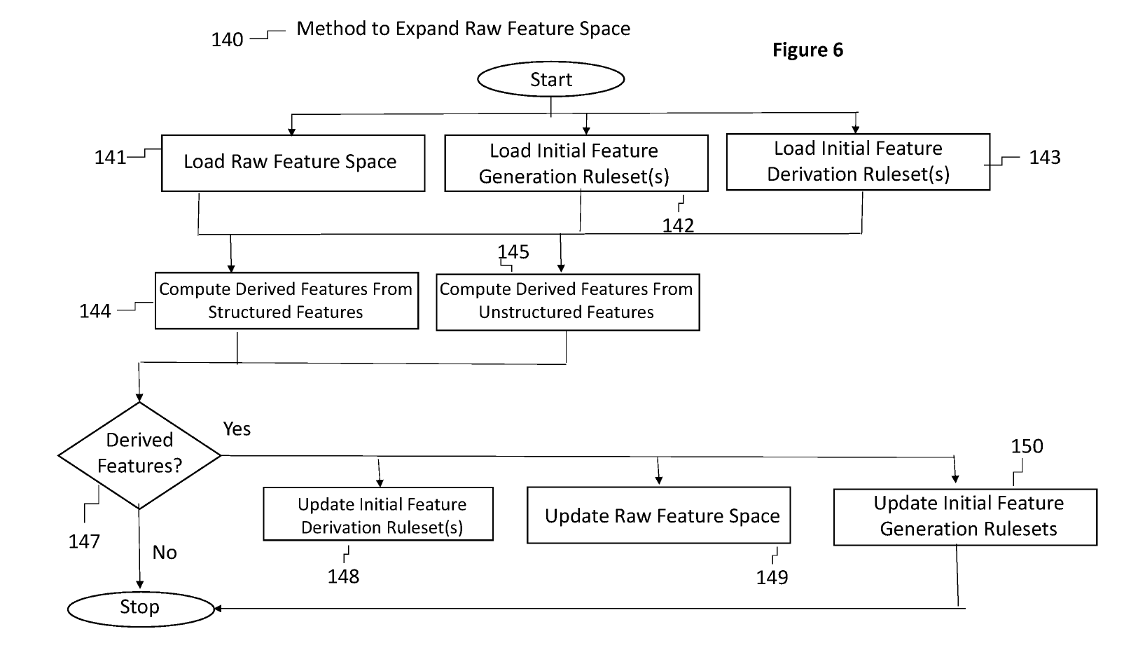

FIG. 6 illustrates one embodiment of AI System Controller 21 and/or Human Monitor interface 53 working in conjunction with Raw Feature Space Expansion Engine 34, Seed Knowledge Base 61, Tools Knowledge Base 63, and Knowledge Base 62 as exemplary Method 140 Method to Expand Raw Feature Space. In certain embodiments, an Expanded Raw Feature Space may be used by 170 Method to Determine Initial Feature Set.

In Step 141, AI System Controller 21 or Human Monitor interface 53 initiates a process to expand the Raw Feature Space and load a Raw Feature Space into Raw Feature Space Expansion Engine 34 for processing. In this Method, the Raw Feature Space contains identified Structured Features, Unstructured Features, and Non-Structured Data, and their associated unique identifiers. In one embodiment, AI System Controller 21 may access Knowledge Base 62, retrieve the Raw Feature Space, and load Raw Feature Space into Raw Feature Space Expansion Engine 34 for processing. In another embodiment, Human Monitor interface 53 may access Knowledge Base 62, retrieve the Raw Feature Space, and load Raw Feature Space to Raw Feature Space Expansion Engine 34 for processing. Other processes may be used to load the Raw Feature Space into Raw Feature Space Expansion Engine 34 without departing from the spirit and scope of the exemplar method.

In Step 142, AI System Controller 21 or Human Monitor interface 53 may load Initial Feature Generation Ruleset(s) to Raw Feature Space Expansion Engine 34 for processing. In this Method, the Initial Feature Generation Ruleset(s) comprises Initial Structured Feature Generation Ruleset(s), Initial Unstructured Feature Generation Ruleset(s), and Initial Non-Feature Generation Ruleset(s) contained in the Initial Master Rule Set used to create Structured Features, Unstructured Features, and designate Non-Feature Data contained in the Raw Feature Space loaded in Step 141. In one embodiment, AI System Controller 21 may access Knowledge Base 62, retrieve the Initial Feature Generation Ruleset(s), and load Initial Feature Generation Ruleset(s) into Raw Feature Space Expansion Engine 34 for processing. In another embodiment, Human Monitor interface 53 may access Knowledge Base 62, retrieve the Initial Feature Generation Ruleset(s), and load Initial Feature Generation Ruleset(s) into Raw Feature Space Expansion Engine 34 for processing. Other processes may be used to load the Initial Feature Generation Ruleset(s) into Raw Feature Space Expansion Engine 34 without departing from the spirit and scope of the exemplar method.

In Step 143, AI System Controller 21 or Human Monitor interface 53 may load Initial Feature Derivation Ruleset(s) to Raw Feature Space Expansion Engine 34 for processing. Initial Feature Derivation Rulesets are pre-existing algorithms used to compute Derived Features utilizing Structured Features, Unstructured Features, and Non-Structured Data from Raw Feature Space loaded in Step 141 and associated Initial Feature Generation Ruleset(s) loaded in Step 142. Algorithms contained in Initial Feature Derivation Rulesets comprise rulesets to determine Features not currently contained in the Raw Feature Space. For example, if Feature “Call Duration”, is not contained in the Raw Feature Space, a rule in the Initial Feature Derivation Ruleset may check for the existence of Features “Call Start Time” and “Call Stop Time” in the Raw Feature Space. If “Call Start Time” and “Call Stop Time”, exists in the Raw Feature Space, the rule may create Feature “Call Duration”. In one embodiment, AI System Controller 21 may access Tools Knowledge Base 63, retrieve one or more individual Initial Feature Derivation Ruleset(s), and load Initial Feature Derivation Ruleset(s) into Raw Feature Space Expansion Engine 34 for processing. In yet another embodiment, Human Monitor interface 53 may access Tools Knowledge Base 63, retrieve one or more individual Initial Feature Derivation Ruleset(s), and load Initial Feature Derivation Ruleset(s) into Raw Feature Space Expansion Engine 34 for processing. Other processes may be used to make load Initial Feature Derivation Ruleset(s) into Raw Feature Space Expansion Engine 34 without departing from the spirit and scope of the exemplar method.

In Step 144, Raw Feature Space Expansion Engine 34 may compute Derived Features from Structured Features contained in Raw Feature Space loaded in Step 141 and associated Initial Feature Generation Ruleset(s) loaded in Step 142 utilizing Initial Feature Derivation Ruleset loaded in Step 143. In certain Embodiments, Derived Features may be used by Method 170 Method to Determine Initial Feature Set. If Raw Feature Space Expansion Engine 34 generated Derived Features, Raw Feature Space Expansion Engine 34 may tag Derived Features with a unique identifier. For example, in one embodiment, Raw Feature Expansion Engine 34 may utilize an algorithm contained in an Initial Feature Derivation Ruleset to determine if Structured Features “Call Start Time” and “Call Stop Time” exists in the Raw Feature Space, and if so, determine the existence of “Call Duration”, a Derived Feature not currently contained in the Raw Feature Space. Raw Feature Expansion Engine 34 may tag “Call Duration” with a unique identifier. Other processes may be used compute Derived Features from Structured Features utilizing Initial Feature Derivation Ruleset(s) without departing from the spirit and scope of the exemplar method.

In Step 145, Raw Feature Space Expansion Engine 34 may compute Derived Features from Unstructured Features contained in Raw Feature Space loaded in Step 141 and associated Initial Feature Generation Ruleset(s) loaded in Step 142 utilizing Initial Feature Derivation Ruleset loaded in Step 143. In certain Embodiments, Derived Features may be used by Method 170 Method to Determine Initial Feature Set. If Raw Feature Space Expansion Engine 34 generated Derived Features, Structured Data Analysis Engine 31 may tag Derived Features with a unique identifier. For example, in one embodiment, Raw Feature Expansion Engine 34 may utilize an algorithm contained in an Initial Feature Derivation Ruleset to determine if Unstructured Features such as Discrete Fourier Transform coefficients or Mel-Frequency Cepstral Coefficients exist in the Raw Feature Space, and if so, determine the existence of probability of expressed happiness, a Derived Feature not currently contained in the Raw Feature Space. Raw Feature Expansion Engine 34 may tag probability of expressed happiness with a unique identifier. Other processes may be used compute Derived Features from Unstructured Features utilizing Initial Feature Derivation Ruleset(s) without departing from the spirit and scope of the exemplar method.

In Step 147, AI System Controller 21 determines if Raw Feature Space Expansion Engine 34 computed Derived Features in Steps 144 or 145. If Derived Features were computed, AI System Controller 21 instructs Raw Feature Space Expansion Engine 34 to initiate Step 148. If no Derived Features were computed, AI System Controller 21, instructs Raw Feature Space Expansion Engine 34 to halt the method. Other processes may be used to determine if Derived Features were computed without departing from the spirit and scope of the exemplar method.

In Step 148 Refined Feature Derivation Ruleset(s) are determined based on Derived Feature(s) computed in Steps 144 and/or 145. In one embodiment, based on computed Derived Features, Raw Feature Space Expansion Engine 34 may convert Initial Feature Derivation Ruleset(s) utilized in Steps 144 and/or 145 into Refined Feature Derivation Ruleset(s) for future use. In another embodiment, based on computed Derived Features, Human Monitor interface 53 may convert Initial Feature Derivation Ruleset(s) utilized in Steps 144 and/or 145 into Refined Feature Derivation Ruleset(s) for future use. Other processes may be used to determine Derived Feature Generation Ruleset(s) without departing from the spirit and scope of the exemplar method.

In Step 149, Derived Feature(s) and their unique identifiers are stored as updates to the Raw Feature Space in Knowledge Base 62 or sent to Human Monitor interface 53. In one embodiment, AI System Controller 21 may instruct Raw Feature Space Expansion Engine 34 to update the Raw Feature Space contained in Knowledge Base 62 with Derived Feature(s) and unique identifiers. In another embodiment, Human Monitor interface 53 may instruct Raw Feature Space Expansion Engine 34 to update the Raw Feature Space contained in Knowledge Base 62 with Derived Features and unique identifiers. Other processes may be used to update the Raw Feature Space with Derived Features and unique identifiers without departing from the spirit and scope of the exemplar method.

In Step 150 Refined Feature Generation Ruleset(s) are determined based on Derived Feature(s) computed in Steps 144 and 145. In one embodiment, the Refined Feature Generation Ruleset(s) utilized to generate Derived Features in Steps 144 and 145 are stored in Knowledge Base 62 or sent to Human Monitor interface 53. In one embodiment, AI System Controller 21 may instruct Raw Feature Space Expansion Engine 34 to update the Initial Master Rule Set contained in Knowledge Base 62 with Refined Feature Generation Ruleset(s) utilized to generate Derived Features. In another embodiment, Human Monitor interface 53 may instruct Raw Feature Space Expansion Engine 34 to update the Initial Master Rule Set contained in Knowledge Base 62 with Refined Feature Generation Ruleset(s) utilized to generate Derived Features. Other processes may be used to update the Initial Master Rule Set with Refined Feature Generation Ruleset(s) utilized to generate Derived Features without departing from the spirit and scope of the exemplar method.

Modifications, additions, or omissions may be made to the Method for Expanding Raw Feature Space without departing from the scope of the method. The method may include more, fewer, or other steps. Additionally, steps may be performed in any suitable order.

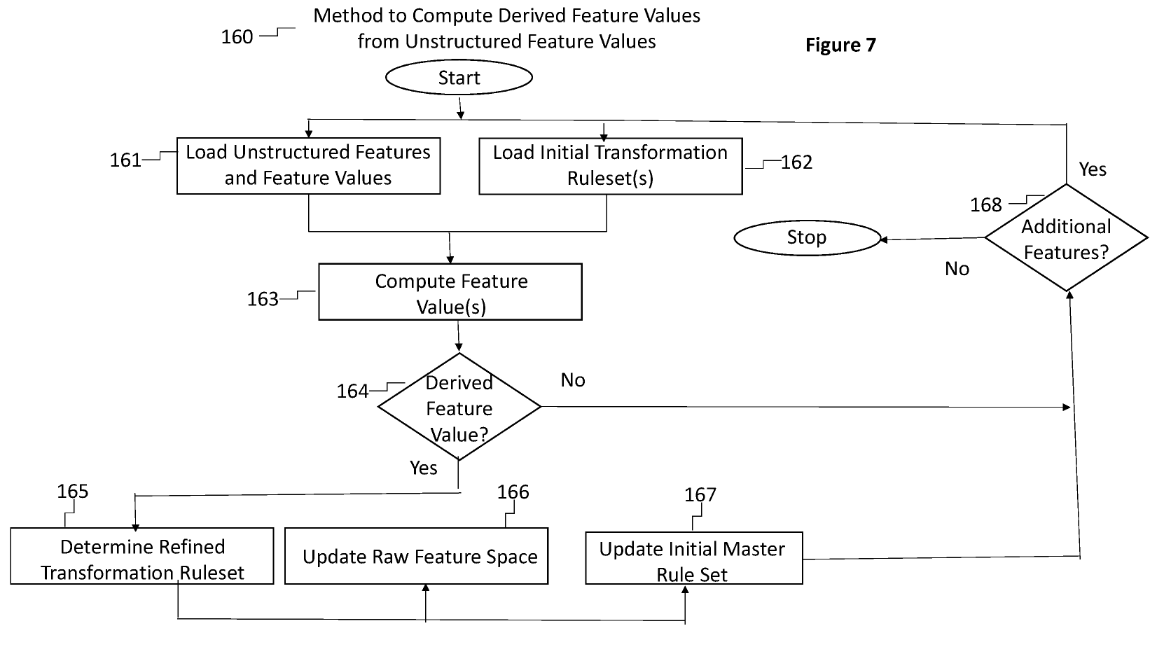

FIG. 7 illustrates one embodiment of AI System Controller 21 and/or Human Monitor interface 53 working in conjunction with Unstructured Data Analysis Engine 32, Seed Knowledge Base 61, Tools Knowledge Base 63, and Knowledge Base 62 as exemplary Method 160, Method to Compute Derived Feature Values from Unstructured Feature Values.

In Step 161, AI System Controller 21 or Human Monitor interface 53 initiates a process to compute Derived Feature Values from Unstructured Feature Values and load Unstructured Features and Feature Values into Unstructured Data Analysis Engine 32 for processing. In one embodiment, AI System Controller 21 may access Knowledge Base 62, retrieve Unstructured Features and Feature Values, and load Unstructured Features and Feature Values into Unstructured Data Analysis Engine 32 for processing. In another embodiment, Human Monitor interface 53 may access Knowledge Base 62, retrieve Unstructured Features and Feature Values, and load Unstructured Features and Feature Values into Unstructured Data Analysis Engine 32 for processing. Other processes may be used to load Unstructured Features and Feature Values into Unstructured Data Analysis Engine 32 without departing from the spirit and scope of the exemplar method.

In Step 162, AI System Controller 21 or Human Monitor interface 53 may load Initial Transformation Ruleset(s) into Unstructured Data Analysis Engine 32 for processing. Initial Transformation Rulesets are pre-existing algorithms used to compute a Singular Unstructured Feature Value from multiple emotional Feature Values identified by an Emotional Model. In one embodiment, AI System Controller 21 may access Tools Knowledge Base 63, retrieve one or more individual Initial Transformation Ruleset(s), and load Initial Transformation Ruleset(s) into Unstructured Data Analysis Engine 32 for processing. In yet another embodiment, Human Monitor interface 53 may access Tools Knowledge Base 63, retrieve one or more individual Initial Transformation Ruleset(s), and load Initial Transformation Ruleset(s) into Unstructured Data Analysis Engine 32 for processing. Other processes may be used to make load Initial Transformation Ruleset(s) into Unstructured Data Analysis Engine 32 without departing from the spirit and scope of the exemplar method.

In Step 163, Unstructured Data Analysis Engine 32 may compute a single Derived Feature Value from one or more Unstructured Feature Values and tag the Derived Feature Value with a unique identifier. In certain embodiments, Unstructured Data Analysis Engine 32 may form a group of Unstructured Feature Values to compute a single Derived Feature Value from multiple Unstructured Feature Values utilizing loaded Initial Transformation Ruleset(s). For example, in one embodiment, Unstructured Data Analysis Engine 32 may utilize algorithms contained in one or more Initial Transformation Ruleset(s) to compute an average of the number of times the emotion “Happy” is expressed in all calls a specific Floor Agent made in a specific time period. In this example, Unstructured Data Analysis Engine 32 may utilize a count algorithm contained in an Initial Transformation Ruleset to determine the number of calls a Floor Agent made in a specific time period. In this example, the number of calls made is 160. Unstructured Data Analysis Engine 32 may then use an algorithm contained in an Initial Transformation Ruleset to determine the number of times a Floor Agent expressed the emotion “Happy” over the 160 calls made. In this example, the number of times the emotion “Happy” was expressed 320 times over the 160 calls made. Unstructured Data Analysis Engine 32 may then use an algorithm contained in an Initial Transformation Ruleset to determine the average of the number of times the emotion “Happy” is expressed in the 160 calls made. In this example, the average number of times the Floor Agent expressed the emotion “Happy” is 2 (320/160). The Derived Feature Value (2) may be tagged with a unique identifier. Other processes may be used compute Derived Feature Values from multiple Unstructured Feature Values utilizing Initial Transformation Rulesets(s) and tag the Derived Feature Value with a unique identifier without departing from the spirit and scope of the exemplar method.

In Step 164, AI System Controller 21 determines if Unstructured Data Analysis Engine 32 computed a Derived Feature Value. If Derived Feature Value was computed, AI System Controller 21 instructs Unstructured Data Analysis Engine 32 to initiate Step 165. If no Derived Feature Value was computed, AI System Controller 21, instructs Unstructured Data Analysis Engine 32 to initiate Step 169. Other processes may be used to determine if a Derived Feature Value was computed without departing from the spirit and scope of the exemplar method.

In Step 165 Refined Transformation Ruleset(s) are determined based on Derived Feature Value computed in Step 163. Only Initial Transformation Ruleset(s) utilized in computing a Feature Value in Step 163 are determined to be Refined Transformation Ruleset(s). Unstructured Data Analysis Engine 32 may tag utilized Refined Transformation Ruleset with a unique identifier. The unique identifier is used as a memory for developing future derived Feature Values. In one embodiment, based on computed Derived Feature Value, Unstructured Data Analysis Engine 32 may convert Initial Transformation Ruleset(s) utilized in Step 163 into Refined Transformation Ruleset(s) and assign a unique identifier. In another embodiment, based on computed Derived Feature Value, Human Monitor interface 53 may convert Initial Transformation Ruleset(s) utilized in Step 163 into Refined Feature Generation Ruleset(s) and assign a unique identifier for future use. Other processes may be used to determine Refined Transformational Ruleset(s) without departing from the spirit and scope of the exemplar method.

In Step 166, Derived Feature Value computed in Step 163 and its assigned unique identifier are stored in Knowledge Base 62 or sent to Human Monitor interface 53. In one embodiment, AI System Controller 21 may instruct Unstructured Data Analysis Engine 32 to update the Raw Feature Space contained in Knowledge Base 62 with a Derived Feature Value and its assigned unique identifier. In another embodiment, Human Monitor interface 53 may instruct Unstructured Data Analysis Engine 32 to update the Raw Feature Space contained in Knowledge Base 62 with a Derived Feature Value and its assigned unique identifier. Other processes may be used to update the Raw Feature Space with a Derived Feature Value and its assigned unique identifier without departing from the spirit and scope of the exemplar method.

In Step 167 the Refined Transformation Ruleset and its unique identifier are stored in Knowledge Base 62 or sent to Human Monitor interface 53. In one embodiment, AI System Controller 21 may instruct Unstructured Data Analysis Engine 32 to update the Initial Master Rule Set contained in Knowledge Base 62 with the Refined Transformation Ruleset(s) and its assigned unique identifier. In another embodiment, Human Monitor interface 53 may instruct Unstructured Data Analysis Engine 32 to update the Initial Master Rule Set contained in Knowledge Base 62 with the Refined Transformation Ruleset and its assigned unique identifier. Other processes may be used to update the Initial Master Rule Set with Refined Transformation Ruleset and its unique identifier without departing from the spirit and scope of the exemplar method.

In Step 168, AI System Controller 21 determines if any other Unstructured Features and Feature Values exists for analysis. If more Unstructured Features and Feature Values exists, AI System Controller 21 instructs Unstructured Data Analysis Engine 32 to initiate Steps 161 and 162. If no additional Unstructured Features and Feature Values exists, AI System Controller 21, instructs Unstructured Data Analysis Engine 32 to halt the method. Other processes may be used to determine if more Unstructured Features and Feature Values exists without departing from the spirit and scope of the exemplar method.

Modifications, additions, or omissions may be made to the Method to Compute Derived Feature values from Unstructured Feature Values without departing from the scope of the method. The method may include more, fewer, or other steps. Additionally, steps may be performed in any suitable order.

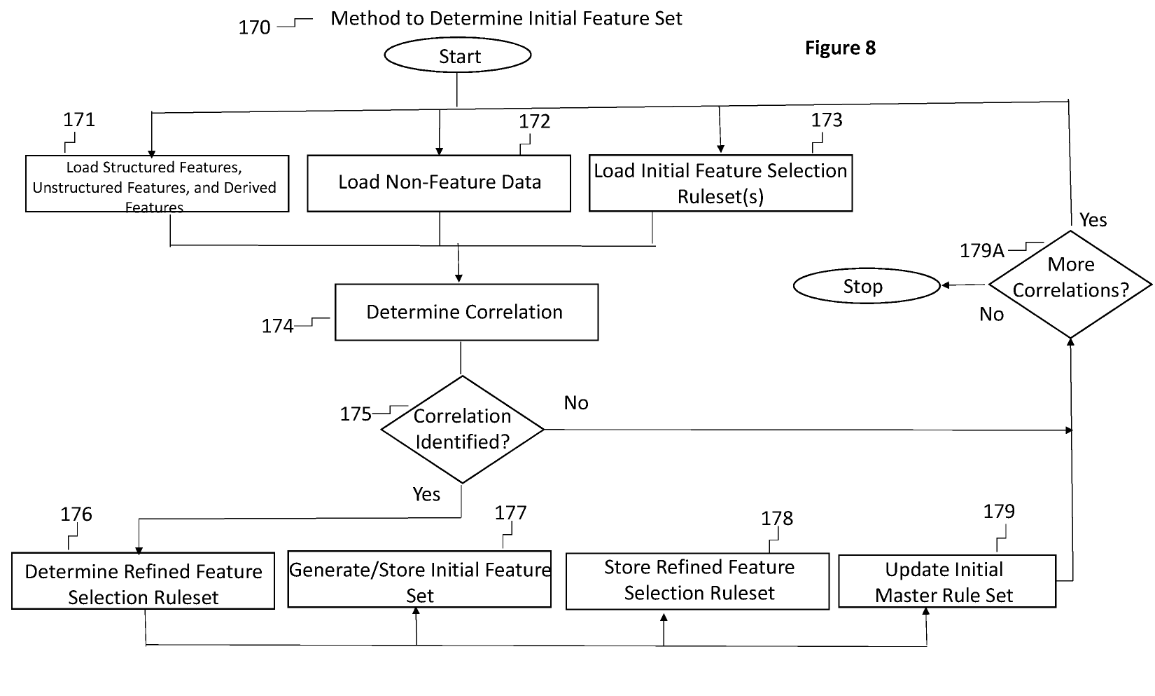

FIG. 8 illustrates one embodiment of AI System Controller 21 and/or Human Monitor interface 53 working in conjunction with Raw Feature Space Analysis Engine 35, Seed Knowledge Base 61, Tools Knowledge Base 63, and Knowledge Base 62 as exemplary Method 170, Method to Determine Initial Feature Set.

In Step 171, AI System Controller 21 or Human Monitor interface 53 initiates a process to determine the Initial Feature Set from Structured Features, Unstructured Features, Derived Features, and/or Non-Feature Data contained in Raw Feature Space, and load Raw Feature Space into Raw Feature Space Analysis Engine 35 for processing. The Initial Feature Set is utilized by Method 180 Method to Determine Feature Vectors. In one embodiment, AI System Controller 21 may access Knowledge Base 62, retrieve Structured Features, Unstructured Features, and Derived Features from Raw Feature Space, and load into Raw Feature Space Analysis Engine 35 for processing. In another embodiment, Human Monitor interface 53 may access Knowledge Base 62, retrieve Structured Features, Unstructured Features, and Derived Features from Raw Feature Space, and load into Raw Feature Space Analysis Engine 35 for processing. Other processes may be used to load Structured Features, Unstructured Features, and Derived Features from into Raw Feature Space Analysis Engine 35 without departing from the spirit and scope of the exemplar method.

In Step 172, AI System Controller 21 or Human Monitor interface 53 may load Non-Feature Data into Raw Feature Space Analysis Engine 35 for processing. In one embodiment, AI System Controller 21 may access Knowledge Base 62, retrieve Non-Feature Data, and load Non-Feature Data into Raw Feature Space Analysis Engine 35 for processing. In another embodiment, Human Monitor interface 53 may access Knowledge Base 62, retrieve Non-Feature Data, and load Non-Feature Data into Raw Feature Space Analysis Engine 35 for processing. Other processes may be used to load Non-Feature Data into Raw Feature Space Analysis Engine 35 without departing from the spirit and scope of the exemplar method.

In Step 173, AI System Controller 21 or Human Monitor interface 53 may load Initial Feature Selection Ruleset(s) into Raw Feature Space Analysis Engine 35 for processing. Initial Feature Selection Ruleset(s) are used to correlate one or more Features contained in the Raw Feature Space, or a Feature with Non-Feature Data. Correlation algorithms contained in Initial Feature Selection Ruleset(s) include but not limited to Covariance Matrices, Grouped ANOVA, Transition Graphs, etc. In one embodiment, AI System Controller 21 may access Tools Knowledge Base 63, retrieve one or more individual Initial Feature Selection Ruleset(s), and load Initial Feature Selection Ruleset(s) into Raw Feature Space Analysis Engine 35 for processing. In yet another embodiment, Human Monitor interface 53 may access Tools Knowledge Base 63, retrieve one or more individual Initial Feature Selection Ruleset(s), and load Initial Feature Selection Ruleset(s) into Raw Feature Space Analysis Engine 35 for processing. Other processes may be used to load Initial Feature Selection Ruleset(s) into Raw Feature Space Analysis Engine 35 without departing from the spirit and scope of the exemplar method.

In Step 174, Raw Feature Space Analysis Engine 35 may compute a single correlation between Features in the Raw Feature Space, for example payments received and call duration, and/or a correlation of a Feature with Non-Feature Data, for example payments received with prediction class, utilizing algorithms contained in Initial Feature Selection Ruleset(s) loaded in Step 173. In certain embodiments, Raw Feature Space Analysis Engine 35 may compute a single correlation between Features in the Raw Feature Space and/or a correlation of a Feature with Non-Feature Data utilizing loaded Initial Feature Selection Ruleset(s). Other processes may be used to correlate a single Feature in the Raw Feature Space with Non-Feature Data without departing from the spirit and scope of the exemplar method.

In Step 175, AI System Controller 21 determines if Raw Feature Space Analysis Engine 35 computed a correlation between Features in the Raw Feature Space and/or a correlation of a Feature with Non-Feature Data. If a correlation was computed, AI System Controller 21 may assign a unique identifier to the correlated Features, and/or the correlated feature and Non-Feature Data, and instruct Raw Feature Space Analysis Engine 35 to initiate Step 176. If no correlation was computed, AI System Controller 21, instructs Raw Feature Space Analysis Engine 35 to initiate Step 179A. Other processes may be used to determine if a correlation between Features in the Raw Feature Space and/or a correlation of a Feature with Non-Feature Data, and assign a unique identifier to a generated correlation without departing from the spirit and scope of the exemplar method.

In Step 176 Refined Feature Selection Ruleset(s) are correlations computed in Step 174. Only Initial Feature Selection Ruleset(s) utilized in computing a correlation in Step 174 are determined to be Refined Feature Selection Ruleset(s). Raw Feature Space Analysis Engine 35 may tag utilized Refined Feature Selection Ruleset(s) with a unique identifier. The unique identifier is used as a memory for developing future correlations. In one embodiment, based on computed correlations, Raw Feature Space Analysis Engine 35 may convert Initial Feature Selection Ruleset(s) utilized in Step 174 into Refined Feature Selection Ruleset(s) and assign a unique identifier for future use. In another embodiment, based on computed correlations, Human Monitor interface 53 may convert Initial Feature Selection Ruleset(s) utilized in Step 174 into Refined Feature Selection Ruleset(s) and assign a unique identifier for future use. Other processes may be used to determine Refined Feature Selection Ruleset(s) without departing from the spirit and scope of the exemplar method.

In Step 177, correlated Features and/or a Feature correlated with Non-Feature Data computed in Step 163, and related unique identifiers are stored in Knowledge Base 62 as an initial Feature Set, or sent to Human Monitor interface 53 as an initial Feature Set. Correlated Features and/or a Feature correlated with Non-Feature Data, and related unique identifiers form the Initial Feature Set. The Initial Feature Set is used by 180 Method to Determine Feature Vectors. In one embodiment, AI System Controller 21 may instruct Raw Feature Space Analysis Engine 35 to generate an Initial Feature Set and assign a unique identifier and store Initial Feature Set and assigned unique identifier in Knowledge Base 62. In another embodiment, Human Monitor interface 53 may instruct Raw Feature Space Analysis Engine 35 to generate an Initial Feature Set and assign a unique identifier, and store Initial Feature Set and assigned unique identifier in Knowledge Base 62. Other processes may be used to generate an Initial Feature Set and assign a unique identifier, and store Initial Feature Set and assigned unique identifier without departing from the spirit and scope of the exemplar method.

In Step 178 the Refined Feature Selection Ruleset(s) generated in Step 176 is stored in Tools Knowledge Base 63 or sent to Human Monitor interface 53. In one embodiment, AI System Controller 21 may instruct Raw Feature Space Analysis Engine 35 to store the Refined Feature Selection Ruleset(s) and its assigned unique identifier in Tools Knowledge Base 63 for future use. In another embodiment, Human Monitor interface 53 may instruct Raw Feature Space Analysis Engine 35 to store Refined Feature Selection Ruleset(s) and its assigned unique identifier in Tools Knowledge Base 63 for future use. Other processes may be used to store the Refined Feature Selection Ruleset(s) without departing from the spirit and scope of the exemplar method.

In Step 179, the Initial Master Rule Set in Knowledge Base 62 is updated with Refined Feature Selection Ruleset(s) and its assigned unique identifier. In one embodiment, AI System Controller 21 may instruct Raw Feature Space Analysis Engine 35 to update the Initial Master Rule Set in Knowledge Base 62 with Refined Feature Selection Ruleset(s) and its assigned unique identifier. In another embodiment, Human Monitor interface 53 may instruct Raw Feature Space Analysis Engine 35 to update the Initial Master Rule Set in Knowledge Base 62 with Refined Feature Selection Ruleset(s) and its assigned unique identifier. Other processes may be used to update the Initial Master Rule Set with Refined Feature Selection Ruleset(s) without departing from the spirit and scope of the exemplar method.

In Step 179A, AI System Controller 21 determines if any other Features and Non-Feature Data exists for analysis. If more Features and Non-Feature Data exists, AI System Controller 21 instructs Raw Feature Space Analysis Engine 35 to initiate Steps 171, 172, and 173. If no additional Features and Non-Feature Data exists, AI System Controller 21, instructs Raw Feature Space Analysis Engine 35 to halt the method. Other processes may be used to determine if more Features and Non-Feature Data exists without departing from the spirit and scope of the exemplar method.

Modifications, additions, or omissions may be made to the Method to Determine Initial Feature Set without departing from the scope of the method. The method may include more, fewer, or other steps. Additionally, steps may be performed in any suitable order.

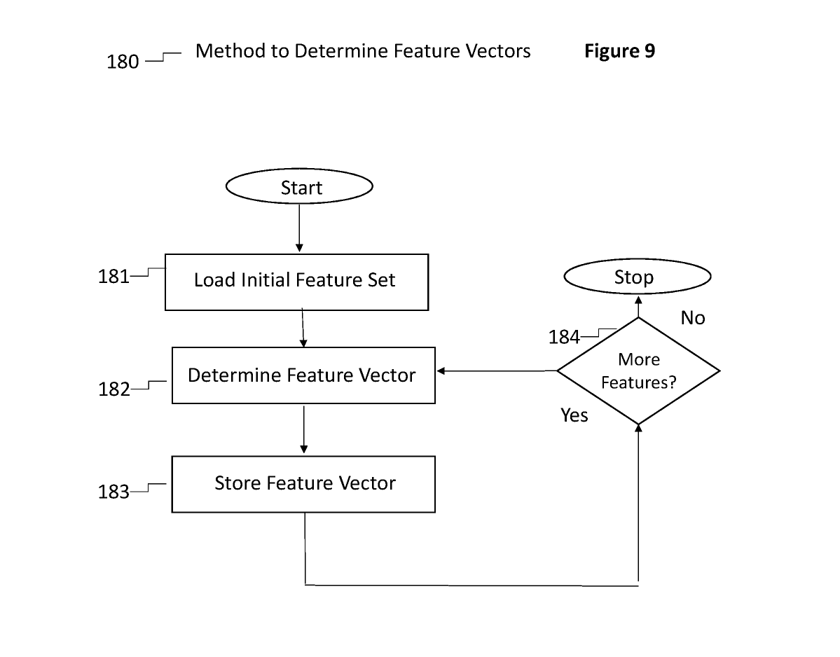

FIG. 9 illustrates one embodiment of AI System Controller 21 and/or Human Monitor interface 53 working in conjunction with Raw Feature Space Analysis Engine 35, and Knowledge Base 62 as exemplary Method 180, Method to Determine Feature Vectors. In certain embodiments, Feature Vectors may be used by 200 Method to Create Initial Data Points from a single Feature Vector, and 210 Method to create Initial Data Points from Multiple Aligned Feature Vectors.

In Step 181, AI System Controller 21 or Human Monitor interface 53 may initiate the method to determine Feature Vectors and load Initial Feature Set contained in the Raw Feature Space into Raw Feature Space Analysis Engine 35 for processing. In one embodiment, AI System Controller 21 may access Knowledge Base 62, retrieve Initial Feature Set, and load Initial Feature Set into Raw Feature Space Analysis Engine 35 for processing. In another embodiment, Human Monitor interface 53 may access Knowledge Base 62, retrieve Initial Feature Set, and load Initial Feature Set into Raw Feature Space Analysis Engine 35 for processing. Other processes may be used to load Initial Feature Set, into Raw Feature Space Analysis Engine 35 without departing from the spirit and scope of the exemplar method.

In Step 182, Raw Feature Space Analysis Engine 35 or Human Monitor interface 53 may determine a Feature in the Initial Feature Set is a Feature Vector. In one embodiment, Raw Feature Space Analysis Engine 35 may determine a Feature in the Initial Feature Set is a Feature Vector based on correlation strengths between Features and/or between Features and Non-Feature Data determined in 170 Method to Determine Initial Feature Set. If Raw Feature Space Analysis Engine 35 determines the existence of a Feature Vector, Raw Feature Space Analysis Engine 35 may tag the Feature Vector with a unique identifier. Tagged Feature Vectors may be used by 190 Method to Align Feature Vectors with Prediction Classes. In another embodiment, Human Monitor interface 53 may determine a Feature in the Initial Feature Set is a Feature Vector based on correlation strengths between Features and/or between Features and Non-Feature Data determined in 170 Method to Determine Initial Feature Set. If Human Monitor interface 53 determines the existence of a Feature Vector, Human Monitor interface 53 may instruct Raw Feature Space Analysis Engine 35 to tag the Feature Vector with a unique identifier. Tagged Feature Vectors may be used by 190 Method to Align Feature Vectors with Prediction Classes. Other processes may be used to determine a Feature Vector from Features and/or Non-Feature Data contained in the Initial Feature Set without departing from the spirit and scope of the exemplar method.

In Step 183, a Feature Vector with its unique identifier may be stored in Knowledge Base 62. In one embodiment, AI System Controller 21 may instruct Raw Feature Space Analysis Engine 35 to store a Feature Vector and its unique identifier in Knowledge Base 62. In another embodiment, Human Monitor interface 53 may instruct Raw Feature Space Analysis Engine 35 to store a Feature Vector and its unique identifier in Knowledge Base 62. Other processes may be used to store a Feature Vector without departing from the spirit and scope of the exemplar method.

In Step 184, AI System Controller 21 determines if more correlated Feature(s) and/or Feature(s) correlated with Non-Feature Data is available for processing. If other correlated Feature(s) and/or Feature(s) correlated with Non-Feature Data exists for processing, AI System Controller 21 instructs Raw Feature Space Analysis Engine 35 to initiate Step 182. If no more correlated Feature(s) and/or Feature(s) correlated with Non-Feature Data is available for processing, AI System Controller 21, instructs Raw Feature Space Analysis Engine 35 to halt the method. Other processes may be used to determine if more correlated Feature(s) and/or Feature(s) correlated with Non-Feature Data is available for processing without departing from the spirit and scope of the exemplar method.

Modifications, additions, or omissions may be made to the Method to Determine Feature Vectors without departing from the scope of the method. The method may include more, fewer, or other steps. Additionally, steps may be performed in any suitable order.

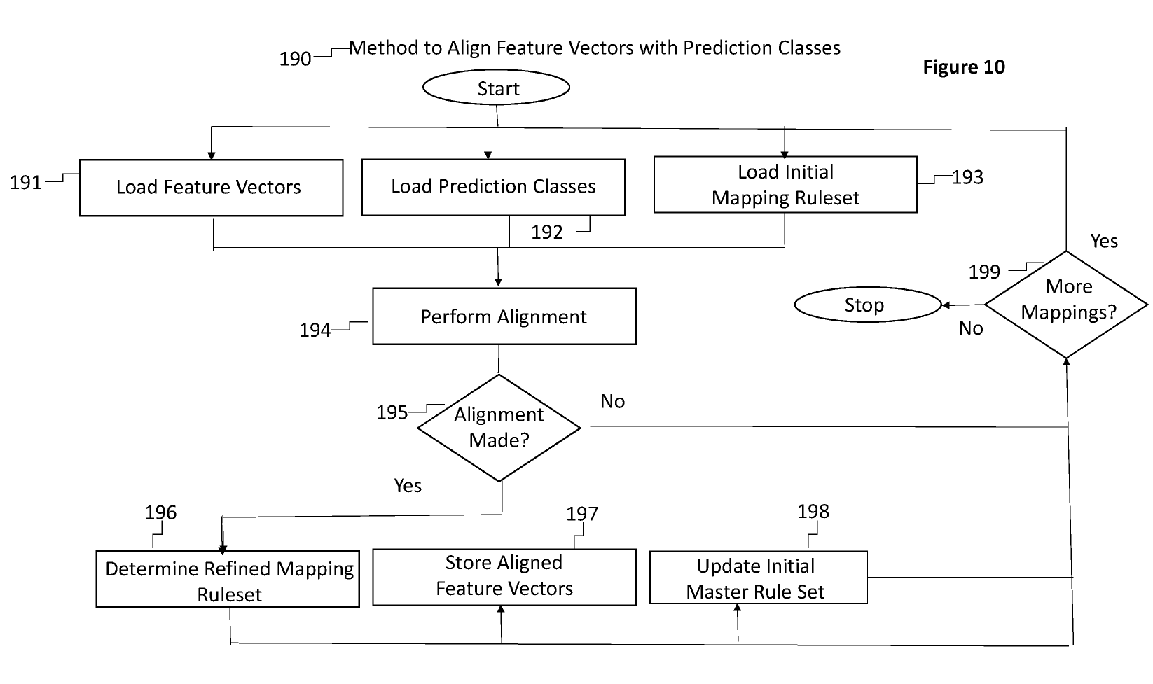

FIG. 10 illustrates one embodiment of AI System Controller 21 and/or Human Monitor interface 53 working in conjunction with Data Point Structure Engine 36, Seed Knowledge Base 61, Tools Knowledge Base 63, and Knowledge Base 62 as exemplary Method 190, Method to Align Feature Vectors with Prediction Classes. Aligned Feature Vectors may be used by 200 Method to Create Initial Data Points from a Single Feature Vector, and/or 210 Method or Create Initial Data Points From Multiple Aligned Feature Vectors.

In Step 191, AI System Controller 21 or Human Monitor interface 53 initiates a process to determine a mapping between Feature Vectors and Prediction Classes, and load Feature Vector into Data Point Structure Engine 36 for processing. In one embodiment, AI System Controller 21 may access Knowledge Base 62, retrieve Feature Vectors based on unique identifiers, and load Feature Vectors and associated unique identifiers into Data Point Structure Engine 36 for processing. In another embodiment, Human Monitor interface 53 may access Knowledge Base 62, retrieve Feature Vectors and associated unique identifiers, and load Feature Vectors and associated unique identifiers into Data Point Structure Engine 36 for processing. Other processes may be used to load Feature Vectors and associated unique identifiers into Data Point Structure Engine 36 without departing from the spirit and scope of the exemplar method.

In Step 192, AI System Controller 21 or Human Monitor interface 53 may load Prediction Classes into Data Point Structure Engine 36 for processing. A Prediction Class is a predetermined mathematical value used to assign Business Outcomes to a Prediction Class value. Prediction Classes may come in multiple forms. For example, in one embodiment, a Prediction Class may exist in a binary form, with a value of 0 or 1, where positive Business Outcomes may be represented by 0, and negative Business Outcomes may be represented by 1. In another embodiment, a Prediction Class may exist in multi-class form, with values of 0, or 1 or 2, where positive Business Outcomes may be represented by 0, negative Business Outcomes may be represented by 1, and undetermined Business Outcomes may be represented by to 2. In one embodiment, AI System Controller 21 may access Knowledge Base 62, retrieve Prediction Classes, and load Prediction Classes into Data Point Structure Engine 36 for processing. In another embodiment, Human Monitor interface 53 may access Knowledge Base 62, retrieve Prediction Classes, and load Prediction Classes into Data Point Structure Engine 36 for processing. Other processes may be used to load Prediction Classes into Data Point Structure Engine 36 without departing from the spirit and scope of the exemplar method.

In Step 193, AI System Controller 21 or Human Monitor interface 53 may load Initial Mapping Ruleset(s) into Data Point Structure Engine 36 for processing. Initial Mapping Ruleset(s) are Machine Learning techniques or other algorithms used to map a Feature Vector to a Prediction Class. Examples of Machine Learning techniques found in an Initial Mapping Ruleset(s) includes but is not limited to Clustering methods (Spectral, K-Means, etc.) for a predetermined number of Prediction Classes, Density or other Non-Parametric Clustering methods (GMMs, DBSCAN, etc.), Semi-Supervised methods (Label Propagation, Transductive Support Vector Machines, etc.), etc. In one embodiment, AI System Controller 21 may access Tools Knowledge Base 63, retrieve one or more individual Initial Mapping Ruleset(s), and load Initial Mapping Ruleset(s) into Data Point Structure Engine 36 for processing. In yet another embodiment, Human Monitor interface 53 may access Tools Knowledge Base 63, retrieve one or more individual Initial Mapping Ruleset(s), and load Initial Mapping Ruleset(s) into Data Point Structure Engine 36 for processing. Other processes may be used to load Initial Mapping Ruleset(s) into Data Point Structure Engine 36 without departing from the spirit and scope of the exemplar method.

In Step 194, Data Point Structure Engine 36 may align a single Feature Vector with a Prediction Class. For example, feature vectors may be aligned with a “positive outcome” or “negative outcome” prediction class, in the case of a binary model. In certain embodiments, the alignment may be considered a cluster analysis utilizing Initial Mapping Ruleset(s) loaded in step 193 to determine a mapping for a Feature Vector Value to a Prediction Class. In certain embodiments, Data Point Structure Engine 36 may align a single Feature Vector with a Prediction Class utilizing loaded Initial Mapping Ruleset(s). Other processes may be used to align a single Feature Vector with a Prediction Class without departing from the spirit and scope of the exemplary method

In Step 195, AI System Controller 21 determines if Data Point Structure Engine 36 aligned a single Feature Vector with a Prediction Class. If an alignment was computed, AI System Controller 21 may assign a unique identifier to the aligned Feature Vector and Prediction Class, and instruct Data Point Structure Engine 36 to initiate Step 196. If no alignment was computed, AI System Controller 21, instructs Data Point Structure Engine 36 to initiate Step 199. Other processes may be used to determine alignment of a single Feature Vector to a Prediction Class without departing from the spirit and scope of the exemplar method.

In Step 196 Refined Mapping Ruleset(s) are determined based on alignments computed in Step 194. Only Initial Mapping Ruleset(s) utilized in aligning a Feature Vector to a Prediction Class Step 194 are determined to be Refined Mapping Ruleset(s). Data Point Structure Engine 36 may tag utilized Refined Mapping Ruleset(s) with a unique identifier. The unique identifier is used as a memory for future use. In one embodiment, based on computed alignments, Data Point Structure Engine 36 may convert Initial Mapping Ruleset(s) utilized in Step 174 into Refined Mapping Ruleset(s) and assign a unique identifier for future use. In another embodiment, based on computed alignments, Human Monitor interface 53 may convert Initial Mapping Ruleset(s) utilized in Step 194 into Refined Mapping Ruleset(s) and assign a unique identifier for future use. Other processes may be used to determine Refined Mapping Ruleset(s) without departing from the spirit and scope of the exemplar method.

In Step 197, aligned Feature Vector and Prediction Class computed in Step 194 is stored in Knowledge Base 62 or sent to Human Monitor interface 53. In one embodiment, AI System Controller 21 may instruct Data Point Structure Engine 36 to update the Feature Vectors contained in Knowledge Base 62 with the aligned Feature Vector and Prediction Class, and their unique identifier. In another embodiment, Human Monitor interface 53 may instruct Data Point Structure Engine 36 to update the Feature Vectors contained in Knowledge Base 62 with the aligned Feature Vector and Prediction Class, and their unique identifier. Other processes may be used to update Feature Vectors with the aligned Feature Vector and Prediction Class, and their unique identifier without departing from the spirit and scope of the exemplar method.

In Step 198, the Initial Master Rule Set in Knowledge Base 62 is updated with Refined Mapping Ruleset(s) and its unique identifier. In one embodiment, AI System Controller 21 may instruct Data Point Structure Engine 36 to update the Initial Master Rule Set in Knowledge Base 62 with Refined Mapping Ruleset(s) and its unique identifier. In another embodiment, Human Monitor interface 53 may instruct Data Point Structure Engine 36 to update the Initial Master Rule Set in Knowledge Base 62 with Refined Mapping Ruleset(s) and its unique identifier. Other processes may be used to update the Initial Master Rule Set with Refined Mapping Ruleset(s) without departing from the spirit and scope of the exemplar method.

In Step 199, AI System Controller 21 determines if any other Feature Vectors and Prediction Classes exists for alignment. If more Feature Vectors and Prediction Classes exists, AI System Controller 21 instructs Data Point Structure Engine 36 to initiate Steps 191, 192, and 193. If no additional Feature Vectors and Prediction Classes exists, AI System Controller 21, instructs Data Point Structure Engine 36 to halt the method. Other processes may be used to determine if more Feature Vectors and Prediction Classes exists without departing from the spirit and scope of the exemplar method.

Modifications, additions, or omissions may be made to the Method to Align Feature Vectors with Prediction Classes without departing from the scope of the method. The method may include more, fewer, or other steps. Additionally, steps may be performed in any suitable order.

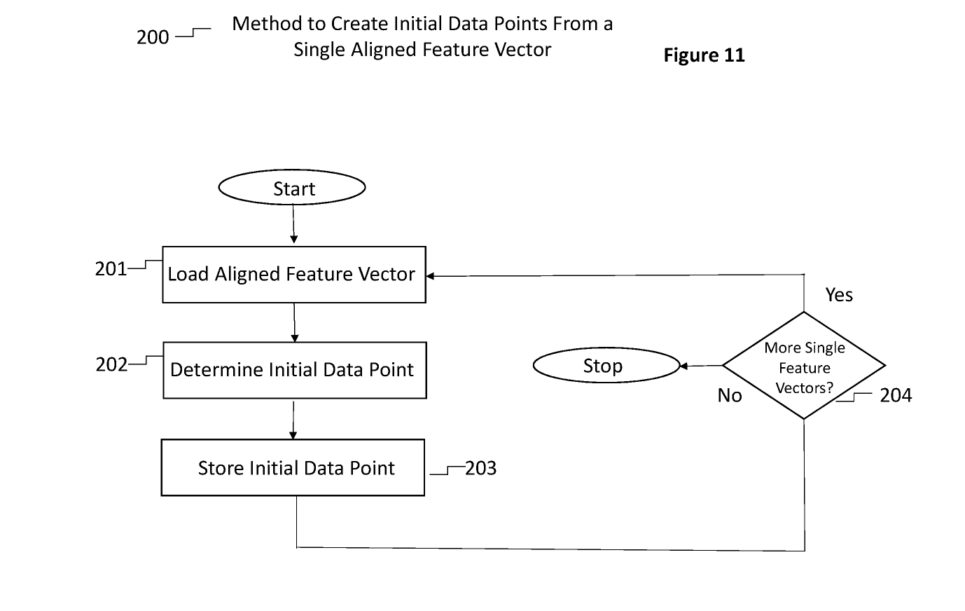

FIG. 11 illustrates one embodiment of AI System Controller 21 and/or Human Monitor interface 53 working in conjunction with Data Point Structure Engine 36, and Knowledge Base 62 as exemplary Method 200, Method to Create Initial Data Points from a Single Aligned Feature Vector. Initial Data Points are used in 220 Method to Create Initial Data Point Structures.

In Step 201, AI System Controller 21 or Human Monitor interface 53 may load an Aligned Feature Vector based on unique identifiers into Data Point Structure Engine 36 for processing. In one embodiment, AI System Controller 21 may access Knowledge Base 62, retrieve an Aligned Feature Vector based on unique identifiers, and load the Aligned Feature Vector into Data Point Structure Engine 36 for processing. In another embodiment, Human Monitor interface 53 may access Knowledge Base 62, retrieve an Aligned Feature Vector based on unique identifiers, and load the Aligned Feature Vector into Data Point Structure Engine 36 for processing. Other processes may be used to load Aligned Feature Vector into Data Point Structure Engine 36 without departing from the spirit and scope of the exemplar method.

In Step 202, Data Point Structure Engine 36 or Human Monitor interface 53 may determine an aligned Feature Vector is an Initial Data Point. In one embodiment, Data Point Structure Engine 36 may determine an Aligned Feature Vector is an Initial Data Point based on correlation strengths determined in 170 Method to Determine Initial Feature Set and alignments determined in 190 Method to Align Feature Vectors with Prediction Classes. If Data Point Structure Engine 36 determines the existence of an Initial Data Point, Data Point Structure Engine 36 may tag the Initial Data Point with a unique identifier for future use. In another embodiment, Human Monitor interface 53 may determine an Aligned Feature Vector is an Initial Data Point based on correlation strengths determined in 170 Method to Determine Initial Feature Set and alignments determined in method 190. If Human Monitor interface 53 determines the existence of an Initial Data Point, Human Monitor interface 53 may instruct Data Point Structure Engine 36 to tag the Initial Data Point with a unique identifier for future use. Other processes may be used to determine an Initial Data Point from an Aligned Feature Vector without departing from the spirit and scope of the exemplar method.

In Step 203, a determined Initial Data Point is stored in Knowledge Base 62. In one embodiment, AI System Controller 21 may instruct Data Point Structure Engine 36 to store a determined Initial Data Point and its unique identifier in Knowledge Base 62. In another embodiment, Human Monitor interface 53 may instruct Data Point Structure Engine 36 to store a determined Initial Data Point and its unique identifier in Knowledge Base 62. Other processes may be used to store a determined Initial Data Point without departing from the spirit and scope of the exemplar method.

In Step 204, AI System Controller 21 determines if another Aligned Feature Vector exists in Knowledge Base 62 for processing. If another Aligned Feature Vector exists for processing, AI System Controller 21 instructs Data Point Structure Engine 36 to initiate Step 201. If no other Aligned Feature Vector exists, AI System Controller 21, instructs Data Point Structure Engine 36 to halt the method. Other processes may be used to determine if another Aligned Feature Vector exists without departing from the spirit and scope of the exemplar method.

Modifications, additions, or omissions may be made to 200 Method to Create Initial Data Points without departing from the scope of the method. The method may include more, fewer, or other steps. Additionally, steps may be performed in any suitable order.

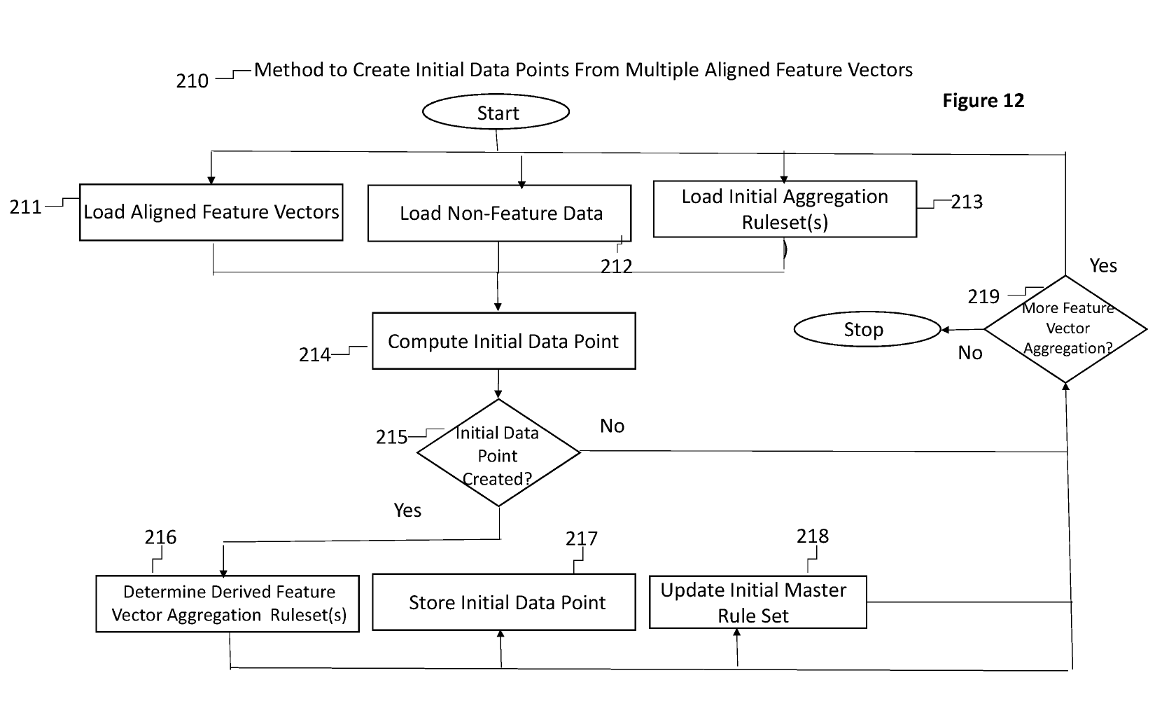

FIG. 12 illustrates one embodiment of AI System Controller 21 and/or Human Monitor interface 53 working in conjunction with Data Point Structure Engine 36, Seed Knowledge Base 61, Tools Knowledge Base 63, and Knowledge Base 62 as exemplary Method 210, Method to Create Initial Data Points from Multiple Feature Vectors. Initial Data Points are used in 220 Method to Create Initial Data Point Structures.

In Step 211, AI System Controller 21 or Human Monitor interface 53 initiates a process to create an Initial Data Point from multiple Aligned Feature Vectors, and load Aligned Feature Vectors based on unique identifiers into Data Point Structure Engine 36 for processing. In one embodiment, AI System Controller 21 may access Knowledge Base 62, retrieve Aligned Feature Vectors based on unique identifiers, and load Aligned Feature Vectors with Prediction Classes into Data Point Structure Engine 36 for processing. In another embodiment, Human Monitor interface 53 may access Knowledge Base 62, retrieve Aligned Feature Vectors based on unique identifiers, and load Aligned Feature Vectors into Data Point Structure Engine 36 for processing. Other processes may be used to load Aligned Feature Vectors into Data Point Structure Engine 36 without departing from the spirit and scope of the exemplar method.

In Step 212, AI System Controller 21 or Human Monitor interface 53 may load Non-Feature Data based on unique identifiers into Data Point Structure Engine 36 for processing. In one embodiment, AI System Controller 21 may access Knowledge Base 62, retrieve Non-Feature Data based on unique identifiers, and load Non-Feature Data into Data Point Structure Engine 36 for processing. In another embodiment, Human Monitor interface 53 may access Knowledge Base 62, retrieve Non-Feature Data based on unique identifiers, and load Non-Feature Data into Data Point Structure Engine 36 for processing. Other processes may be used to load Non-Feature Data into Data Point Structure Engine 36 without departing from the spirit and scope of the exemplar method.

In Step 213, AI System Controller 21 or Human Monitor interface 53 may load Initial Aggregation Ruleset(s) into Data Point Structure Engine 36 for processing. In certain embodiments, Initial Aggregation Ruleset(s) are algorithms used to analyze Non-Feature Data in the context of Aligned Feature Vectors, and based on analysis, determine an aggregation of Aligned Feature Vectors to form an Initial Data Point. In one embodiment, AI System Controller 21 may access Tools Knowledge Base 63, retrieve one or more individual Initial Aggregation Ruleset(s), and load Initial Aggregation Ruleset(s) into Data Point Structure Engine 36 for processing. In yet another embodiment, Human Monitor interface 53 may access Tools Knowledge Base 63, retrieve one or more individual Initial Aggregation Ruleset(s), and load Initial Aggregation Ruleset(s) into Data Point Structure Engine 36 for processing. Other processes may be used to load Initial Aggregation Ruleset(s) into Data Point Structure Engine 36 without departing from the spirit and scope of the exemplar method.

In Step 214, Data Point Structure Engine 36 may compute an Initial Data Point. In one embodiment, Data Point Structure Engine 36 may compute an Initial Data Point from aggregating values of multiple Aligned Feature Vectors utilizing loaded Initial Aggregation Ruleset(s) and Non-Feature Data based on correlation strengths determined in 170 Method to Determine Initial Feature Set and alignments determined in 190 Method to Align Feature Vectors with Prediction Classes. Other processes may be used to compute an Initial Data Point without departing from the spirit and scope of the exemplar method.

In Step 215, AI System Controller 21 determines if Data Point Structure Engine 36 created an Initial Data Point. If an Initial Data Point was computed, AI System Controller 21 may assign a unique identifier to the Initial Data Point, and instruct Data Point Structure Engine 36 to initiate Step 216. If no Initial Data Point was computed, AI System Controller 21, instructs Data Point Structure Engine 36 to initiate Step 219. Other processes may be used to determine if Data Point Structure Engine 36 created an Initial Data Point without departing from the spirit and scope of the exemplar method.

In Step 216, Refined Aggregation Ruleset(s) are determined based Initial Data Points computed in Step 214. Only Initial Aggregation Ruleset(s) utilized in computing an Initial Data Point in Step 214 are determined to be Refined Aggregation Ruleset(s). Data Point Structure Engine 36 may tag utilized Refined Aggregation Ruleset(s) with a unique identifier. The unique identifier is used as a memory for developing future aggregations. In one embodiment, based on computed Initial Data Points, Data Point Structure Engine 36 may convert Initial Aggregation Ruleset(s) utilized in Step 214 into Refined Aggregation Ruleset(s) and assign a unique identifier for future use. In another embodiment, based on computed alignments, Human Monitor interface 53 may convert Initial Aggregation Ruleset(s) utilized in Step 214 into Refined Aggregation Ruleset(s) and assign a unique identifier for future use. Other processes may be used to determine Refined Aggregation Ruleset(s) without departing from the spirit and scope of the exemplar method.

In Step 217, a determined Initial Data Point and its unique identifier is stored in Knowledge Base 62. In one embodiment, AI System Controller 21 may instruct Data Point Structure Engine 36 to store a determined Initial Data Point and its unique identifier in Knowledge Base 62. In another embodiment, Human Monitor interface 53 may instruct Data Point Structure Engine 36 to store a determined Initial Data Point and its unique identifier in Knowledge Base 62. Other processes may be used to store a determined Initial Data Point without departing from the spirit and scope of the exemplar method.

In Step 218, the Initial Master Rule Set in Knowledge Base 62 is updated with Refined Aggregation Ruleset(s) and its assigned unique identifier. In one embodiment, AI System Controller 21 may instruct Raw Feature Space Analysis Engine 35 to update the Initial Master Rule Set in Knowledge Base 62 with Refined Aggregation Ruleset(s) and its assigned unique identifier. In another embodiment, Human Monitor interface 53 may instruct Raw Feature Space Analysis Engine 35 to update the Initial Master Rule Set in Knowledge Base 62 with Refined Aggregation Ruleset(s) and its assigned unique identifier. Other processes may be used to update the Initial Master Rule Set with Refined Aggregation Ruleset(s) without departing from the spirit and scope of the exemplar method.

In Step 219, AI System Controller 21 determines if more Aligned Feature Vectors and Non-Feature Data exists in Knowledge Base 62 for processing. If more Aligned Feature Vectors and Non-Feature Data exists for processing, AI System Controller 21 instructs Data Point Structure Engine 36 to initiate Steps 211, 212, and 213. If no more Aligned Feature Vectors and Non-Feature Data exists, AI System Controller 21, instructs Data Point Structure Engine 36 to halt the method. Other processes may be used to determine if more Aligned Feature Vectors and Non-Feature Data exists without departing from the spirit and scope of the exemplar method.

Modifications, additions, or omissions may be made to the Method to Create Initial Data Points From Multiple Feature Vectors without departing from the scope of the method. The method may include more, fewer, or other steps. Additionally, steps may be performed in any suitable order.

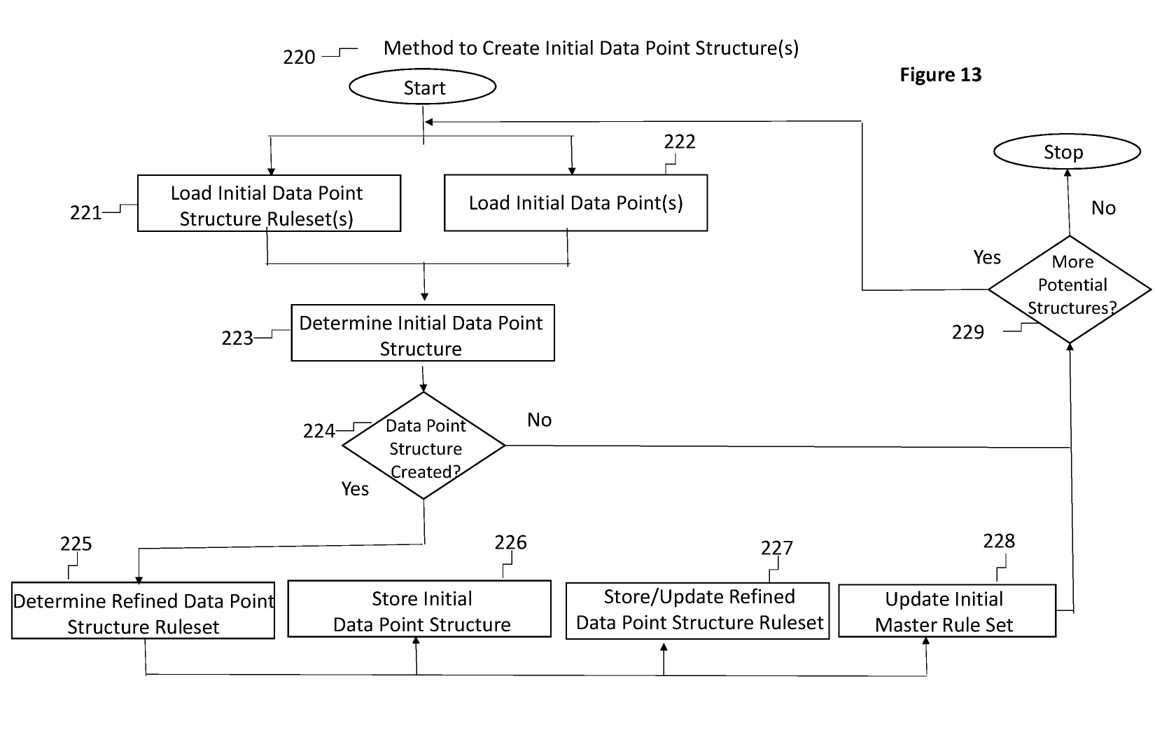

FIG. 13 illustrates one embodiment of AI System Controller 21 and/or Human Monitor interface 53 working in conjunction with Data Point Structure Engine 36, Seed Knowledge Base 61, Tools Knowledge Base 63, and Knowledge Base 62 as exemplary Method 220, Method to Create Initial Data Point Structure(s). Initial Data Point Structures comprise Data Points processed to form one or more structures used by 270 Method to Train a Predictive or Evaluative Model.

In Step 221, AI System Controller 21 or Human Monitor interface 53 may load Initial Data Point Structure Ruleset(s) into Data Point Structure Engine 36 for processing. In certain embodiments, Initial Data Point Structure Rulesets are algorithms used to designate which Initial Data Points comprise Initial Data Point Structure(s). In one embodiment, AI System Controller 21 may access Tools Knowledge Base 63, retrieve one or more individual Initial Data Point Structure Ruleset(s), and load Initial Data Point Structure Ruleset(s) into Data Point Structure Engine 36 for processing. In yet another embodiment, Human Monitor interface 53 may access Tools Knowledge Base 63, retrieve one or more individual Initial Data Point Structure Ruleset(s), and load Initial Data Point Structure Ruleset(s) into Data Point Structure Engine 36 for processing. Other processes may be used to load Initial Data Point Structure Ruleset(s) into Data Point Structure Engine 36 without departing from the spirit and scope of the exemplar method.

In Step 222, AI System Controller 21 or Human Monitor interface 53 may load Initial Data Points based on unique identifiers into Data Point Structure Engine 36 for processing. In one embodiment, AI System Controller 21 may access Knowledge Base 62, retrieve Initial Data Points based on unique identifiers, and load Initial Data Points into Data Point Structure Engine 36 for processing. In another embodiment, Human Monitor interface 53 may access Knowledge Base 62, retrieve Initial Data Points, and load Initial Data Points based on unique identifiers into Data Point Structure Engine 36 for processing. Other processes may be used to load Initial Data Points into Data Point Structure Engine 36 without departing from the spirit and scope of the exemplar method.

In Step 223, Data Point Structure Engine 36 may determine a single Initial Data Point Structure. In certain embodiments, Data Point Structure Engine 36 may determine a single Initial Data Point Structure based on loaded Initial Data Point Structure Ruleset(s) applied to two or more loaded Initial Data Points Other processes may be used to determine a single Initial Data Point Structure without departing from the spirit and scope of the exemplar method.

In Step 224, AI System Controller 21 determines if Data Point Structure Engine 36 created a single Data Point Structure. If a single Data Point Structure was created, AI System Controller 21 will consider the single Data Point Structure as an Initial Data Point Structure. AI System Controller 21 may assign a unique identifier to the Initial Data Point Structure and instruct Data Point Structure Engine 36 to initiate Step 225. If no Initial Data Point Structure was created, AI System Controller 21, instructs Data Point Structure Engine 36 to initiate Step 229. Other processes may be used to determine if an Initial Data Point Structure was created without departing from the spirit and scope of the exemplar method.

In Step 225, a Refined Data Point Structure Ruleset is determined by encoding the decisions made to determine Initial Data Point Structure(s) in Step 223. Only Initial Data Point Structure Ruleset(s) utilized in computing an Initial Data Point Structure in Step 224 are determined to be Refined Data Point Structure Ruleset(s). Data Point Structure Engine 36 may tag utilized Refined Data Point Structure Ruleset(s) with a unique identifier. The unique identifier is used as a memory for developing future Data Point Structures. In one embodiment, based on computed Initial Data Point Structure, Data Point Structure Engine 36 may convert Initial Data Point Structure Ruleset(s) utilized in Step 223 into Refined Data Point Structure Ruleset and assign a unique identifier for future use. In another embodiment, based on computed Initial Data Point Structure, Human Monitor interface 53 may convert Initial Data Point Structure Ruleset(s) utilized in Step 223 into Refined Data Point Structure Ruleset and assign a unique identifier for future use. Other processes may be used to determine a Refined Data Point Structure Ruleset without departing from the spirit and scope of the exemplar method.

In Step 226, an Initial Data Point Structure and its unique identifier is stored in Knowledge Base 62. In one embodiment, AI System Controller 21 may instruct Data Point Structure Engine 36 to store the Initial Data Point Structure and its unique identifier in Knowledge Base 62. In another embodiment, Human Monitor interface 53 may instruct Data Point Structure Engine 36 to store the Initial Data Point Structure and its unique identifier in Knowledge Base 62. Other processes may be used to store the Initial Data Point Structure without departing from the spirit and scope of the exemplar method.

In Step 227 the Refined Data Point Structure Ruleset and its unique identifier is stored in Tools Knowledge Base 63 for future use. In one embodiment, AI System Controller 21 may instruct Data Point Structure Engine 36 to store the Refined Data Point Structure Ruleset(s) and its unique identifier in Tools Knowledge Base 63 for future use. In another embodiment, Human Monitor interface 53 may instruct Data Point Structure Engine 36 to store the Refined Data Point Structure Ruleset(s) and its unique identifier in Tools Knowledge Base 63 for future use. Other processes may be used to store/update the Refined Data Point Structure Ruleset without departing from the spirit and scope of the exemplar method.

In Step 228, the Initial Master Rule Set in Knowledge Base 62 is updated with the Refined Data Point Structure Ruleset and its unique identifier. In one embodiment, AI System Controller 21 may instruct Data Point Structure Engine 36 to update the Initial Master Rule Set in Knowledge Base 62 with the Refined Data Point Structure Ruleset and its unique identifier. In another embodiment, Human Monitor interface 53 may instruct Data Point Structure Engine 36 to update the Initial Master Rule Set in Knowledge Base 62 with the Refined Data Point Structure Ruleset and its unique identifier. Other processes may be used to update the Initial Master Rule Set with the Refined Data Point Structure Ruleset without departing from the spirit and scope of the exemplar method.

In Step 229, AI System Controller 21 determines if the creation of additional Initial Data Point Structure(s) is possible. If creation of more Initial Data Point Structure(s) is possible, AI System Controller 21 instructs Data Point Structure Engine 36 to initiate Steps 221 and 222. If creation of more Initial Data Point Structure(s) is not possible, AI System Controller 21, instructs Data Point Structure Engine 36 to halt the method. Other processes may be used to determine if the creation of additional Initial Data Point Structure(s) is possible without departing from the spirit and scope of the exemplar method.

Modifications, additions, or omissions may be made to the Method to Create Initial Data Point Structure(s) without departing from the scope of the method. The method may include more, fewer, or other steps. Additionally, steps may be performed in any suitable order.

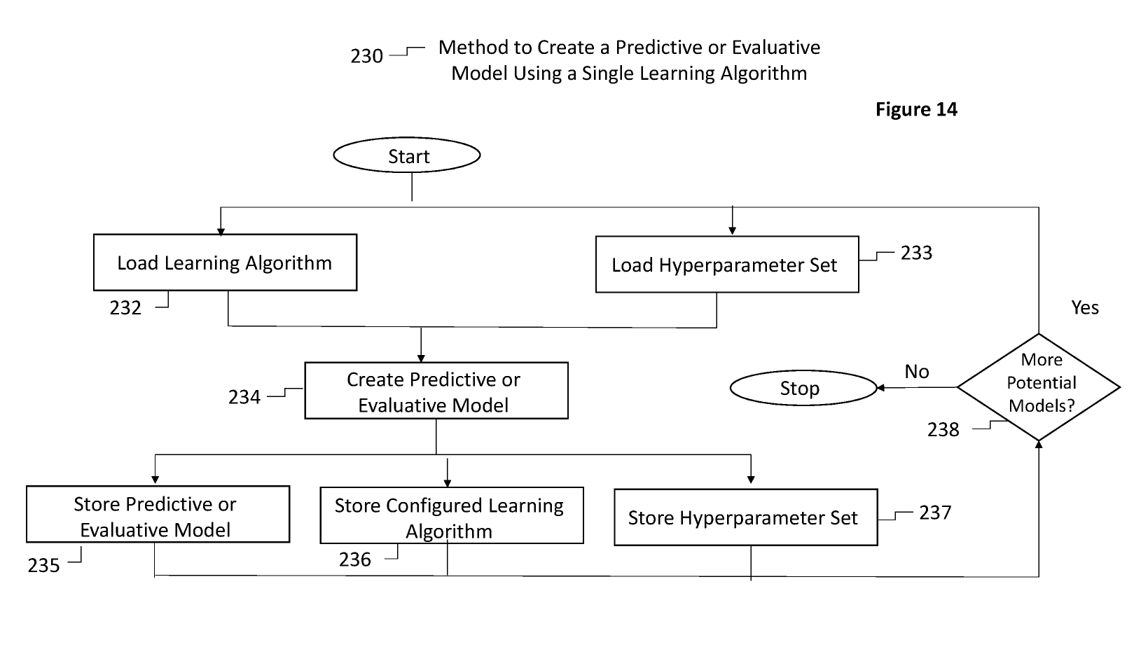

FIG. 14 illustrates one embodiment of AI System Controller 21 and/or Human Monitor interface 53 working in conjunction with Model Builder Engine 37, Tools Knowledge Base 63, and Knowledge Base 62 as exemplary Method 230, Method to Create a Predictive or Evaluative Model Using a Single Learning Algorithm. In certain embodiments, a Predictive or Evaluative Model created utilizing a properly configured Learning Algorithm may be used by 270 Method to Train a Predictive or Evaluative Model.

In Step 232, AI System Controller 21 or Human Monitor interface 53 initiates a process to create a Predictive or Evaluative Model using a single Learning Algorithm and load Learning Algorithm into Model Builder Engine 37 for processing. Learning Algorithms can be considered the “brains” behind Machine Learning techniques utilized in Model building. Major types of Machine Learning techniques include but not limited to Supervised Learning, Unsupervised Learning, Semi-Supervised Learning, Reinforcement Learning, etc. There are thousands of Learning Algorithms available to support various Machine Learning techniques including but limited to k-Means, Logistic Regression, Neural Network, Least Angle Regression (LARS), etc. In one embodiment, AI System Controller 21 may access Knowledge Base 62 or Tools Knowledge Base 63, retrieve single Learning Algorithm, and load single Learning Algorithm into Model Builder Engine 37 for processing. In another embodiment, Human Monitor interface 53 may access Knowledge Base 62 or Tools Knowledge Base 63, retrieve single Learning Algorithm, and load single Learning Algorithm into Model Builder Engine 37 for processing. Other processes may be used to load a single Learning Algorithm into Model Builder Engine 37 without departing from the spirit and scope of the exemplar method.

In Step 233, AI System Controller 21 or Human Monitor interface 53 may load a Hyperparameter Set into Model Builder Engine 37 for processing. Hyperparameters are used to configure Learning Algorithms. Hyperparameters may include but not limited to the choice of kernel function in a kernel-based method, attenuation factors in iterative methods, basis function weights in approximation algorithms, etc. In one embodiment, AI System Controller 21 may access Tools Knowledge Base 63, retrieve Hyperparameter set, and load Hyperparameter set into Model Builder Engine 37 for processing. In another embodiment, Human Monitor interface 53 may access Tools Knowledge Base 63, retrieve Hyperparameter set, and load Hyperparameter set into Model Builder Engine 37 for processing. Other processes may be used to load Hyperparameter set into Model Builder Engine 37 without departing from the spirit and scope of the exemplar method.

In Step 234, Model Builder Engine 37 may create a Predictive or Evaluative Model utilizing a single Learning Algorithm. In certain embodiments, Model Builder Engine 37 may create a Predictive or Evaluative Model by configuring a loaded single Learning Algorithm with a loaded Hyperparameter Set and applying the configured Learning Algorithm to loaded Initial Data Point Structure(s). Model Builder Engine 37 may assign a unique identifier to a created Predictive or Evaluative Model for future use. Model Builder Engine 37 may assign a unique identifier to configured Learning Algorithm for future use. Model Builder Engine 37 may assign a unique identifier to Hyperparameter Set utilized for future use. Other processes may be used to create a Predictive or Evaluative Model utilizing a single Learning Algorithm without departing from the spirit and scope of the exemplar method.

In Step 235, a created Predictive or Evaluative Model and its unique identifier is stored in Knowledge Base 62. In one embodiment, AI System Controller 21 may instruct Model Builder Engine 37 to store a created Predictive or Evaluative Model and its unique identifier in Knowledge Base 62. In another embodiment, Human Monitor interface 53 may instruct Model Builder Engine 37 to store a created Predictive or Evaluative Model and its unique identifier in Knowledge Base 62. Other processes may be used to store a created Predictive or Evaluative Model without departing from the spirit and scope of the exemplar method.

In Step 236, a Learning Algorithm configured in Step 234 and its unique identifier is stored in Knowledge Base 62. In one embodiment, AI System Controller 21 may instruct Model Builder Engine 37 to store a configured Learning Algorithm and its unique identifier in Knowledge Base 62. In another embodiment, Human Monitor interface 53 may instruct Model Builder Engine 37 to store a configured Learning Algorithm and its unique identifier in Knowledge Base 62. Other processes may be used to store a configured Learning Algorithm without departing from the spirit and scope of the exemplar method.

In Step 237, a Hyperparameter Set and its unique identifier utilized to configure a Learning Algorithm in Step 234 is stored in Knowledge Base 62. In one embodiment, AI System Controller 21 may instruct Model Builder Engine 37 to store Hyperparameter Set and its unique identifier, utilized to configure a Learning Algorithm in Knowledge Base 62. In another embodiment, Human Monitor interface 53 may instruct Model Builder Engine 37 to store Hyperparameter Set and its unique identifier utilized to configure a Learning Algorithm in Knowledge Base 62. Other processes may be used to store a Hyperparameter Set utilized to configure a Learning Algorithm without departing from the spirit and scope of the exemplar method.

In Step 238, AI System Controller 21 determines if more potential Predictive or Evaluative Models can be created utilizing another Learning Algorithm and/or Hyperparameter set applied to Initial Data Point Structure(s). If other viable Learning Algorithm(s) and/or Hyperparameter Set(s) exists to build a potential Predictive or Evaluative Model, AI System Controller 21 instructs Model Builder Engine 37 to initiate Steps 231, 232, and 233. If no other viable Learning Algorithm(s) and/or Hyperparameter Set(s) exists, AI System Controller 21, instructs Model Builder Engine 37 to halt the method. Other processes may be used to determine if other viable Learning Algorithm(s) and/or Hyperparameter Set(s) exists to build a potential Predictive or Evaluative Model without departing from the spirit and scope of the exemplar method.

Modifications, additions, or omissions may be made to the Method to Create a Predictive or Evaluative Model Using a Single Learning Algorithm without departing from the scope of the method. The method may include more, fewer, or other steps. Additionally, steps may be performed in any suitable order.

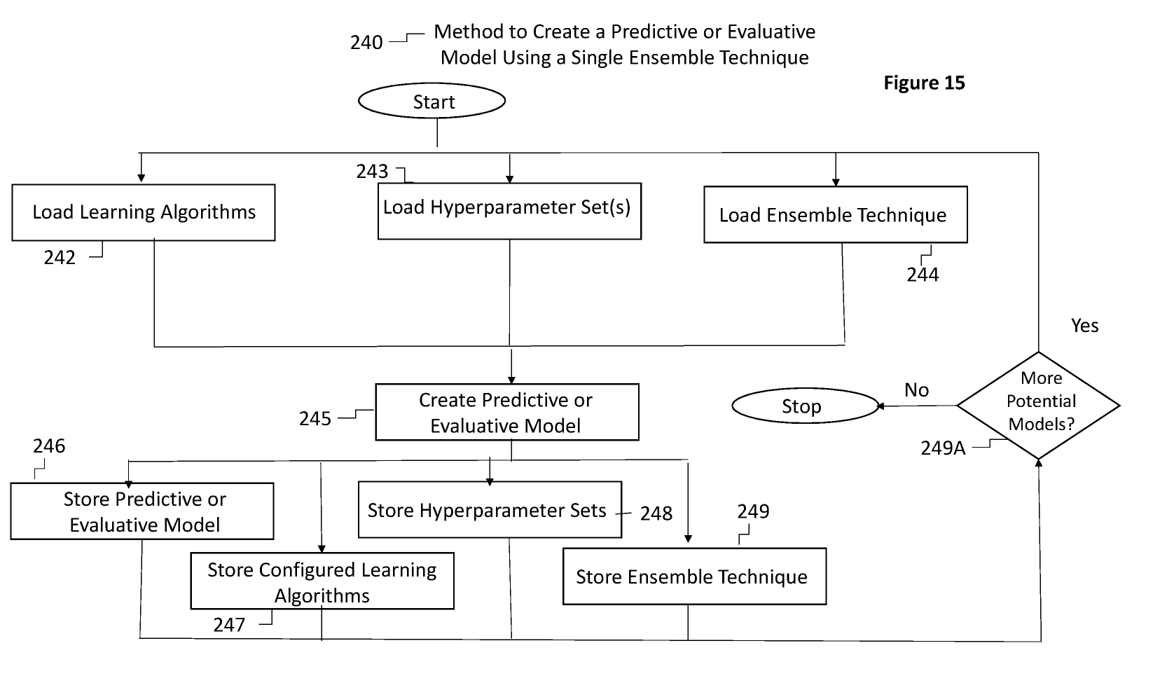

FIG. 15 illustrates one embodiment of AI System Controller 21 and/or Human Monitor interface 53 working in conjunction with Model Builder Engine 37, Tools Knowledge Base 63, and Knowledge Base 62 as exemplary Method 240, Method to Create a Predictive or Evaluative Model Using a Single Ensemble Technique. In certain embodiments, a Predictive or Evaluative Model created utilizing an Ensemble Technique may be used by 270 Method to Train a Predictive or Evaluative Model.

In Step 242, AI System Controller 21 or Human Monitor interface 53 initiates a process to create a Predictive or Evaluative Model using a single Ensemble Technique and load two or more Learning Algorithms into Model Builder Engine 37 for processing. In one embodiment, AI System Controller 21 may access Knowledge Base 62 and/or Tools Knowledge Base 63, retrieve two or more Learning Algorithms, and load two or more Learning Algorithms into Model Builder Engine 37 for processing. In another embodiment, Human Monitor interface 53 may access Knowledge Base 62 and/or Tools Knowledge Base 63, retrieve two or more Learning Algorithms, and load two or more Learning Algorithms into Model Builder Engine 37 for processing. Other processes may be used to load two or more Learning Algorithm into Model Builder Engine 37 without departing from the spirit and scope of the exemplar method.

In Step 243, AI System Controller 21 or Human Monitor interface 53 may load one or more Hyperparameter Set(s) into Model Builder Engine 37 for processing. In one embodiment, AI System Controller 21 may access Tools Knowledge Base 63, retrieve one or more Hyperparameter Set(s), and load one or more Hyperparameter Set(s) into Model Builder Engine 37 for processing. In another embodiment, Human Monitor interface 53 may access Tools Knowledge Base 63, retrieve one or more Hyperparameter Set(s), and load one or more Hyperparameter Set(s) into Model Builder Engine 37 for processing. Other processes may be used to load Hyperparameter Set(s) into Model Builder Engine 37 without departing from the spirit and scope of the exemplar method.

In Step 244, AI System Controller 21 or Human Monitor interface 53 may load a single Ensemble Technique into Model Builder Engine 37 for processing. An Ensemble Technique is used to assemble two or more configured Learning Algorithms in a sequence in building a Predictive or Evaluative Model. In one embodiment, AI System Controller 21 may access Knowledge Base 62 and/or Tools Knowledge Base 63, retrieve single Ensemble Technique, and load single Ensemble Technique into Model Builder Engine 37 for processing. In another embodiment, Human Monitor interface 53 may access Knowledge Base 62 and/or Tools Knowledge Base 63, retrieve single Ensemble Technique, and load single Ensemble Technique into Model Builder Engine 37 for processing. Other processes may be used to load a single Ensemble Technique into Model Builder Engine 37 without departing from the spirit and scope of the exemplar method.

In Step 245, Model Builder Engine 37 may create a Predictive or Evaluative Model utilizing a single Ensemble Technique. In certain embodiments, Model Builder Engine 37 may create a Predictive or Evaluative Model by configuring loaded Learning Algorithms with loaded Hyperparameter Sets, applying a single Ensemble Technique to assemble configured Learning Algorithms, and applying the assembled Learning Algorithms to loaded Initial Data Point Structure(s). For example, a boosting ensemble technique may be used in conjunction with multiple decision trees given loaded Hyperparameter Sets specific to decision tree learning algorithms, as applied to the loaded Initial Data Point Structure(s). Model Builder Engine 37 may assign a unique identifier to a created Predictive or Evaluative Model for future use. Model Builder Engine 37 may assign a unique identifier to configured Learning Algorithms for future use. Model Builder Engine 37 may assign a unique identifier to Hyperparameter Set(s) utilized for future use. Model Builder Engine 37 may assign a unique identifier to Ensemble Technique for future use. Other processes may be used to create a Predictive or Evaluative Model utilizing a single Ensemble Technique without departing from the spirit and scope of the exemplar method.

In Step 246, a created Predictive or Evaluative Model and its unique identifier is stored in Knowledge Base 62. In one embodiment, AI System Controller 21 may instruct Model Builder Engine 37 to store a created Predictive or Evaluative Model and its unique identifier in Knowledge Base 62. In another embodiment, Human Monitor interface 53 may instruct Model Builder Engine 37 to store a created Predictive or Evaluative Model and its unique identifier in Knowledge Base 62. Other processes may be used to store a created Predictive or Evaluative Model without departing from the spirit and scope of the exemplar method.

In Step 247, Learning Algorithms and their unique identifiers configured in Step 245 is stored in Knowledge Base 62. In one embodiment, AI System Controller 21 may instruct Model Builder Engine 37 to store configured Learning Algorithms and their unique identifiers in Knowledge Base 62. In another embodiment, Human Monitor interface 53 may instruct Model Builder Engine 37 to store configured Learning Algorithms and their unique identifiers in Knowledge Base 62. Other processes may be used to store a configured Learning Algorithm without departing from the spirit and scope of the exemplar method.

In Step 248, Hyperparameter Set(s) and their unique identifiers utilized to configure Learning Algorithms in Step 245 is stored in Knowledge Base 62. In one embodiment, AI System Controller 21 may instruct Model Builder Engine 37 to store Hyperparameter Set(s) and their unique identifiers utilized to configure Learning Algorithms in Knowledge Base 62. In another embodiment, Human Monitor interface 53 may instruct Model Builder Engine 37 to store Hyperparameter Set(s) and their unique identifiers utilized to configure Learning Algorithms in Knowledge Base 62. Other processes may be used to store a Hyperparameter Set(s) utilized to configure Learning Algorithms without departing from the spirit and scope of the exemplar method.

In Step 249, the Ensemble Technique and its unique identifier utilized to create a Predictive or Evaluative Model in Step 245 is stored in Knowledge Base 62. In one embodiment, AI System Controller 21 may instruct Model Builder Engine 37 to store the Ensemble Technique and its unique identifier utilized to create a Predictive or Evaluative Model in Knowledge Base 62. In another embodiment, Human Monitor interface 53 may instruct Model Builder Engine 37 to store the Ensemble Technique and its unique identifier utilized to create a Predictive or Evaluative Model in Knowledge Base 62. Other processes may be used to store the Ensemble Technique utilized to create a Predictive or Evaluative Model without departing from the spirit and scope of the exemplar method.

In Step 249A, AI System Controller 21 determines if more potential Predictive or Evaluative Models can be created utilizing another Single Ensemble Technique. If other Single Ensemble Technique(s) exists to build a potential Predictive or Evaluative Model, AI System Controller 21 instructs Model Builder Engine 37 to initiate Steps 242, 243, and 244. If no other viable Single Ensemble Technique exists, AI System Controller 21, instructs Model Builder Engine 37 to halt the method. Other processes may be used to determine if other viable Single Ensemble Technique exists to build a potential Predictive or Evaluative Model without departing from the spirit and scope of the exemplar method.

Modifications, additions, or omissions may be made to the Method to Create a Predictive or Evaluative Model Using a Single Ensemble Technique without departing from the scope of the method. The method may include more, fewer, or other steps. Additionally, steps may be performed in any suitable order.

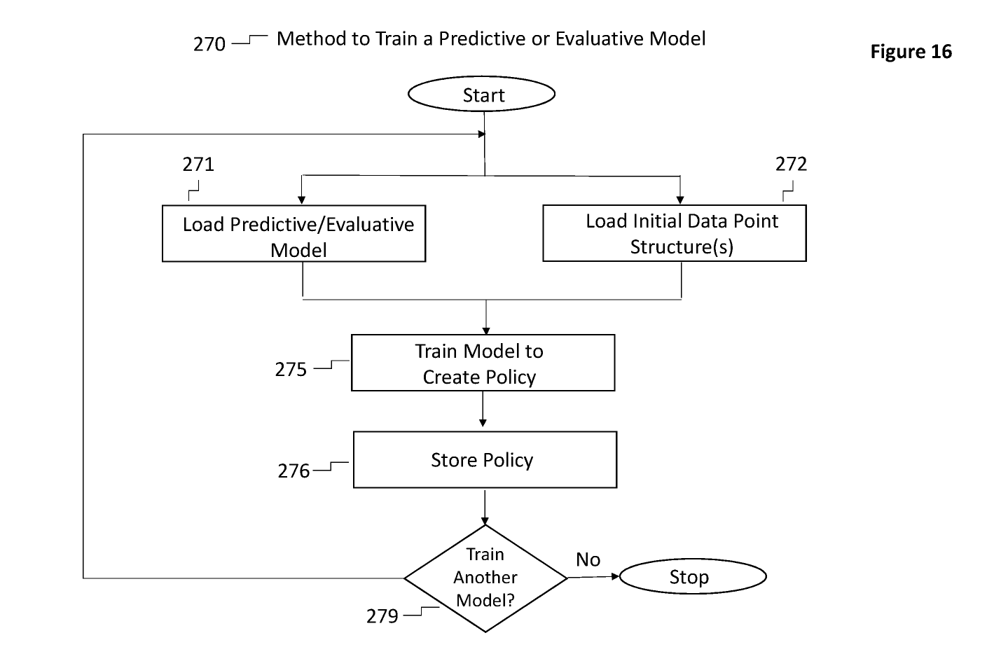

FIG. 16 illustrates one embodiment of AI System Controller 21 and/or Human Monitor interface 53 working in conjunction with Training Engine 39, Seed Knowledge Base 61, Knowledge Base 62, Tools Knowledge Base 63, Predictive Outcomes 64, and Evaluative Outcomes 65 as exemplary Method 270, Method to Train a Predictive or Evaluative Model.

In Step 271, AI System Controller 21 or Human Monitor interface 53 initiates a process to train a Predictive or Evaluative Model created in accordance with 230 Method to Create a Model Using a Single Learning Algorithm or 240 Method to Create a Model Using a Single Ensemble Technique, and load a single Predictive or Evaluative Model and its unique identifier into Training Engine 39 for processing. In certain embodiments, Trained Models may be used to generate Policies for use in 290 Method to Utilize Predictive Policies to Generate Predictive Outcomes, or 300 Method to Utilize Evaluative Policies to Generate Evaluative Outcomes. In one embodiment, AI System Controller 21 may access Knowledge Base 62, retrieve a single Predictive or Evaluative Model and its unique identifier, and load a single Predictive or Evaluative Model and its unique identifier into Training Engine 39 for processing. In another embodiment, Human Monitor interface 53 may access Knowledge Base 62, retrieve a single Predictive or Evaluative Model and its unique identifier, and load a single Predictive or Evaluative Model and its unique identifier into Training Engine 39 for processing. Other processes may be used to load a single Predictive or Evaluative Model into Training Engine 39 without departing from the spirit and scope of the exemplar method.

In Step 272, AI System Controller 21 or Human Monitor interface 53 may load Initial Data Point Structure(s) and their unique identifiers into Training Engine 39 for processing. In one embodiment, AI System Controller 21 may access Knowledge Base 62, retrieve Initial Data Point Structure(s) and their unique identifiers, and load into Training Engine 39 for processing. In another embodiment, Human Monitor interface 53 may access Knowledge Base 62, retrieve Initial Data Point Structure(s) and their unique identifiers, and load into Training Engine 39 for processing. Other processes may be used to load Initial Data Point Structure(s) into Training Engine 39 without departing from the spirit and scope of the exemplar method.

In Step 275, Training Engine 39 may train a Predictive or Evaluative Model loaded in Step 271 by providing it Initial Data Point Structure(s) loaded in Step 272 as input to create a Predictive or Evaluative Policy. In certain embodiments, a created Predictive Policy may be used by 290 Method to Utilize Predictive Policies to Generate Predictive Outcomes, and an Evaluative Policy may be used by 300 Method to Utilize Evaluative Policies to Generate Evaluative Outcomes. In certain embodiments, the loaded Predictive or Evaluative Model, created in 230 Method to Create a Predictive or Evaluative Model Using a Single Learning Algorithm, is trained by initializing its associated Learning Algorithm with its associated Hyperparameter Set and executing the initialized Learning Algorithm using the loaded Initial Data Point Structure(s) as input, producing a Predictive or Evaluative Policy as output. In certain embodiments, the loaded Predictive or Evaluative Model, created in 240 Method to Create a Predictive or Evaluative Model Using a Single Ensemble Technique, is trained by initializing each of its associated Learning Algorithms with their corresponding Hyperparameter Set(s) and executing its associated Ensemble Technique using the loaded Initial Data Point Structure(s) as input, producing a Predictive or Evaluative Policy as output. In these embodiments, the Ensemble Technique executes a combination of the Learning Algorithms to produce the Predictive or Evaluative Policy. In certain embodiments, Training Engine 39 may assign a unique identifier to a generated Predictive Policy or Evaluative Policy for future use. Other processes may be used to create Predictive or Evaluative Policies without departing from the spirit and scope of the exemplar method.

In Step 276, a created Predictive or Evaluative Policy and its unique identifier is stored in Knowledge Base 62. In one embodiment, AI System Controller 21 may instruct Training Engine 39 to store a created Predictive or Evaluative Policy and its unique identifier in Knowledge Base 62. In another embodiment, Human Monitor interface 53 may instruct Training Engine 39 to store a created Predictive or Evaluative Policy and its unique identifier in Knowledge Base 62. Other processes may be used to store a created Predictive or Evaluative Policy without departing from the spirit and scope of the exemplar method.

In Step 279, AI System Controller 21 determines if the training of additional Predictive or Evaluative Model(s) is possible. If training of additional Predictive or Evaluative Model(s) is possible, AI System Controller 21 instructs Training Engine 39 to initiate Steps 271 and 272. If training of more Predictive or Evaluative Model(s) is not possible, AI System Controller 21, instructs Training Engine 39 to halt the method. Other processes may be used to determine if the creation of additional Predictive or Evaluative Model(s) is possible without departing from the spirit and scope of the exemplar method.

Modifications, additions, or omissions may be made to the Method to Train a Predictive or Evaluative Model without departing from the scope of the method. The method may include more, fewer, or other steps. Additionally, steps may be performed in any suitable order.

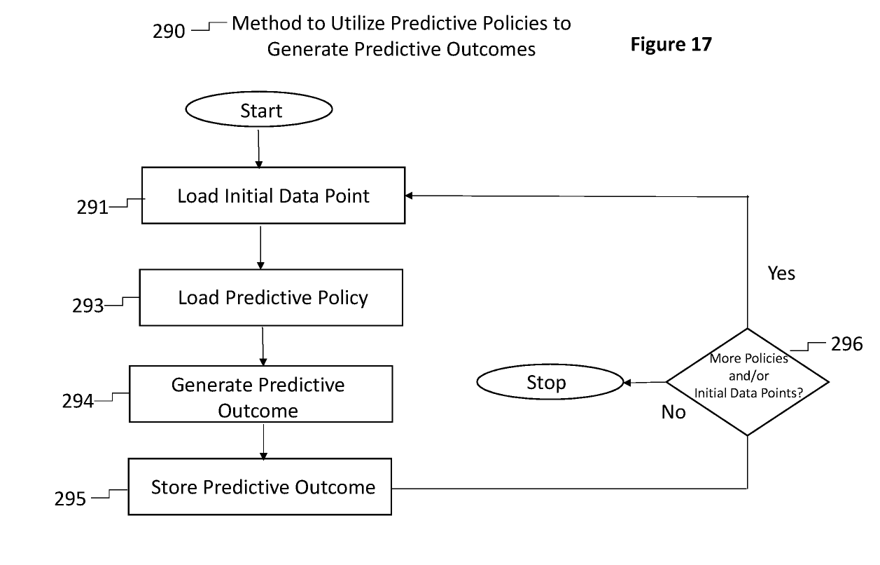

FIG. 17 illustrates one embodiment of AI System Controller 21 and/or Human Monitor interface 53 working in conjunction with Training Engine 39, Predictive Outcomes 64, and Knowledge Base 62 as exemplary Method 290, Method to Utilize Predictive Policies to Generate Predictive Outcomes. Predictive Outcomes may be used by 310 Method to Validate Predictive Policies, 330 Method to Modify Predictive Model Learning Algorithm(s) Based on Alteration of Hyperparameters, 370 Method to Change Predictive Model by Adding/Deleting Learning Algorithm(s), or 410 Method to Change Predictive Model by Changing Ensemble Technique(s).

In Step 291, AI System Controller 21 or Human Monitor interface 53 initiates a process to utilize a Predictive Policy to generate Predictive Outcomes, and load a single Initial Data Point into Training Engine 39 for processing. In one embodiment, AI System Controller 21 may access Knowledge Base 62, retrieve a single Initial Data Point from an existing Initial Data Point Structure, and load a single Initial Data Point into Training Engine 39 for processing. In another embodiment, Human Monitor interface 53 may access Knowledge Base 62, retrieve a single Initial Data Point from an existing Initial Data Point Structure, and load a single Initial Data Point into Training Engine 39 for processing. Other processes may be used to load a single Initial Data Point into Training Engine 39 without departing from the spirit and scope of the exemplar method.

In Step 293, AI System Controller 21 or Human Monitor interface 53 may load a Predictive Policy associated with a single Initial Data Point loaded in Step 291 into Training Engine 39 for processing. In one embodiment, AI System Controller 21 may access Knowledge Base 62, retrieve a Predictive Policy associated with a single Initial Data Point loaded in Step 291, and load into Training Engine 39 for processing. In another embodiment, Human Monitor interface 53 may access Knowledge Base 62, retrieve a Predictive Policy associated with a single Initial Data Point loaded in Step 291, and load into Training Engine 39 for processing. Other processes may be used to load a Predictive Policy into Training Engine 39 without departing from the spirit and scope of the exemplar method.

In Step 294, AI System Controller 21 or Human Monitor interface 53 may instruct Training Engine 39 to apply a loaded Prediction Policy to a loaded Initial Data Point and generate a Predictive Outcome. In certain embodiments, Training Engine 39 utilizes a Predictive Policy loaded in Step 293 to map Initial Data Point loaded in step 291 to a Predictive Outcome. In one embodiment, mapping is accomplished by function evaluation. In another embodiment, mapping is accomplished by table lookup. Training Engine 39 may assign a unique identifier to a generated Predictive Outcome for future use. Other processes may be used to generate Predictive Outcomes without departing from the spirit and scope of the exemplar method.

In Step 295, a created Predictive Outcome and its unique identifier is stored in Knowledge Base 62 and/or Predictive Outcomes 64. In one embodiment, AI System Controller 21 may instruct Training Engine 39 to store a created Predictive Outcome and its unique identifier in Knowledge Base 62 and/or Predictive Outcomes 64. In another embodiment, Human Monitor interface 53 may instruct Training Engine 39 to store a created Predictive Outcome and its unique identifier in Knowledge Base 62 and/or Predictive Outcomes 64. Other processes may be used to store a created Predictive Outcome without departing from the spirit and scope of the exemplar method.

In Step 296, AI System Controller 21 determines if additional Predictive Policies and/or Initial Data Points exists. If additional Predictive Policies and/or Initial Data Points exists, AI System Controller 21 instructs Training Engine 39 to initiate Step 291. If additional Predictive Policies and/or Initial Data Points do not exist, AI System Controller 21, instructs Training Engine 39 to halt the method. Other processes may be used to determine if additional Predictive Policies and/or Initial Data Points exist without departing from the spirit and scope of the exemplar method.

Modifications, additions, or omissions may be made to the Method to Utilize Predictive Policies to Generate Predictive Outcomes without departing from the scope of the method. The method may include more, fewer, or other steps. Additionally, steps may be performed in any suitable order.

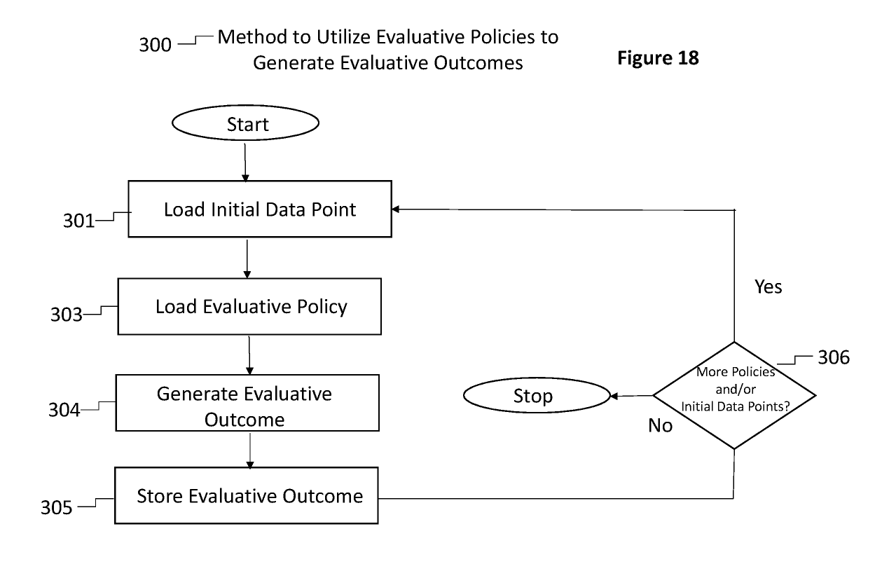

FIG. 18 illustrates one embodiment of AI System Controller 21 and/or Human Monitor interface 53 working in conjunction with Training Engine 39, Evaluative Outcomes 65, and Knowledge Base 62 as exemplary Method 300, Method to Utilize Evaluative Policies to Generate Evaluative Outcomes. Evaluative Outcomes may be used by 320 Method to Validate Evaluative Policies, 350 Method to Modify Evaluative Model Learning Algorithm(s) Based on Alteration of Hyperparameters, 390 Method to Change Evaluative Model by Adding/Deleting Learning Algorithm(s), or 430 Method to Change Evaluative Model by Changing Ensemble Technique(s).

In Step 301, AI System Controller 21 or Human Monitor interface 53 initiates a process to utilize an Evaluative Policy to generate Evaluative Outcomes, and load a single Initial Data Point from an existing Initial Data Point Structure, into Training Engine 39 for processing. In one embodiment, AI System Controller 21 may access Knowledge Base 62, retrieve a single Initial Data Point from an existing Initial Data Point Structure, and load a single Initial Data Point into Training Engine 39 for processing. In another embodiment, Human Monitor interface 53 may access Knowledge Base 62, retrieve a single Initial Data Point from an existing Initial Data Point Structure, and load a single Initial Data Point into Training Engine 39 for processing. Other processes may be used to load a single Initial Data Point into Training Engine 39 without departing from the spirit and scope of the exemplar method.

In Step 303, AI System Controller 21 or Human Monitor interface 53 may load an Evaluative Policy associated with a single Initial Data Point loaded in Step 301 into Training Engine 39 for processing. In one embodiment, AI System Controller 21 may access Knowledge Base 62, retrieve an Evaluative Policy associated with a single Initial Data Point loaded in Step 301, and load into Training Engine 39 for processing. In another embodiment, Human Monitor interface 53 may access Knowledge Base 62, retrieve an Evaluative Policy associated with a single Initial Data Point loaded in Step 301, and load into Training Engine 39 for processing. Other processes may be used to load an Evaluative Policy into Training Engine 39 without departing from the spirit and scope of the exemplar method.

In Step 304, AI System Controller 21 or Human Monitor interface 53 may instruct Training Engine 39 to apply a loaded Evaluative Policy to a loaded Initial Data Point and generate an Evaluative Outcome. In certain embodiments, Training Engine 39 utilizes an Evaluative Policy loaded in Step 293 to map Initial Data Point loaded in step 291 to an Evaluative Outcome. In one embodiment, mapping is accomplished by function evaluation. In another embodiment, mapping is accomplished by table lookup. Training Engine 39 may assign a unique identifier to a generated Evaluative Outcome for future use. Other processes may be used to generate Evaluative Outcomes without departing from the spirit and scope of the exemplar method.

In Step 305, a created Evaluative Outcome and its unique identifier is stored in Knowledge Base 62 and/or Evaluative Outcomes 65. In one embodiment, AI System Controller 21 may instruct Training Engine 39 to store a created Evaluative Outcome and its unique identifier in Knowledge Base 62 and/or Evaluative Outcomes 65. In another embodiment, Human Monitor interface 53 may instruct Training Engine 39 to store a created Evaluative Outcome and its unique identifier in Knowledge Base 62 and/or Evaluative Outcomes 65. Other processes may be used to store a created Evaluative Outcome without departing from the spirit and scope of the exemplar method.

In Step 306, AI System Controller 21 determines if additional Evaluative Policies and/or Initial Data Points exists. If additional Evaluative Policies and/or Initial Data Points exists, AI System Controller 21 instructs Training Engine 39 to initiate Step 301. If additional Evaluative Policies and/or Initial Data Points do not exist, AI System Controller 21, instructs Training Engine 39 to halt the method. Other processes may be used to determine if additional Evaluative Policies and/or Initial Data Points exist without departing from the spirit and scope of the exemplar method.

Modifications, additions, or omissions may be made to the Method to Utilize Evaluative Policies to Generate Evaluative Outcomes without departing from the scope of the method. The method may include more, fewer, or other steps. Additionally, steps may be performed in any suitable order.

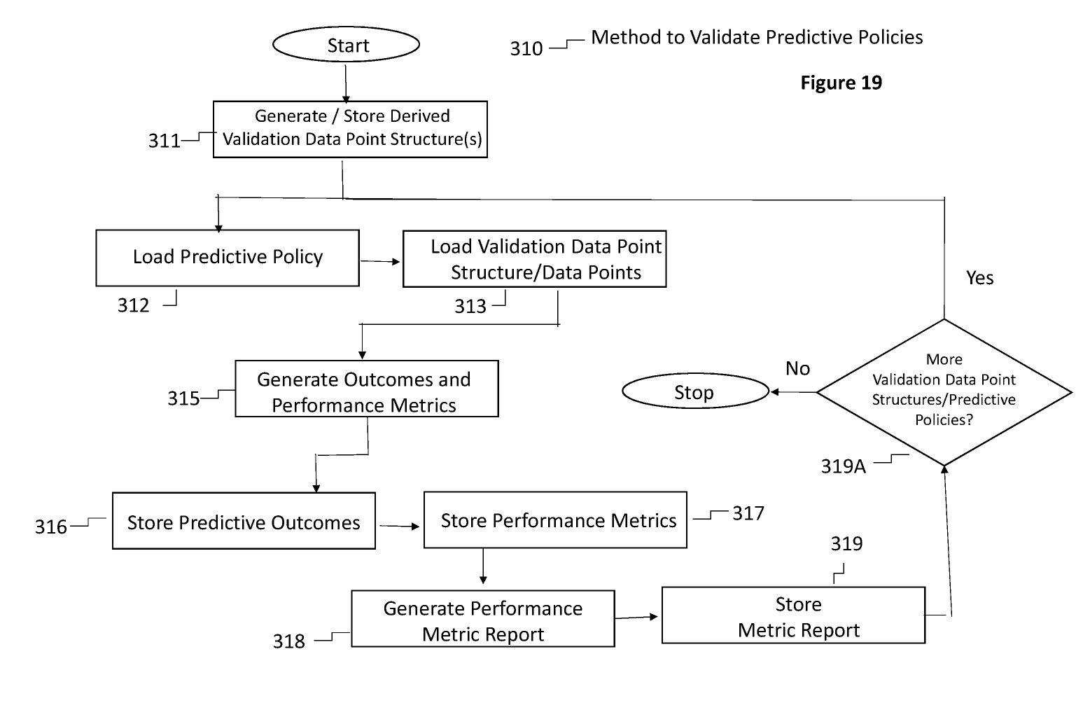

FIG. 19 illustrates one embodiment of AI System Controller 21 and/or Human Monitor interface 53 working in conjunction with Validation Engine 38, Seed Knowledge Base 61, Knowledge Base 62, Tools Knowledge Base 63, Predictive Outcomes 64, Performance Metrics 66, and Performance Metric Report 71 as exemplary Method 310, Method to Validate Predictive Policies. The method validates Predictive Policies generated in 270 Method to Train a Predictive or Evaluative Model.

In Step 311, AI System Controller 21 or Human Monitor interface 53 initiates a process to validate a Predictive Policy, and generate and store Derived Validation Data Point Structure(s). In one embodiment, AI System Controller 21 may utilize 220 Method to Create Initial Data Point Structure(s) to create and store Initial Derived Validation Data Point Structure(s) and their unique identifier, store and/or update Derived Validation Data Point Structure Ruleset(s) and their unique identifier, and generate and/or store Initial Validation Ruleset and its unique identifier. In another embodiment, AI System Controller 21 may create and store Initial Derived Validation Data Point Structure(s) utilizing a method specified by a cross-validation method stored in Seed Knowledge Base 61, Knowledge Base 62, or Tools Knowledge Base 63. In yet another embodiment, Human Monitor interface 53 may utilize 220 Method to Create Initial Data Point Structure(s) to create and store Initial Derived Validation Data Point Structure(s) and their unique identifier, store and/or update Derived Validation Data Point Structure Ruleset(s) and their unique identifier, and generate and/or Store Initial Validation Ruleset and its unique identifier. In another embodiment, AI System Controller 21 may create and store Initial Derived Validation Data Point Structure(s) utilizing a method specified by a cross-validation method stored in Seed Knowledge Base 61, Knowledge Base 62, or Tools Knowledge Base 63. Other processes may be used to create and store Initial Derived Validation Data Point Structure(s) without departing from the spirit and scope of the exemplar method.

In Step 312, AI System Controller 21 or Human Monitor interface 53 may load a Predictive Policy based on its unique identifier into Validation Engine 38 for processing. In one embodiment, AI System Controller 21 may access Knowledge Base 62, retrieve a Predictive Policy based on its unique identifier, and load into Validation Engine 38 for processing. In another embodiment, Human Monitor interface 53 may access Knowledge Base 62, retrieve a Predictive Policy based on its unique identifier, and load into Validation Engine 38 for processing. Other processes may be used to load a Predictive Policy into Validation Engine 38 without departing from the spirit and scope of the exemplar method.

In Step 313, AI System Controller 21 or Human Monitor interface 53 may load a Derived Validation Data Point Structure and its unique identifier and Initial Data Points associated with a Predictive Policy loaded in Step 312 into Validation Engine 38 for processing. In one embodiment, AI System Controller 21 may access Knowledge Base 62, retrieve a Derived Validation Data Point Structure and its unique identifier and Initial Data Points associated with a Predictive Policy loaded in Step 312, and load into Validation Engine 38 for processing. In another embodiment, Human Monitor interface 53 may access Knowledge Base 62, retrieve a Derived Validation Data Point Structure and its unique identifier and Initial Data Points associated with a Predictive Policy loaded in Step 312, and load into Validation Engine 38 for processing. Other processes may be used to load Derived Validation Data Point Structures and Initial Data Points associated with a Predictive Policy loaded in Step 312 into Validation Engine 38 without departing from the spirit and scope of the exemplar method.

In Step 315, Validation Engine 38 may generate Predictive Outcomes and Performance Metrics for a Predictive Policy loaded in Step 312 utilizing loaded Initial Data Points. In certain embodiments, Validation Engine 38 may utilize 290 Method to Utilize Predictive Policies to Generate Predictive Outcomes to generate new Predictive Outcomes for Validation. In Certain embodiments, Validation Engine 38 may generate Performance Metrics. In this embodiment, Validation Engine 38 may utilize unique identifiers to load previous Predictive Outcomes for a Predictive Policy loaded in Step 312 to generate Performance Metrics. Validation Engine 38 may utilize unique identifiers to load current Predictive Outcomes to generate Performance Metrics for a Predictive Policy loaded in Step 312. Validation Engine 38 may use one or more cross-validation process to generate Performance Metrics including but not limited to leave-p-out, k-fold, Monte Carlo, etc. In certain embodiments, Validation Engine 38 may assign a unique identifier to old and new Predictive Outcomes for future use. In certain embodiments, Validation Engine 38 may assign a unique identifier to Performance Metrics Generated. In one embodiment, AI System Controller 21 may access Tools Knowledge Base 63 and/or Seed Knowledge Base 61, determine appropriate cross-validation process(s), and provide appropriate cross-validation processes to Validation Engine 38 to create Predictive Outcomes and Performance Metrics. In another embodiment, Human Monitor interface 53 may provide appropriate cross-validation process(s) to Validation Engine 38 to create Predictive Outcomes and Performance Metrics. Other processes may be used create Performance Metrics and Predictive Outcomes without departing from the spirit and scope of the exemplar method.

In Step 316, old and new Predictive Outcomes and their unique identifier are stored in Knowledge Base 62 and/or Predictive Outcomes 64. In one embodiment, AI System Controller 21 may instruct Validation Engine 38 to store old and new Predictive Outcomes and their unique identifier in Knowledge Base 62 and/or Predictive Outcomes 64. In another embodiment, Human Monitor interface 53 may instruct Validation Engine 38 to store old and new Predictive Outcomes and their unique identifier in Knowledge Base 62 and/or Predictive Outcomes 64. Other processes may be used to store old and new Predictive Outcomes without departing from the spirit and scope of the exemplar method.

In Step 317, created Performance Metrics and its unique identifier are stored in Knowledge Base 62 and/or Performance Metrics 66. In one embodiment, AI System Controller 21 may instruct Validation Engine 38 to store created Performance Metrics and its unique identifier in Knowledge Base 62 and/or Performance Metrics 66. In another embodiment, Human Monitor interface 53 may instruct Validation Engine 38 to store created Performance Metrics and its unique identifier in Knowledge Base 62 and/or Performance Metrics 66. Other processes may be used to store created Performance Metrics without departing from the spirit and scope of the exemplar method.

In Step 318, Validation Engine 38 may generate a Performance Metric Report. The Performance Metric Report summarizes comparison of old Performance Outcomes with new Performance Outcomes used to determine the fitness of a Prediction Policy. In one embodiment, AI System Controller 21 may instruct Validation Engine 38 to generate a Performance Metric Report and assign a unique identifier based on Performance Metrics generated in Step 315. In another embodiment, Human Monitor interface 53 may instruct Validation Engine 38 to generate a Performance Metric Report and assign a unique identifier based on Performance Metrics generated in Step 315. Other processes may be used to generate a Performance Metric Report without departing from the spirit and scope of the exemplar method.

In Step 319, Performance Metric Report and its unique identifier generated in Step 318 is stored in Performance Metric Report 71. In one embodiment, AI System Controller 21 may instruct Validation Engine 38 to store Performance Metric Report and its unique identifier generated in Step 318 in Performance Metric Report 71. In another embodiment, Human Monitor interface 53 may instruct Validation Engine 38 to store Performance Metric Report and its unique identifier generated in Step 318 in Performance Metric Report 71. Other processes may be used to store generated Performance Metric Report without departing from the spirit and scope of the exemplar method.

In Step 319A, AI System Controller 21 determines if additional Predictive Policy(s) and/or Derived Validation Data Point Structure(s) exists. If additional Predictive Policy(s) and/or Derived Validation Data Point Structure(s) exists, AI System Controller 21 instructs Validation Engine 38 to initiate Step 312. If additional Predictive Policy(s) and/or Derived Validation Data Point Structure(s) do not exist, AI System Controller 21, instructs Validation Engine 38 to halt the method. Other processes may be used to determine if additional Predictive Policy(s) and/or Derived Validation Data Point Structure(s) exist without departing from the spirit and scope of the exemplar method.

Modifications, additions, or omissions may be made to the Method to Validate Predictive Policies without departing from the scope of the method. The method may include more, fewer, or other steps. Additionally, steps may be performed in any suitable order.

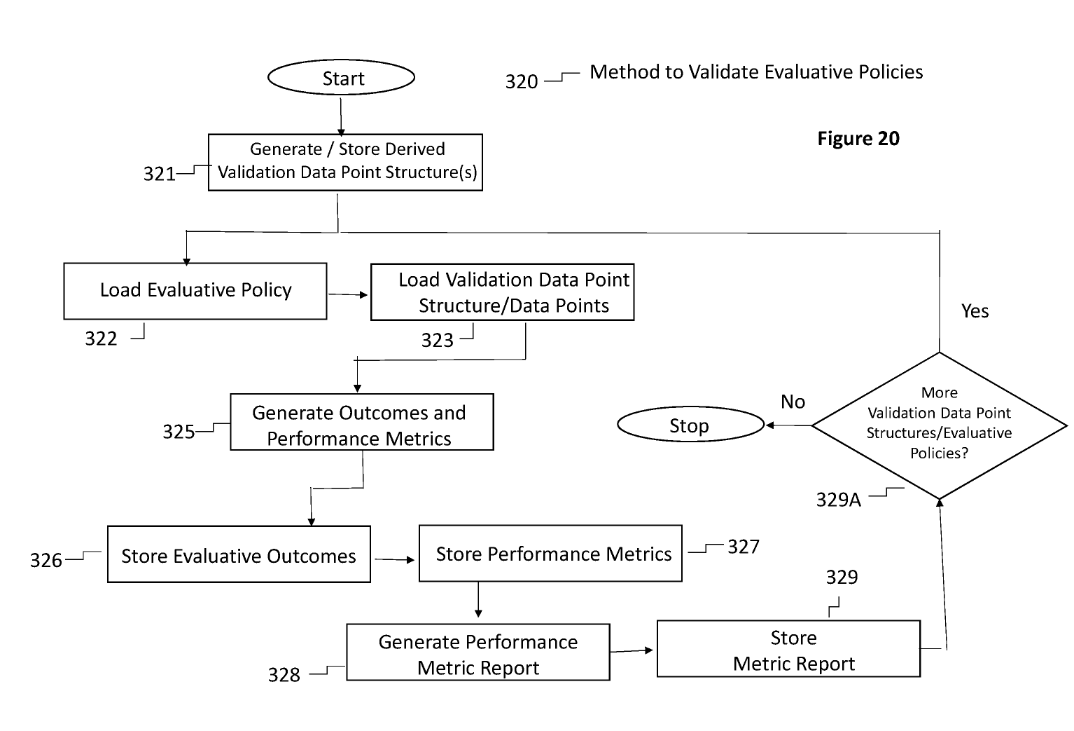

FIG. 20 illustrates one embodiment of AI System Controller 21 and/or Human Monitor interface 53 working in conjunction with Validation Engine 38, Seed Knowledge Base 61, Knowledge Base 62, Tools Knowledge Base 63, Evaluative Outcomes 65, Performance Metrics 66, and Performance Metric Report 71 as exemplary Method 320, Method to Validate Evaluative Policies. The method validates Evaluative Policies generated in 270 Method to Train a Predictive or Evaluative Model.

In Step 321, AI System Controller 21 or Human Monitor interface 53 initiates a process to validate an Evaluative Policy, and generate and store Derived Validation Data Point Structure(s). In one embodiment, AI System Controller 21 may utilize 220 Method to Create Initial Data Point Structure(s) to create and store Initial Derived Validation Data Point Structure(s) and their unique identifier, store and/or update Derived Validation Data Point Structure Ruleset(s) and their unique identifier, and generate and/or Store Initial Validation Ruleset and its unique identifier. In another embodiment, AI System Controller 21 may create and store Initial Derived Validation Data Point Structure(s) utilizing a method specified by a cross-validation method stored in Seed Knowledge Base 61, Knowledge Base 62, or Tools Knowledge Base 63. In yet another embodiment, Human Monitor interface 53 may utilize 220 Method to Create Initial Data Point Structure(s) to create and store Initial Derived Validation Data Point Structure(s) and their unique identifier, store and/or update Derived Validation Data Point Structure Ruleset(s) and their unique identifier, and generate and/or Store Initial Validation Ruleset and its unique identifier. In another embodiment, AI System Controller 21 may create and store Initial Derived Validation Data Point Structure(s) utilizing a method specified by a cross-validation method stored in Seed Knowledge Base 61, Knowledge Base 62, or Tools Knowledge Base 63. Other processes may be used to create and store Initial Derived Validation Data Point Structure(s) without departing from the spirit and scope of the exemplar method.

In Step 322, AI System Controller 21 or Human Monitor interface 53 may load an Evaluative Policy based on its unique identifier into Validation Engine 38 for processing. In one embodiment, AI System Controller 21 may access Knowledge Base 62, retrieve an Evaluative Policy based on its unique identifier, and load into Validation Engine 38 for processing. In another embodiment, Human Monitor interface 53 may access Knowledge Base 62, retrieve an Evaluative Policy based on its unique identifier, and load into Validation Engine 38 for processing. Other processes may be used to load an Evaluative Policy into Validation Engine 38 without departing from the spirit and scope of the exemplar method.

In Step 323, AI System Controller 21 or Human Monitor interface 53 may load a Derived Validation Data Point Structure and its unique identifier and Data Points associated with an Evaluative Policy loaded in Step 322 into Validation Engine 38 for processing. In one embodiment, AI System Controller 21 may access Knowledge Base 62, retrieve a Derived Validation Data Point Structure and its unique identifier and Initial Data Points associated with an Evaluative Policy loaded in Step 322, and load into Validation Engine 38 for processing. In another embodiment, Human Monitor interface 53 may access Knowledge Base 62, retrieve a Derived Validation Data Point Structure and its unique identifier and Initial Data Points associated with an Evaluative Policy loaded in Step 322, and load into Validation Engine 38 for processing. Other processes may be used to load Derived Validation Data Point Structures and Initial Data Points associated with an Evaluative loaded in Step 322 into Validation Engine 38 without departing from the spirit and scope of the exemplar method.

In Step 325, Validation Engine 38 may generate Evaluative Outcomes and Performance Metrics for an Evaluative Policy loaded in Step 322 utilizing loaded Initial Data Points. In certain embodiments, Validation Engine 38 may utilize 300 Method to Utilize Evaluative Policies to Generate Evaluative Outcomes to generate new Evaluative Outcomes for Validation. In Certain embodiments, Validation Engine 38 may generate Performance Metrics. In this embodiment, Validation Engine 38 may utilize unique identifiers to load previous Evaluative Outcomes for an Evaluative Policy loaded in Step 322 to generate Performance Metrics. Validation Engine 38 may utilize unique identifiers to load current Evaluative Outcomes to generate Performance Metrics for an Evaluative Policy loaded in Step 322. Validation Engine 38 may use one or more cross-validation process to generate Performance Metrics including but not limited to leave-p-out, k-fold, Monte Carlo, etc. In certain embodiments, Validation Engine 38 may assign a unique identifier to old and new Evaluative Outcomes for future use. In certain embodiments, Validation Engine 38 may assign a unique identifier to Evaluative Metrics Generated. In one embodiment, AI System Controller 21 may access Tools Knowledge Base 63 and/or Seed Knowledge Base 61, determine appropriate cross-validation process(s), and provide appropriate cross-validation processes to Validation Engine 38 to create Performance Metrics. In another embodiment, Human Monitor interface 53 may provide appropriate cross-validation process(s) to Validation Engine 38 to create Performance Metrics. Other processes may be used create Performance Metrics and Evaluative Outcomes without departing from the spirit and scope of the exemplar method.

In Step 326, old and new Evaluative Outcomes and their unique identifier are stored in Knowledge Base 62 and/or Evaluative Outcomes 65. In one embodiment, AI System Controller 21 may instruct Validation Engine 38 to store old and new Evaluative Outcomes and their unique identifier in Knowledge Base 62 and/or Evaluative Outcomes 65. In another embodiment, Human Monitor interface 53 may instruct Validation Engine 38 to store old and new Evaluative Outcomes and their unique identifier in Knowledge Base 62 and/or Evaluative Outcomes 65. Other processes may be used to store old and new Evaluative Outcomes without departing from the spirit and scope of the exemplar method.

In Step 327, created Performance Metrics and its unique identifier are stored in Knowledge Base 62 and/or Performance Metrics 66. In one embodiment, AI System Controller 21 may instruct Validation Engine 38 to store created Performance Metrics and its unique identifier in Knowledge Base 62 and/or Performance Metrics 66. In another embodiment, Human Monitor interface 53 may instruct Validation Engine 38 to store created Performance Metrics and its unique identifier in Knowledge Base 62 and/or Performance Metrics 66. Other processes may be used to store created Performance Metrics without departing from the spirit and scope of the exemplar method.

In Step 328, Validation Engine 38 may generate a Performance Metric Report. The Performance Metric Report summarizes comparison of old Performance Outcomes with new Performance Outcomes used to determine the fitness of an Evaluative Policy. In one embodiment, AI System Controller 21 may instruct Validation Engine 38 to generate a Performance Metric Report and assign a unique identifier based on Performance Metrics generated in Step 315. In another embodiment, Human Monitor interface 53 may instruct Validation Engine 38 to generate a Performance Metric Report and assign a unique identifier based on Performance Metrics generated in Step 315. Other processes may be used to generate a Performance Metric Report without departing from the spirit and scope of the exemplar method.

In Step 329, Performance Metric Report and its unique identifier generated in Step 318 is stored in Performance Metric Report 71. In one embodiment, AI System Controller 21 may instruct Validation Engine 38 to store Performance Metric Report and its unique identifier generated in Step 328 in Performance Metric Report 71. In another embodiment, Human Monitor interface 53 may instruct Validation Engine 38 to store Performance Metric Report and its unique identifier generated in Step 328 in Performance Metric Report 71. Other processes may be used to store generated Performance Metric Report without departing from the spirit and scope of the exemplar method.

In Step 329A, AI System Controller 21 determines if additional Evaluative Policy(s) and/or Derived Validation Data Point Structure(s) exists. If additional Evaluative Policy(s) and/or Derived Validation Data Point Structure(s) exists, AI System Controller 21 instructs Validation Engine 38 to initiate Step 322. If additional Evaluative Policy(s) and/or Derived Validation Data Point Structure(s) do not exist, AI System Controller 21, instructs Validation Engine 38 to halt the method. Other processes may be used to determine if additional Evaluative Policy(s) and/or Derived Validation Data Point Structure(s) exist without departing from the spirit and scope of the exemplar method.

Modifications, additions, or omissions may be made to the Method to Validate Evaluative Policies without departing from the scope of the method. The method may include more, fewer, or other steps. Additionally, steps may be performed in any suitable order.

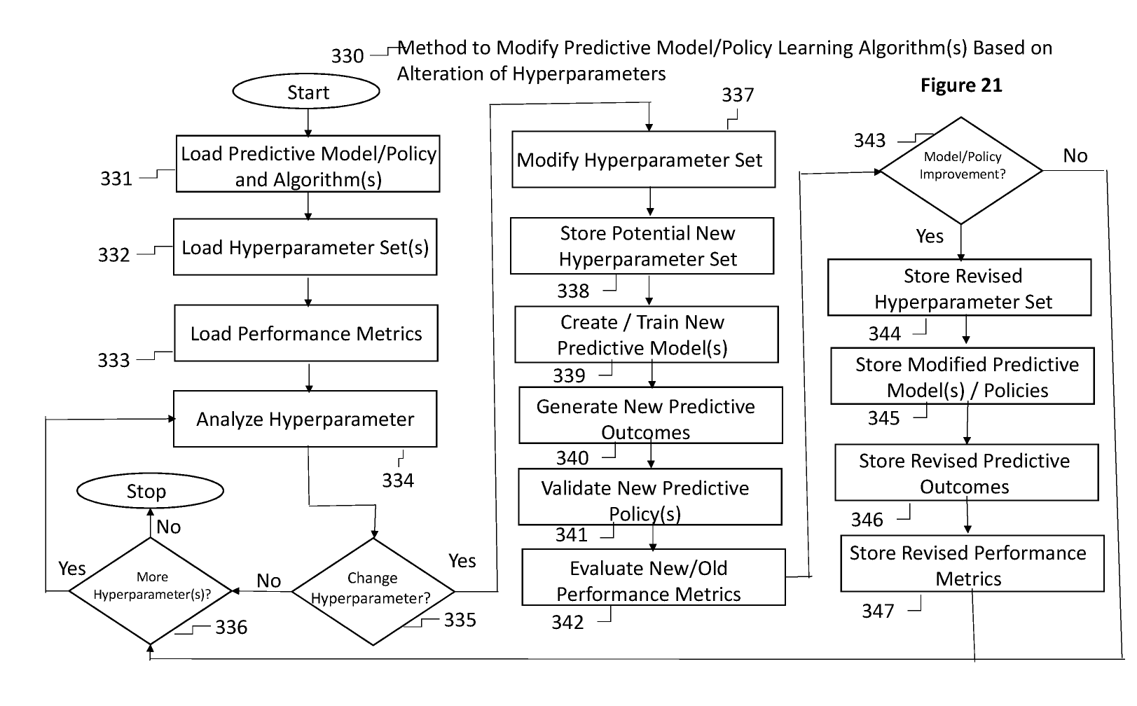

FIG. 21 illustrates one embodiment of AI System Controller 21 and/or Human Monitor interface 53 working in conjunction with Training Engine 39, Seed Knowledge Base 61, Knowledge Base 62, Tools Knowledge Base 63, Predictive Outcomes 64, and Performance Metrics 66, as exemplary Method 330, Method to Modify Predictive Model/Policy Learning Algorithm(s) Based on Alterations of Hyperparameters. Hyperparameters are used configure Learning Algorithms. Hyperparameters may include but not limited to the choice of kernel function in a kernel-based method, attenuation factors in iterative methods, basis function weights in approximation algorithms, etc. The method modifies Predictive Models/Policies generated in 230 Method to Create a Predictive or Evaluative Model Using a Single Learning Algorithm or 240 Method to Create a Predictive or Evaluative Model Using a Single Ensemble Technique.

In Step 331, AI System Controller 21 or Human Monitor interface 53 initiates a process to Modify Predictive Model/Policy Learning Algorithm(s) based on Alterations of Hyperparameters, and load a single Predictive Model/Policy and utilized Predictive Model/Policy algorithms into Training Engine 39 for processing. In one embodiment, AI System Controller 21 may access Knowledge Base 62, retrieve a single Predictive Model/Policy based on its unique identifier and utilized Predictive Model/Policy algorithms based on their unique identifiers, and load a single Predictive Model/Policy and utilized Predictive Model/Policy algorithms into Training Engine 39 for processing. In another embodiment, Human Monitor interface 53 may access Knowledge Base 62, retrieve a single Predictive Model/Policy based on its unique identifier and utilized Predictive Model/Policy algorithms based on their unique identifiers, and load a single Predictive Model/Policy and utilized Predictive Model/Policy algorithms into Training Engine 39 for processing. Other processes may be used to load a single Predictive Model/Policy and utilized Predictive Model/Policy algorithms into Training Engine 39 without departing from the spirit and scope of the exemplar method.

In Step 332, AI System Controller 21 or Human Monitor interface 53 may load Hyperparameter Set(s) associated with Predictive Model/Policy loaded in Step 331 into Training Engine 39 for processing. In one embodiment, AI System Controller 21 may access Knowledge Base 62, retrieve Hyperparameter Set(s) based on its unique identifier(s) associated with Predictive Model/Policy loaded in Step 331, and load Hyperparameter Set(s) into Training Engine 39 for processing. In another embodiment, Human Monitor interface 53 may access Knowledge Base 62, retrieve Hyperparameter Set(s) based on its unique identifier(s) associated with Predictive Model/Policy loaded in Step 331, and load Hyperparameter Set(s) into Training Engine 39 for processing. Other processes may be used to load a single Hyperparameter Set(s) associated with Predictive Model/Policy loaded in Step 331 into Training Engine 39 without departing from the spirit and scope of the exemplar method.

In Step 333, AI System Controller 21 or Human Monitor interface 53 may load Performance Metrics generated in 310 Method to Validate Predictive Policies associated with Predictive Model/Policy loaded in Step 331 into Training Engine 39 for processing. In one embodiment, AI System Controller 21 may access Knowledge Base 62, retrieve Performance Metrics and its unique identifier associated with Predictive Model/Policy loaded in Step 331, and load Performance Metrics into Training Engine 39 for processing. In another embodiment, Human Monitor interface 53 may access Knowledge Base 62, retrieve Performance Metrics and its unique identifier associated with Predictive Model/Policy loaded in Step 331, and load Performance Metrics into Training Engine 39 for processing. Other processes may be used to load Performance Metrics associated with Predictive Model/Policy loaded in Step 331 into Training Engine 39 without departing from the spirit and scope of the exemplar method.

In Step 334, Training Engine 39 performs analysis on a Hyperparameter contained in a Hyperparameter Set(s) loaded in Step 332 to determine a potential change to a Hyperparameter. In certain embodiments, Training Engine 39 may use various analysis techniques for determining a potential change to a Hyperparameter including but not limited to damping factors, rate of convergence, stability, sensitivity to initial conditions, mathematical conditioning, search methods, goodness of fit, and/or cross-validation feedback. In one embodiment, AI System Controller 21 may access Tools Knowledge Base 63 and/or Seed Knowledge Base 61, determine appropriate analytic technique(s), and provide appropriate analytic computation(s) to Training Engine 39 to determine a potential change to a Hyperparameter contained within the loaded Hyperparameter Set(s). In another embodiment, Human Monitor interface 53 may provide analytic computation(s) to Training Engine 39 to determine a potential change to a Hyperparameter contained within the loaded Hyperparameter Set(s). Other processes may be used to analyze a Hyperparameter without departing from the spirit and scope of the exemplar method.

In Step 335, AI System Controller 21 determines if a potential change exists to a Hyperparameter analyzed in Step 334. Based on analytics utilized in Step 334, a potential change to a Hyperparameter may be identified. Examples of potential Hyperparameter changes may include but not limited to the choice of kernel function in a kernel-based method, attenuation factors in iterative methods, basis function weights in approximation algorithms, etc. If a potential change to a Hyperparameter exists, AI System Controller 21 instructs Training Engine 39 to initiate Step 337. If a potential change a Hyperparameter does not exist, AI System Controller 21, instructs Training Engine 39 to initiate Step 336. Other processes may be used to determine if a potential change to a Hyperparameter exists without departing from the spirit and scope of the exemplar method.

In Step 336, AI System Controller 21 determines if additional Hyperparameter(s) exists in the Hyperparameter Set loaded in Step 332. If additional Hyperparameter(s) exists, AI System Controller 21 instructs Training Engine 39 to initiate Step 334. If additional Hyperparameter(s) do not exist, AI System Controller 21, instructs Training Engine 39 to halt the method. Other processes may be used to determine if additional Hyperparameter(s) exists is possible without departing from the spirit and scope of the exemplar method.

In Step 337, Training Engine 39 may modify Hyperparameter identified for change in Step 335. In one embodiment, AI System Controller 21 may instruct Training Engine 39 to update a Hyperparameter contained in a Hyperparameter Set and assign a unique identifier. In another embodiment, Human Monitor interface 53 may instruct Training Engine 39 to update a Hyperparameter contained in a Hyperparameter Set and assign a unique identifier. Other processes may be used to modify a Hyperparameter contained in a Hyperparameter Set without departing from the spirit and scope of the exemplar method.

In Step 338, a Potential New Hyperparameter Set containing Hyperparameter modified in Step 337 is stored in Knowledge Base 62. In one embodiment, AI System Controller 21 may instruct Training Engine 39 to store the Potential New Hyperparameter Set and its unique identifier in Knowledge Base 62. In another embodiment, Human Monitor interface 53 may instruct Training Engine 39 to store the Potential New Hyperparameter Set and its unique identifier in Knowledge Base 62. Other processes may be used to store the Potential New Hyperparameter Set without departing from the spirit and scope of the exemplar method.

In Step 339, AI System Controller 21 or Human Monitor interface 53 initiates a process to create and train New Predictive Model(s)/Policy(s). In one embodiment, AI System Controller 21 may utilize 230 Method to Create a Predictive or Evaluative Model Using a Single Learning Algorithm or 240 Method to Create a Predictive or Evaluative Model Using a Single Ensemble Technique to create and store a New Predictive Model/Policy based on the New Hyperparameter Set stored in Step 338. AI System Controller 21 may then utilize 270 Method to Train a Predictive or Evaluative Model to train new Models/Policies. In another embodiment, Human Monitor interface 53 may utilize 230 Method to Create a Predictive or Evaluative Model Using a Single Learning Algorithm or 240 Method to Create a Predictive or Evaluative Model Using a Single Ensemble Technique to create and store a New Predictive Model/Policy based on the new Hyperparameter Set stored in Step 338. Human Monitor interface 53 may then utilize 270 Method to Train a Predictive or Evaluative Model to train new Models/Policies. Other processes may be used to create and train New Predictive Model(s)/Policy(s) without departing from the spirit and scope of the exemplar method.

In Step 340, AI System Controller 21 or Human Monitor interface 53 initiates a process to generate New Predictive Outcomes based on Predictive Policy(s) created in Step 339. In one embodiment, AI System Controller 21 may utilize 290 Method to Utilize Predictive Policies to Generate Predictive Outcomes to generate and store a New Predictive Outcome. In another embodiment, Human Monitor interface 53 may utilize 290 Method to Utilize Predictive Policies to Generate Predictive Outcomes to generate and store a New Predictive Outcome. Other processes may be used to generate New Predictive Outcomes without departing from the spirit and scope of the exemplar method.

In Step 341, AI System Controller 21 or Human Monitor interface 53 initiates a process to validate New Predictive Policy(s) created in Step 339. In one embodiment, AI System Controller 21 may utilize 310 Method to Validate Predictive Policies to validate a New Predictive Policy. In another embodiment, Human Monitor interface 53 may utilize 310 Method to Validate Predictive Policies to validate a New Predictive Policy. Other processes may be used to validate a New Predictive Policies without departing from the spirit and scope of the exemplar method.

In Step 342, Training Engine 39 evaluates New Performance Metrics generated in Step 341 to old Performance Metrics loaded in Step 333 to determine if a New Predictive Model/Policy(s) generated in Step 339 is superior to predictive performance of Predictive Model/Policy loaded in Step 331. In one embodiment, AI System Controller 21 may access Knowledge Base 62, and load New Performance Metrics and its unique identifier for a New Predictive Model/Policy into Training Engine 39. In this embodiment, Training Engine 39 evaluates and determines if loaded New Performance Metrics is superior to Old Performance Metrics loaded in Step 333. In another embodiment, Human Monitor interface 53 may access Knowledge Base 62, and load New Performance Metrics and its unique identifier for a New Predictive Model/Policy into Training Engine 39. In this embodiment, Training Engine 39 evaluates and determines if loaded New Performance Metrics is superior to Old Performance Metrics loaded in Step 333. Other processes may be used to evaluate New Performance Metrics generated in step 341 to determine if a New Predictive Model/Policy is superior in predictive performance to an Older Model/Policy's predictive performance without departing from the spirit and scope of the exemplar method.

In Step 343, AI System Controller 21 determines if there is a significant improvement of Performance Metrics evaluated in Step 342. Types of Significant Improvement calculations utilized may include but not limited to Chi Square, Degrees of Freedom, T-Tests, etc. In one embodiment, AI System Controller 21 may access Seed Knowledge Base 61 and/or Tools Knowledge Base 63, and load appropriate Significant Difference calculations into Training Engine 39. In this embodiment, Training Engine 39 evaluates and determines if a New Predictive Model/Policy's predictive performance is a significant difference of improvement over a previous older Predictive Model/Policy's predictive performance. If a significant difference of improvement utilizing the New Predictive Model/Policy's predictive performance exists, AI System Controller 21 instructs Training Engine 39 to initiate Step 344. If a significant improvement utilizing the New Predictive Model/Policy's predictive performance does not exist, AI System Controller 21 instructs Training Engine 39 to initiate Step 336. Other processes may be used to determine if a New Predictive Model/Policy predictive performance is a significant difference of improvement over a previous older Predictive Model/Policy's predictive performance without departing from the spirit and scope of the exemplar method.

In Step 344, the New Hyperparameter Set(s) generated in Step 339 is stored as the Revised Hyperparameter Set in Knowledge Base 62. In one embodiment, AI System Controller 21 may instruct Training Engine 39 to assign a new unique identifier to Revised Hyperparameter Set and store Revised Hyperparameter Set and its unique identifier in Knowledge Base 62. In another embodiment, Human Monitor interface 53 may instruct Training Engine 39 to assign a new unique identifier to Revised Hyperparameter Set and store Revised Hyperparameter Set and its unique identifier in Knowledge Base 62. Other processes may be used to store Revised Hyperparameter Set without departing from the spirit and scope of the exemplar method.

In Step 345, the New Predictive Model/Policy generated in Step 339 is stored as the Modified Predictive Model/Policy in Knowledge Base 62. In one embodiment, AI System Controller 21 may instruct Training Engine 39 to assign a unique identifier to Modified Predictive Model/Policy and store Modified Predictive Model/Policy and its unique identifier in Knowledge Base 62. In another embodiment, Human Monitor interface 53 may instruct Training Engine 39 to assign a unique identifier to Modified Predictive Model/Policy and store Modified Predictive Model/Policy and its unique identifier in Knowledge Base 62. Other processes may be used to store Modified Predictive Model/Policy without departing from the spirit and scope of the exemplar method.

In Step 346, New Predictive Outcome(s) generated in Step 340 is stored as the Revised Predictive Outcome in Knowledge Base 62 and/or Predictive Outcome 64. In one embodiment, AI System Controller 21 may instruct Training Engine 39 to assign a unique identifier to Revised Predictive Outcome(s) and store Revised Predictive Outcome(s) and its unique identifier in Knowledge Base 62 and/or Predictive Outcome 64. In another embodiment, Human Monitor interface 53 may instruct Training Engine 39 to assign a unique identifier to Revised Predictive Outcome(s) and store Revised Predictive Outcome(s) and its unique identifier in Knowledge Base 62 and/or Predictive Outcome 64. Other processes may be used to store Revised Predictive Outcome without departing from the spirit and scope of the exemplar method.

In Step 347, New Performance Metrics generated in Step 341 is stored as Revised Performance Metrics in Knowledge Base 62 and/or Performance Metrics 66. In one embodiment, AI System Controller 21 may instruct Training Engine 39 to assign a unique identifier to Revised Performance Metrics and store Revised Performance Metrics and its unique identifier in Knowledge Base 62 and/or Performance Metrics 66. In another embodiment, Human Monitor interface 53 may instruct Training Engine 39 to assign a unique identifier to Revised Performance Metrics and store Revised Performance Metrics and its unique identifier in Knowledge Base 62 and/or Performance Metrics 66. Other processes may be used to store Performance Metrics without departing from the spirit and scope of the exemplar method.

Modifications, additions, or omissions may be made to the Method to Modify Predictive Model Learning Algorithm(s) Based on Alterations of Hyperparameters without departing from the scope of the method. The method may include more, fewer, or other steps. Additionally, steps may be performed in any suitable order.

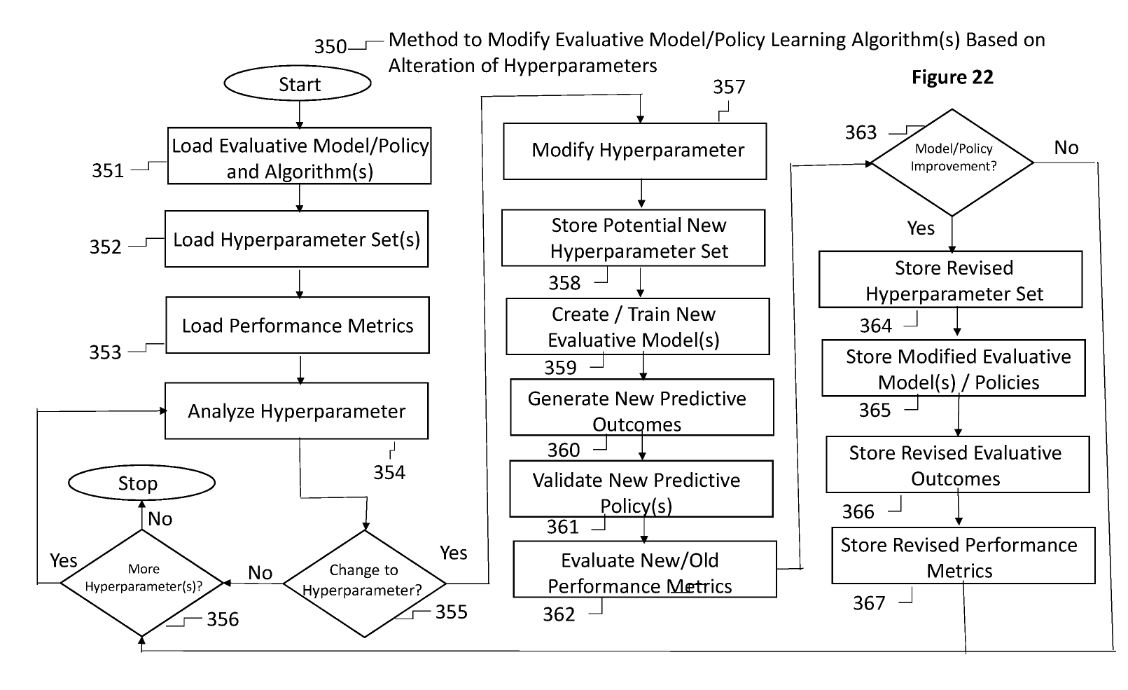

FIG. 22 illustrates one embodiment of AI System Controller 21 and/or Human Monitor interface 53 working in conjunction with Training Engine 39, Seed Knowledge Base 61, Knowledge Base 62, Tools Knowledge Base 63, Predictive Outcomes 64, and Performance Metrics 66, as exemplary Method 350, Method to Modify Evaluative Model/Policy Learning Algorithm(s) Based on Alterations of Hyperparameters. Hyperparameters are used to configure Learning Algorithms. Hyperparameters may include but not limited to the choice of kernel function in a kernel-based method, attenuation factors in iterative methods, basis function weights in approximation algorithms, etc. The method modifies Predictive Models/Policies generated in 230 Method to Create a Predictive or Evaluative Model Using a Single Learning Algorithm or 240 Method to Create a Predictive or Evaluative Model Using a Single Ensemble Technique.

In Step 351, AI System Controller 21 or Human Monitor interface 53 initiates a process to Modify Evaluative Model/Policy Learning Algorithm(s) based on Alterations of Hyperparameters, and load a single Evaluative Model/Policy and utilized Evaluative Model/Policy algorithms into Training Engine 39 for processing. In one embodiment, AI System Controller 21 may access Knowledge Base 62, retrieve a single Evaluative Model/Policy based on its unique identifier and utilized Evaluative Model/Policy algorithms based on their unique identifiers, and load a single Evaluative Model/Policy and utilized Evaluative Model/Policy algorithms into Training Engine 39 for processing. In another embodiment, Human Monitor interface 53 may access Knowledge Base 62, retrieve a single Evaluative Model/Policy based on its unique identifier and utilized Predictive Model/Policy based on its unique identifier algorithms based on their unique identifiers, and load a single Evaluative Model/Policy and utilized Evaluative Model/Policy algorithms into Training Engine 39 for processing. Other processes may be used to load a single Evaluative Model/Policy and utilized Evaluative Model/Policy algorithms into Training Engine 39 without departing from the spirit and scope of the exemplar method.

In Step 352, AI System Controller 21 or Human Monitor interface 53 may load Hyperparameter Set(s) associated with Evaluative Model/Policy loaded in Step 351 into Training Engine 39 for processing. In one embodiment, AI System Controller 21 may access Knowledge Base 62, retrieve Hyperparameter Set(s) based on its unique identifier(s) associated with Evaluative Model/Policy loaded in Step 351, and load Hyperparameter Set(s) into Training Engine 39 for processing. In another embodiment, Human Monitor interface 53 may access Knowledge Base 62, retrieve Hyperparameter Set(s) based on its unique identifier(s) associated with Evaluative Model/Policy loaded in Step 351, and load Hyperparameter Set(s) into Training Engine 39 for processing. Other processes may be used to load a single Hyperparameter Set(s) associated with Evaluative Model/Policy loaded in Step 351 into Training Engine 39 without departing from the spirit and scope of the exemplar method.

In Step 353, AI System Controller 21 or Human Monitor interface 53 may load Performance Metrics generated in 320 Method to Validate Evaluative Policies associated with Evaluative Model/Policy loaded in Step 351 into Training Engine 39 for processing. In one embodiment, AI System Controller 21 may access Knowledge Base 62, retrieve Performance Metrics and its unique identifier associated with Evaluative Model/Policy loaded in Step 351, and load Performance Metrics into Training Engine 39 for processing. In another embodiment, Human Monitor interface 53 may access Knowledge Base 62, retrieve Performance Metrics and its unique identifier associated with Evaluative Model/Policy loaded in Step 351, and load Performance Metrics into Training Engine 39 for processing. Other processes may be used to load Performance Metrics associated with Evaluative Model/Policy loaded in Step 351 into Training Engine 39 without departing from the spirit and scope of the exemplar method.

In Step 354, Training Engine 39 performs analysis on a Hyperparameter contained in a Hyperparameter Set(s) loaded in Step 352 to determine a potential change to a Hyperparameter. In certain embodiments, Training Engine 39 may use various analysis techniques for determining a potential change to a Hyperparameter including but not limited to damping factors, rate of convergence, stability, sensitivity to initial conditions, mathematical conditioning, search methods, goodness of fit, and/or cross-validation feedback. In one embodiment, AI System Controller 21 may access Tools Knowledge Base 63 and/or Seed Knowledge Base 61, determine appropriate analytic technique(s), and provide appropriate analytic computation(s) to Training Engine 39 to determine a potential change to a Hyperparameter contained within the loaded Hyperparameter Set(s). In another embodiment, Human Monitor interface 53 may provide analytic computation(s) to Training Engine 39 to determine a potential change to a Hyperparameter contained within the loaded Hyperparameter Set(s). Other processes may be used to analyze a Hyperparameter without departing from the spirit and scope of the exemplar method.

In Step 355, AI System Controller 21 determines if a potential change exists to a Hyperparameter analyzed in Step 354. Based on analytics utilized in Step 354, a potential change to a Hyperparameter may be identified. Examples of potential Hyperparameter changes may include but not limited to the choice of kernel function in a kernel-based method, attenuation factors in iterative methods, basis function weights in approximation algorithms, etc. If a potential change to a Hyperparameter exists, AI System Controller 21 instructs Training Engine 39 to initiate Step 357. If a potential change a Hyperparameter does not exist, AI System Controller 21, instructs Training Engine 39 to initiate Step 356. Other processes may be used to determine if a potential change to a Hyperparameter exists without departing from the spirit and scope of the exemplar method.

In Step 356, AI System Controller 21 determines if additional Hyperparameter(s) exists in the Hyperparameter Set loaded in Step 352. If additional Hyperparameter(s) exists, AI System Controller 21 instructs Training Engine 39 to initiate Step 354. If additional Hyperparameter(s) do not exist, AI System Controller 21, instructs Training Engine 39 to halt the method. Other processes may be used to determine if additional Hyperparameter(s) exists is possible without departing from the spirit and scope of the exemplar method.

In Step 357, Training Engine 39 may modify Hyperparameter identified for change in Step 355. In one embodiment, AI System Controller 21 may instruct Training Engine 39 to update a Hyperparameter contained in a Hyperparameter Set and assign a unique identifier. In another embodiment, Human Monitor interface 53 may instruct Training Engine 39 to update a Hyperparameter contained in a Hyperparameter Set and assign a unique identifier. Other processes may be used to modify a Hyperparameter contained in a Hyperparameter Set without departing from the spirit and scope of the exemplar method.

In Step 358, a Potential New Hyperparameter Set containing Hyperparameter modified in Step 357 is stored in Knowledge Base 62. In one embodiment, AI System Controller 21 may instruct Training Engine 39 to store the Potential New Hyperparameter Set and its unique identifier in Knowledge Base 62. In another embodiment, Human Monitor interface 53 may instruct Training Engine 39 to store the Potential New Hyperparameter Set and its unique identifier in Knowledge Base 62. Other processes may be used to store the Potential New Hyperparameter Set without departing from the spirit and scope of the exemplar method.

In Step 359, AI System Controller 21 or Human Monitor interface 53 initiates a process to create and train New Evaluative Model(s)/Policy(s). In one embodiment, AI System Controller 21 may utilize 230 Method to Create a Predictive or Evaluative Model Using a Single Learning Algorithm or 240 Method to Create a Predictive or Evaluative Model Using a Single Ensemble Technique to create and store a New Predictive Model/Policy based on the New Hyperparameter Set stored in Step 358. AI System Controller 21 may then utilize 270 Method to Train a Predictive or Evaluative Model to train new Models/Policies. In another embodiment, Human Monitor interface 53 may utilize 230 Method to Create a Predictive or Evaluative Model Using a Single Learning Algorithm or 240 Method to Create a Predictive or Evaluative Model Using a Single Ensemble Technique to create and store a New Evaluative Model/Policy based on the new Hyperparameter Set stored in Step 358. Human Monitor interface 53 may then utilize 270 Method to Train a Predictive or Evaluative Model to train new Models/Policies. Other processes may be used to create and train New Evaluative Model(s)/Policy(s) without departing from the spirit and scope of the exemplar method.

In Step 360, AI System Controller 21 or Human Monitor interface 53 initiates a process to generate New Evaluative Outcomes based on Evaluative Policy(s) created in Step 359. In one embodiment, AI System Controller 21 may utilize 300 Method to Utilize Evaluative Policies to Generate Evaluative Outcomes to generate and store a New Evaluative Outcome. In another embodiment, Human Monitor interface 53 may utilize 230 Method to Utilize Evaluative Policies to Generate Predictive Outcomes to generate and store a New Evaluative Outcome. Other processes may be used to generate New Evaluative Outcomes without departing from the spirit and scope of the exemplar method.

In Step 361, AI System Controller 21 or Human Monitor interface 53 initiates a process to validate New Evaluative Policy(s) created in Step 359. In one embodiment, AI System Controller 21 may utilize 320 Method to Validate Evaluative Policies to validate a New Evaluative Policy. In another embodiment, Human Monitor interface 53 may utilize 330 Method to Validate Evaluative Policies to validate a New Evaluative Policy. Other processes may be used to validate a New Evaluative Policies without departing from the spirit and scope of the exemplar method.

In Step 362, Training Engine 39 evaluates New Performance Metrics generated in Step 361 to old Performance Metrics loaded in Step 353 to determine if a New Evaluative Model/Policy(s) generated in Step 359 is superior to predictive performance of Evaluative Model/Policy loaded in Step 351. In one embodiment, AI System Controller 21 may access Knowledge Base 62, and load New Performance Metrics and its unique identifier for a New Evaluative Model/Policy into Training Engine 39. In this embodiment, Training Engine 39 evaluates and determines if loaded New Performance Metrics is superior to Old Performance Metrics loaded in Step 353. In another embodiment, Human Monitor interface 53 may access Knowledge Base 62, and load New Performance Metrics and its unique identifier for a New Evaluative Model/Policy into Training Engine 39. In this embodiment, Training Engine 39 evaluates and determines if loaded New Performance Metrics is superior to Old Performance Metrics loaded in Step 353. Other processes may be used to evaluate New Performance Metrics generated in step 361 to determine if a New Evaluative Model/Policy is superior in predictive performance to an Older Model/Policy's predictive performance without departing from the spirit and scope of the exemplar method.

In Step 363, AI System Controller 21 determines if there is a significant improvement of Performance Metrics evaluated in Step 362. Types of Significant Improvement calculations utilized may include but not limited to Chi Square, Degrees of Freedom, T-Tests, etc. In one embodiment, AI System Controller 21 may access Seed Knowledge Base 61 and/or Tools Knowledge Base 63, and load appropriate Significant Difference calculations into Training Engine 39. In this embodiment, Training Engine 39 evaluates and determines if a New Evaluative Model/Policy's predictive performance is a significant difference of improvement over a previous older Evaluative Model/Policy's predictive performance. If a significant difference of improvement utilizing the New Evaluative Model/Policy's predictive performance exists, AI System Controller 21 instructs Training Engine 39 to initiate Step 364. If a significant improvement utilizing the New Evaluative Model/Policy's predictive performance does not exist, AI System Controller 21 instructs Training Engine 39 to initiate Step 356. Other processes may be used to determine if a New Evaluative Model/Policy predictive performance is a significant difference of improvement over a previous older Evaluative Model/Policy's predictive performance without departing from the spirit and scope of the exemplar method.

In Step 364, the New Hyperparameter Set(s) generated in Step 359 is stored as the Revised Hyperparameter Set in Knowledge Base 62. In one embodiment, AI System Controller 21 may instruct Training Engine 39 to assign a new unique identifier to Revised Hyperparameter Set and store Revised Hyperparameter Set and its unique identifier in Knowledge Base 62. In another embodiment, Human Monitor interface 53 may instruct Training Engine 39 to assign a new unique identifier to Revised Hyperparameter Set and store Revised Hyperparameter Set and its unique identifier in Knowledge Base 62. Other processes may be used to store Revised Hyperparameter Set without departing from the spirit and scope of the exemplar method.

In Step 365, the New Evaluative Model/Policy generated in Step 359 is stored as the Modified Evaluative Model/Policy in Knowledge Base 62. In one embodiment, AI System Controller 21 may instruct Training Engine 39 to assign a unique identifier to Modified Evaluative Model/Policy and store Modified Evaluative Model/Policy and its unique identifier in Knowledge Base 62. In another embodiment, Human Monitor interface 53 may instruct Training Engine 39 to assign a unique identifier to Modified Evaluative Model/Policy and store Modified Evaluative Model/Policy and its unique identifier in Knowledge Base 62. Other processes may be used to store Modified Evaluative Model/Policy without departing from the spirit and scope of the exemplar method.

In Step 366, New Evaluative Outcome(s) generated in Step 360 is stored as the Revised Evaluative Outcome in Knowledge Base 62 and/or Evaluative Outcome 64. In one embodiment, AI System Controller 21 may instruct Training Engine 39 to assign a unique identifier to Revised Evaluative Outcome(s) and store Revised Evaluative Outcome(s) and its unique identifier in Knowledge Base 62 and/or Evaluative Outcome 64. In another embodiment, Human Monitor interface 53 may instruct Training Engine 39 to assign a unique identifier to Revised Evaluative Outcome(s) and store Revised Evaluative Outcome(s) and its unique identifier in Knowledge Base 62 and/or Evaluative Outcome 64. Other processes may be used to store Revised Evaluative Outcome without departing from the spirit and scope of the exemplar method.

In Step 367, New Performance Metrics generated in Step 361 is stored as Revised Performance Metrics in Knowledge Base 62 and/or Performance Metrics 66. In one embodiment, AI System Controller 21 may instruct Training Engine 39 to assign a unique identifier to Revised Performance Metrics and store Revised Performance Metrics and its unique identifier in Knowledge Base 62 and/or Performance Metrics 66. In another embodiment, Human Monitor interface 53 may instruct Training Engine 39 to assign a unique identifier to Revised Performance Metrics and store Revised Performance Metrics and its unique identifier in Knowledge Base 62 and/or Performance Metrics 66. Other processes may be used to store Performance Metrics without departing from the spirit and scope of the exemplar method.

Modifications, additions, or omissions may be made to the Method to Modify Evaluative Model Learning Algorithm(s) Based on Alterations of Hyperparameters without departing from the scope of the method. The method may include more, fewer, or other steps. Additionally, steps may be performed in any suitable order.

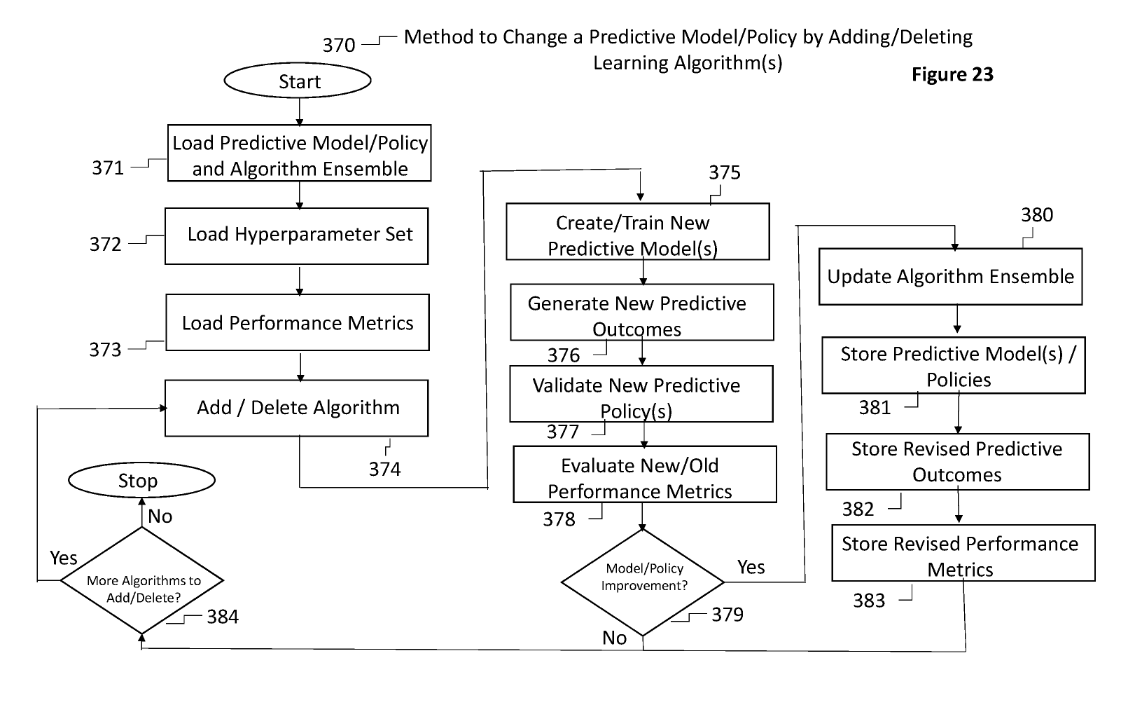

FIG. 23 illustrates one embodiment of AI System Controller 21 and/or Human Monitor interface 53 working in conjunction with Training Engine 39, Seed Knowledge Base 61, Knowledge Base 62, Tools Knowledge Base 63, Predictive Outcomes 64, and Performance Metrics 66, as exemplary Method 370, Method to Change Predictive Model/Policy by Adding/Deleting Learning Algorithm(s). Learning Algorithms are utilized by Machine Learning techniques in Model building. Major types of Machine Learning techniques include but not limited to Supervised Learning, Unsupervised Learning, Semi-Supervised Learning, Reinforcement Learning, etc. There are thousands of Learning Algorithms available to support various Machine Learning techniques including but limited to k-Means, Logistic Regression, Neural Network, Least Angle Regression (LARS), etc. The method modifies Predictive Models/Policies generated in 230 Method to Create a Predictive or Evaluative Model Using a Single Learning Algorithm or 240 Method to Create a Predictive or Evaluative Model Using a Single Ensemble Technique.

In Step 371, AI System Controller 21 or Human Monitor interface 53 initiates a process to Modify Predictive Model/Policy by Adding/Deleting Learning Algorithms, and load a single Predictive Model/Policy based on its unique identifier and associated Predictive Model/Policy Algorithm, or Algorithm Ensemble based on their unique identifiers into Training Engine 39 for processing. In one embodiment, AI System Controller 21 may access Knowledge Base 62, retrieve a single Predictive Model/Policy based on its unique identifier and utilized Predictive Model/Policy Algorithm, or Algorithm Ensemble based on their unique identifiers, and load a single Predictive Model/Policy and utilized Predictive Model/Policy Algorithm, or Algorithm Ensemble into Training Engine 39 for processing. In another embodiment, Human Monitor interface 53 may access Knowledge Base 62, retrieve a single Predictive Model/Policy based on its unique identifier and utilized Predictive Model/Policy Algorithm, or Algorithm Ensemble based on their unique identifiers, and load a single Predictive Model/Policy and utilized Predictive Model/Policy Algorithm, or Algorithm Ensemble into Training Engine 39 for processing. Other processes may be used to load a single Predictive Model/Policy and utilized Predictive Model/Policy Algorithm, or Algorithm Ensemble into Training Engine 39 without departing from the spirit and scope of the exemplar method.

In Step 372, AI System Controller 21 or Human Monitor interface 53 may load Hyperparameter Set(s) associated with Predictive Model/Policy loaded in Step 371 into Training Engine 39 for processing. In one embodiment, AI System Controller 21 may access Knowledge Base 62, retrieve Hyperparameter Set(s) based on their unique identifiers associated with Predictive Model/Policy loaded in Step 371, and load Hyperparameter Set(s) into Training Engine 39 for processing. In another embodiment, Human Monitor interface 53 may access Knowledge Base 62, retrieve Hyperparameter Set(s) based on their unique identifiers associated with Predictive Model/Policy loaded in Step 371, and load Hyperparameter Set(s) into Training Engine 39 for processing. Other processes may be used to load a single Hyperparameter Set(s) associated with Predictive Model/Policy loaded in Step 371 into Training Engine 39 without departing from the spirit and scope of the exemplar method.

In Step 373, AI System Controller 21 or Human Monitor interface 53 may load Performance Metrics associated with Predictive Model/Policy loaded in Step 371 into Training Engine 39 for processing. In one embodiment, AI System Controller 21 may access Knowledge Base 62, retrieve Performance Metrics based on their unique identifiers associated with Predictive Model/Policy loaded in Step 371, and load Performance Metrics into Training Engine 39 for processing. In another embodiment, Human Monitor interface 53 may access Knowledge Base 62, retrieve Performance Metrics associated with Predictive Model/Policy loaded in Step 371, and load Performance Metrics into Training Engine 39 for processing. Other processes may be used to load Performance Metrics associated with Predictive Model/Policy loaded in Step 371 into Training Engine 39 without departing from the spirit and scope of the exemplar method.

In Step 374, Training Engine 39 performs analysis on an Algorithm, or Algorithm Ensemble loaded in Step 371 and adds and/or deletes an algorithm. In certain embodiments, Training Engine 39 may use various analysis techniques for determining weak Learning Algorithms within an Algorithm Ensemble including but not limited to quantification of overfitting, direct cross-validation performance assessment, rank-based elimination, natural selection methods, redundancy checks, stochastic decision making, and/or minimum acceptable weight thresholds. In one embodiment, AI System Controller 21 may access Tools Knowledge Base 63 and/or Seed Knowledge Base 61, determine appropriate analytic computation(s), and load appropriate analytic computation(s) into Training Engine 39 to determine an addition and/or deletion of an algorithm to the Algorithm Ensemble. In certain embodiments, Training Engine 39 may utilize loaded analytic computations to and/or delete an algorithm to the Algorithm Ensemble. If an algorithm was added or deleted to the Algorithm Ensemble, AI System Controller assigns a new unique identifier to the Algorithm Ensemble. In another embodiment, Human Monitor interface 53 may access Tools Knowledge Base 63 and/or Seed Knowledge Base 61, determine appropriate analytic computation(s), and load appropriate analytic computation(s) into Training Engine 39 to determine an addition and/or deletion of an algorithm to the Algorithm Ensemble. In certain embodiments, Training Engine 39 may utilize loaded analytic computations to add and/or delete an algorithm to the Algorithm Ensemble. If an algorithm was added or deleted to the Algorithm Ensemble, AI System Controller assigns a new unique identifier to the Algorithm Ensemble. Other processes may be used to analyze the Algorithm Ensemble, and add and/or delete an algorithm to the Algorithm Ensemble without departing from the spirit and scope of the exemplar method.

In Step 375, AI System Controller 21 or Human Monitor interface 53 initiates a process to create and train New Predictive Model(s)/Policy(s) based on Algorithm Ensemble created/modified in Step 374. In one embodiment, AI System Controller 21 may utilize 230 Method to Create a Predictive or Evaluative Model Using a Single Learning Algorithm or 240 Method to Create a Predictive or Evaluative Model Using a Single Ensemble Technique to create and store a New Predictive Model/Policy based on new/modified Algorithm Ensemble created in Step 374. AI System Controller 21 may then utilize 270 Method to Train a Predictive or Evaluative Model to train new Models/Policies. In another embodiment, Human Monitor interface 53 may utilize 230 Method to Create a Predictive or Evaluative Model Using a Single Learning Algorithm or 240 Method to Create a Predictive or Evaluative Model Using a Single Ensemble Technique to create and store a New Predictive Model/Policy based on new/modified Algorithm Ensemble created in Step 374. Human Monitor interface 53 may then utilize 270 Method to Train a Predictive or Evaluative Model to train new Models/Policies. Other processes may be used to create and train New Predictive Model(s)/Policy(s) without departing from the spirit and scope of the exemplar method.

In Step 376, AI System Controller 21 or Human Monitor interface 53 initiates a process to generate New Predictive Outcomes based on Predictive Policy(s) created in Step 375. In one embodiment, AI System Controller 21 may utilize 290 Method to Utilize Predictive Policies to Generate Predictive Outcomes to generate and store a New Predictive Outcome. In another embodiment, Human Monitor interface 53 may utilize 290 Method to Utilize Predictive Policies to Generate Predictive Outcomes to generate and store a New Predictive Outcome. Other processes may be used to generate New Predictive Outcomes without departing from the spirit and scope of the exemplar method.

In Step 377, AI System Controller 21 or Human Monitor interface 53 initiates a process to validate New Predictive Policy(s) created in Step 375. In one embodiment, AI System Controller 21 may utilize 310 Method to Validate Predictive Policies to validate a New Predictive Policy. In another embodiment, Human Monitor interface 53 may utilize 310 Method to Validate Predictive Policies to validate a New Predictive Policy. Other processes may be used to validate a New Predictive Policies without departing from the spirit and scope of the exemplar method.

In Step 378, Training Engine 39 evaluates New Performance Metrics generated in step 377 to old Performance Metrics loaded in Step 373 to determine if a New Predictive Model/Policy(s) generated in Step 375 is superior to predictive performance of Predictive Model/Policy loaded in Step 371. In one embodiment, AI System Controller 21 may access Knowledge Base 62, and load New Performance Metrics and its unique identifier for a New Predictive Model/Policy into Training Engine 39. In this embodiment, Training Engine 39 determines if loaded New Performance Metrics is superior to Old Performance Metrics loaded in Step 373. In another embodiment, Human Monitor interface 53 may access Knowledge Base 62, and load New Performance Metrics and its unique identifier for a New Predictive Model/Policy into Training Engine 39. In this embodiment, Training Engine 39 evaluates and determines if loaded New Performance Metrics is superior to Old Performance Metrics loaded in Step 373. Other processes may be used to evaluate New Performance Metrics generated in step 377 to determine if a New Predictive Model/Policy is superior in predictive performance to an Older Predictive Model/Policy's predictive performance without departing from the spirit and scope of the exemplar method.

In Step 379, AI System Controller 21 determines if there is a significant improvement of Performance Metrics evaluated in Step 378. Types Significant Improvement calculations utilized may include but not limited to Chi Square, Degrees of Freedom, T-Tests, etc. In one embodiment, AI System Controller 21 may access Seed Knowledge Base 61 and/or Tools Knowledge Base 63, and load appropriate Significant Difference calculations into Training Engine 39. In this embodiment, Training Engine 39 evaluates and determines if a New Predictive Model/Policy's predictive performance is a significant difference of improvement over a previous older Predictive Model/Policy's predictive performance. If a significant difference of improvement utilizing the New Predictive Model/Policy's predictive performance exists, AI System Controller 21 instructs Training Engine 39 to initiate Step 380. If a significant improvement utilizing the New Predictive Model/Policy's predictive performance does not exist, AI System Controller 21 instructs Training Engine 39 to initiate Step 384. Other processes may be used to determine if a New Predictive Model/Policy predictive performance is a significant difference of improvement over a previous older Predictive Model/Policy's predictive performance without departing from the spirit and scope of the exemplar method.

In Step 380, the New Algorithm Ensemble generated in Step 374 is stored as Revised Algorithm Ensemble in Knowledge Base 62. In one embodiment, AI System Controller 21 may instruct Training Engine 39 to assign a new unique identifier to Revised Algorithm Ensemble and store Revised Algorithm Ensemble and its unique identifier in Knowledge Base 62. In another embodiment, Human Monitor interface 53 may instruct Training Engine 39 to assign a new unique identifier to Revised Algorithm Ensemble and store Revised Algorithm Ensemble and its unique identifier in Knowledge Base 62. Other processes may be used to store Revised Algorithm Ensemble without departing from the spirit and scope of the exemplar method.

In Step 381, the New Predictive Model/Policy generated in Step 375 is stored as the Modified Predictive Model/Policy in Knowledge Base 62. In one embodiment, AI System Controller 21 may instruct Training Engine 39 to assign a unique identifier to Modified Predictive Model/Policy and store Modified Predictive Model/Policy and its unique identifier in Knowledge Base 62. In another embodiment, Human Monitor interface 53 may instruct Training Engine 39 to assign a unique identifier to Modified Predictive Model/Policy and store Modified Predictive Model/Policy and its unique identifier in Knowledge Base 62. Other processes may be used to store Modified Predictive Model/Policy without departing from the spirit and scope of the exemplar method.

In Step 382, New Predictive Outcome(s) generated in Step 376 is stored as the Revised Predictive Outcome in Knowledge Base 62 and/or Predictive Outcome 64. In one embodiment, AI System Controller 21 may instruct Training Engine 39 to assign a unique identifier to Revised Predictive Outcome(s) and store Revised Predictive Outcome(s) and its unique identifier in Knowledge Base 62 and/or Predictive Outcome 64. In another embodiment, Human Monitor interface 53 may instruct Training Engine 39 to assign a unique identifier to Revised Predictive Outcome(s) and store Revised Predictive Outcome(s) and its unique identifier in Knowledge Base 62 and/or Predictive Outcome 64. Other processes may be used to store Revised Predictive Outcome without departing from the spirit and scope of the exemplar method.

In Step 383, New Performance Metrics generated in Step 377 is stored as Revised Performance Metrics in Knowledge Base 62 and/or Performance Metrics 66. In one embodiment, AI System Controller 21 may instruct Training Engine 39 to assign a unique identifier to Revised Performance Metrics and store Revised Performance Metrics and its unique identifier in Knowledge Base 62 and/or Performance Metrics 66. In another embodiment, Human Monitor interface 53 may instruct Training Engine 39 to assign a unique identifier to Revised Performance Metrics and store Revised Performance Metrics and its unique identifier in Knowledge Base 62 and/or Performance Metrics 66. Other processes may be used to store Revised Performance Metrics without departing from the spirit and scope of the exemplar method.

In Step 384, AI System Controller 21 determines if additional algorithms contained in Algorithm Ensemble loaded in Step 371 can be added or deleted. If additional algorithms can be added or deleted, AI System Controller 21 instructs Training Engine 39 to initiate Step 374. If additional algorithms cannot be added or deleted, AI System Controller 21, instructs Training Engine 39 to halt the method. Other processes may be used to determine if algorithms can be added or deleted without departing from the spirit and scope of the exemplar method.

Modifications, additions, or omissions may be made to the Method to Change a Predictive Model/Policy by Adding/Deleting Learning Algorithms without departing from the scope of the method. The method may include more, fewer, or other steps. Additionally, steps may be performed in any suitable order.

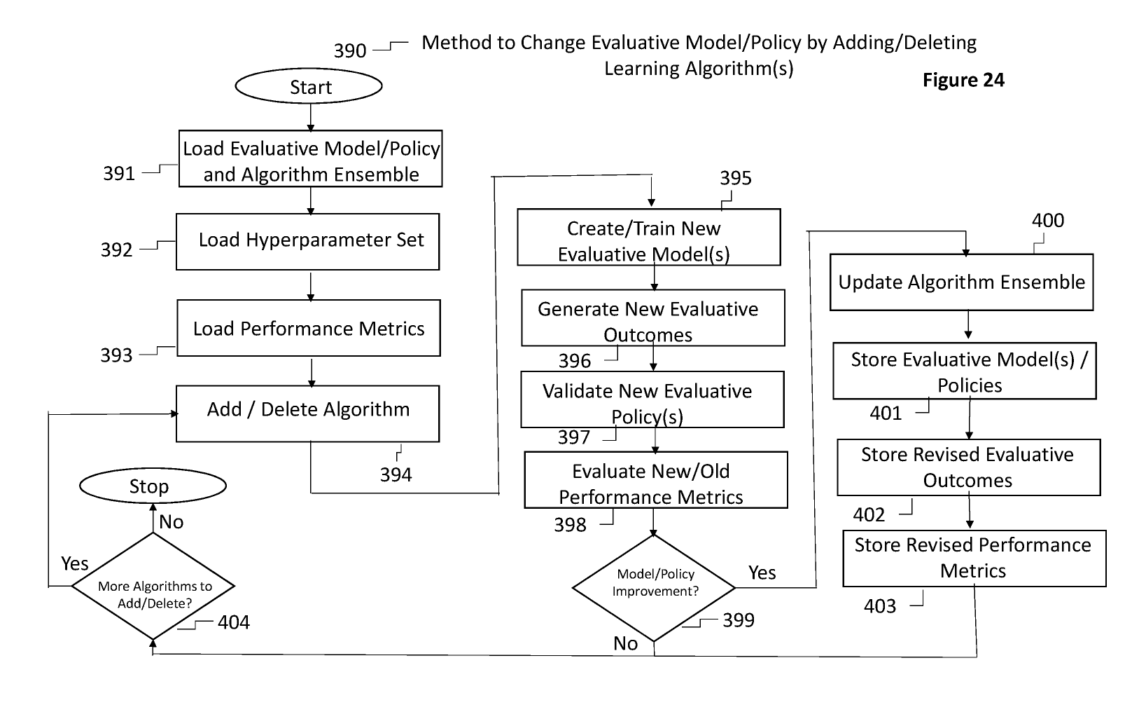

FIG. 24 illustrates one embodiment of AI System Controller 21 and/or Human Monitor interface 53 working in conjunction with Training Engine 39, Seed Knowledge Base 61, Knowledge Base 62, Tools Knowledge Base 63, Evaluative Outcomes 65, and Performance Metrics 66, as exemplary Method 390, Method to Change Evaluative Model/Policy by Adding/Deleting Learning Algorithm(s). Learning Algorithms are utilized by Machine Learning techniques in Model building. Major types of Machine Learning techniques include but not limited to Supervised Learning, Unsupervised Learning, Semi-Supervised Learning, Reinforcement Learning, etc. There are thousands of Learning Algorithms available to support various Machine Learning techniques including but limited to k-Means, Logistic Regression, Neural Network, Least Angle Regression (LARS), etc. The method modifies Evaluative Models/Policies generated in 230 Method to Create a Predictive or Evaluative Model Using a Single Learning Algorithm or 240 Method to Create a Predictive or Evaluative Model Using a Single Ensemble Technique.

In Step 391, AI System Controller 21 or Human Monitor interface 53 initiates a process to Modify Evaluative Model/Policy by Adding/Deleting Learning Algorithms), and load a single Evaluative Model/Policy based on its unique identifier and associated Evaluative Model/Policy Algorithm Ensemble based on their unique identifiers into Training Engine 39 for processing. In one embodiment, AI System Controller 21 may access Knowledge Base 62, retrieve a single Evaluative Model/Policy based on its unique identifier and utilized Evaluative Model/Policy Algorithm, or Algorithm Ensemble based on their unique identifiers, and load a single Evaluative Model/Policy and utilized Evaluative Model/Policy Algorithm, or Algorithm Ensemble into Training Engine 39 for processing. In another embodiment, Human Monitor interface 53 may access Knowledge Base 62, retrieve a single Evaluative Model/Policy based on its unique identifier and utilized Evaluative Model/Policy Algorithm, or Algorithm Ensemble based on their unique identifiers, and load a single Evaluative Model/Policy and utilized Evaluative Model/Policy Algorithm, or Algorithm Ensemble into Training Engine 39 for processing. Other processes may be used to load a single Evaluative Model/Policy and utilized Evaluative Model/Policy Algorithm, or Algorithm Ensemble into Training Engine 39 without departing from the spirit and scope of the exemplar method.

In Step 392, AI System Controller 21 or Human Monitor interface 53 may load Hyperparameter Set(s) associated with Evaluative Model/Policy loaded in Step 391 into Training Engine 39 for processing. In one embodiment, AI System Controller 21 may access Knowledge Base 62, retrieve Hyperparameter Set(s) based on their unique identifiers associated with Evaluative Model/Policy loaded in Step 391, and load Hyperparameter Set(s) into Training Engine 39 for processing. In another embodiment, Human Monitor interface 53 may access Knowledge Base 62, retrieve Hyperparameter Set(s) based on their unique identifiers associated with Evaluative Model/Policy loaded in Step 391, and load Hyperparameter Set(s) into Training Engine 39 for processing. Other processes may be used to load a single Hyperparameter Set(s) associated with Evaluative Model/Policy loaded in Step 391 into Training Engine 39 without departing from the spirit and scope of the exemplar method.

In Step 393, AI System Controller 21 or Human Monitor interface 53 may load Performance Metrics associated with Evaluative Model/Policy loaded in Step 391 into Training Engine 39 for processing. In one embodiment, AI System Controller 21 may access Knowledge Base 62, retrieve Performance Metrics based on their unique identifiers associated with Evaluative Model/Policy loaded in Step 391, and load Performance Metrics into Training Engine 39 for processing. In another embodiment, Human Monitor interface 53 may access Knowledge Base 62, retrieve Performance Metrics associated with Evaluative Model/Policy loaded in Step 391, and load Performance Metrics into Training Engine 39 for processing. Other processes may be used to load Performance Metrics associated with Evaluative Model/Policy loaded in Step 391 into Training Engine 39 without departing from the spirit and scope of the exemplar method.

In Step 394, Training Engine 39 performs analysis on an Algorithm, or Algorithm Ensemble loaded in Step 391 and adds and/or deletes an algorithm. In certain embodiments, Training Engine 39 may use various analysis techniques for determining weak Learning Algorithms within an Algorithm Ensemble including but not limited to quantification of overfitting, direct cross-validation performance assessment, rank-based elimination, natural selection methods, redundancy checks, stochastic decision making, and/or minimum acceptable weight thresholds. In one embodiment, AI System Controller 21 may access Tools Knowledge Base 63 and/or Seed Knowledge Base 61, determine appropriate analytic computation(s), and load appropriate analytic computation(s) into Training Engine 39 to determine an addition and/or deletion of an algorithm to the Algorithm Ensemble. In certain embodiments, Training Engine 39 may utilize loaded analytic computations to and/or delete an algorithm to the Algorithm Ensemble. If an algorithm was added or deleted to the Algorithm Ensemble, AI System Controller assigns a new unique identifier to the Algorithm Ensemble. In another embodiment, Human Monitor interface 53 may access Tools Knowledge Base 63 and/or Seed Knowledge Base 61, determine appropriate analytic computation(s), and load appropriate analytic computation(s) into Training Engine 39 to determine an addition and/or deletion of an algorithm to the Algorithm Ensemble. In certain embodiments, Training Engine 39 may utilize loaded analytic computations to add and/or delete an algorithm in the Algorithm Ensemble. If an algorithm was added or deleted to the Algorithm Ensemble, AI System Controller assigns a new unique identifier to the Algorithm Ensemble. Other processes may be used to analyze the Algorithm Ensemble, and add and/or delete an algorithm to the Algorithm Ensemble without departing from the spirit and scope of the exemplar method.

In Step 395, AI System Controller 21 or Human Monitor interface 53 initiates a process to create and train New Predictive Model(s)/Policy(s) based on Algorithm Ensemble created/modified in Step 394. In one embodiment, AI System Controller 21 may utilize 230 Method to Create a Predictive or Evaluative Model Using a Single Learning Algorithm or 240 Method to Create a Predictive or Evaluative Model Using a Single Ensemble Technique to create and store a New Evaluative Model/Policy based on new/modified Algorithm Ensemble created in Step 394. AI System Controller 21 may then utilize 270 Method to Train a Predictive or Evaluative Model to train new Models/Policies. In another embodiment, Human Monitor interface 53 may utilize 230 Method to Create a Predictive or Evaluative Model Using a Single Learning Algorithm or 240 Method to Create a Predictive or Evaluative Model Using a Single Ensemble Technique to create and store a New Evaluative Model/Policy based on new Algorithm Ensemble created/modified in Step 394. Human Monitor interface 53 may then utilize 270 Method to Train a Predictive or Evaluative Model to train new Models/Policies. Other processes may be used to create and train New Evaluative Model(s)/Policy(s) without departing from the spirit and scope of the exemplar method.

In Step 396, AI System Controller 21 or Human Monitor interface 53 initiates a process to generate New Evaluative Outcomes based on Evaluative Policy(s) created in Step 395. In one embodiment, AI System Controller 21 may utilize 300 Method to Utilize Evaluative Policies to Generate Evaluative Outcomes to generate and store a New Evaluative Outcome. In another embodiment, Human Monitor interface 53 may utilize 300 Method to Utilize Evaluative Policies to Generate Predictive Outcomes to generate and store a New Evaluative Outcome. Other processes may be used to generate New Evaluative Outcomes without departing from the spirit and scope of the exemplar method.

In Step 397, AI System Controller 21 or Human Monitor interface 53 initiates a process to validate New Evaluative Policy(s) created in Step 395. In one embodiment, AI System Controller 21 may utilize 320 Method to Validate Evaluative Policies to validate a New Evaluative Policy. In another embodiment, Human Monitor interface 53 may utilize 320 Method to Validate Evaluative Policies to validate a New Evaluative Policy. Other processes may be used to validate a New Evaluative Policies without departing from the spirit and scope of the exemplar method.

In Step 398, Training Engine 39 evaluates New Performance Metrics generated in step 397 to Performance Metrics loaded in Step 393 to determine if a New Evaluative Model/Policy(s) generated in Step 395 is superior to predictive performance of Predictive Model/Policy loaded in Step 391. In one embodiment, AI System Controller 21 may access Knowledge Base 62, and load New Performance Metrics and its unique identifier for a New Evaluative Model/Policy into Training Engine 39. In this embodiment, Training Engine 39 determines if loaded New Performance Metrics is superior to Performance Metrics loaded in Step 393. In another embodiment, Human Monitor interface 53 may access Knowledge Base 62, and load New Performance Metrics and its unique identifier for a New Evaluative Model/Policy into Training Engine 39. In this embodiment, Training Engine 39 evaluates and determines if loaded New Performance Metrics is superior to Performance Metrics loaded in Step 393. Other processes may be used to evaluate New Performance Metrics generated in step 397 to determine if a New Evaluative Model/Policy is superior in predictive performance to an older Evaluative Model/Policy's predictive performance without departing from the spirit and scope of the exemplar method.

In Step 399, AI System Controller 21 determines if there is a significant improvement of Performance Metrics evaluated in Step 398. Types Significant Improvement calculations utilized may include but not limited to Chi Square, Degrees of Freedom, T-Tests, etc. In one embodiment, AI System Controller 21 may access Seed Knowledge Base 61 and/or Tools Knowledge Base 63, and load appropriate Significant Difference calculations into Training Engine 39. In this embodiment, Training Engine 39 evaluates and determines if a New Evaluative Model/Policy's predictive performance is a significant difference of improvement over a previous older Evaluative Model/Policy's predictive performance. If a significant difference of improvement utilizing the New Evaluative Model/Policy's predictive performance exists, AI System Controller 21 instructs Training Engine 39 to initiate Step 400. If a significant improvement utilizing the New Evaluative Model/Policy's predictive performance does not exist, AI System Controller 21 instructs Training Engine 39 to initiate Step 404. Other processes may be used to determine if a New Evaluative Model/Policy predictive performance is a significant difference of improvement over a previous older Evaluative Model/Policy's predictive performance without departing from the spirit and scope of the exemplar method.

In Step 400, the New Algorithm Ensemble generated in Step 394 is stored as Revised Algorithm Ensemble in Knowledge Base 62. In one embodiment, AI System Controller 21 may instruct Training Engine 39 to assign a new unique identifier to Revised Algorithm Ensemble and store Revised Algorithm Ensemble and its unique identifier in Knowledge Base 62. In another embodiment, Human Monitor interface 53 may instruct Training Engine 39 to assign a new unique identifier to Revised Algorithm Ensemble and store Revised Algorithm Ensemble and its unique identifier in Knowledge Base 62. Other processes may be used to store Revised Algorithm Ensemble without departing from the spirit and scope of the exemplar method.

In Step 401, the New Evaluative Model/Policy generated in Step 395 is stored as the Modified Evaluative Model/Policy in Knowledge Base 62. In one embodiment, AI System Controller 21 may instruct Training Engine 39 to assign a unique identifier to Modified Evaluative Model/Policy and store Modified Evaluative Model/Policy and its unique identifier in Knowledge Base 62. In another embodiment, Human Monitor interface 53 may instruct Training Engine 39 to assign a unique identifier to Modified Evaluative Model/Policy and store Modified Evaluative Model/Policy and its unique identifier in Knowledge Base 62. Other processes may be used to store Modified Evaluative Model/Policy without departing from the spirit and scope of the exemplar method.

In Step 402, New Evaluative Outcome(s) generated in Step 396 is stored as the Revised Evaluative Outcome in Knowledge Base 62 and/or Evaluative Outcome 65. In one embodiment, AI System Controller 21 may instruct Training Engine 39 to assign a unique identifier to Revised Evaluative Outcome(s) and store Revised Evaluative Outcome(s) and its unique identifier in Knowledge Base 62 and/or Evaluative Outcome 65. In another embodiment, Human Monitor interface 53 may instruct Training Engine 39 to assign a unique identifier to Revised Evaluative Outcome(s) and store Revised Evaluative Outcome(s) and its unique identifier in Knowledge Base 62 and/or Evaluative Outcome 65. Other processes may be used to store Revised Evaluative Outcome without departing from the spirit and scope of the exemplar method.

In Step 403, New Performance Metrics generated in Step 397 is stored as Revised Performance Metrics in Knowledge Base 62 and/or Performance Metrics 66. In one embodiment, AI System Controller 21 may instruct Training Engine 39 to assign a unique identifier to Revised Performance Metrics and store Revised Performance Metrics and its unique identifier in Knowledge Base 62 and/or Performance Metrics 66. In another embodiment, Human Monitor interface 53 may instruct Training Engine 39 to assign a unique identifier to Revised Performance Metrics and store Revised Performance Metrics and its unique identifier in Knowledge Base 62 and/or Performance Metrics 66. Other processes may be used to store Revised Performance Metrics without departing from the spirit and scope of the exemplar method.

In Step 404, AI System Controller 21 determines if additional algorithms contained in Algorithm Ensemble loaded in Step 391 can be added or deleted. If additional algorithms can be added or deleted, AI System Controller 21 instructs Training Engine 39 to initiate Step 394. If additional algorithms cannot be added or deleted, AI System Controller 21, instructs Training Engine 39 to halt the method. Other processes may be used to determine if algorithms can be added or deleted without departing from the spirit and scope of the exemplar method.

Modifications, additions, or omissions may be made to the Method to Change Evaluative Model/Policy by Adding/Deleting Learning Algorithm(s) without departing from the scope of the method. The method may include more, fewer, or other steps. Additionally, steps may be performed in any suitable order.

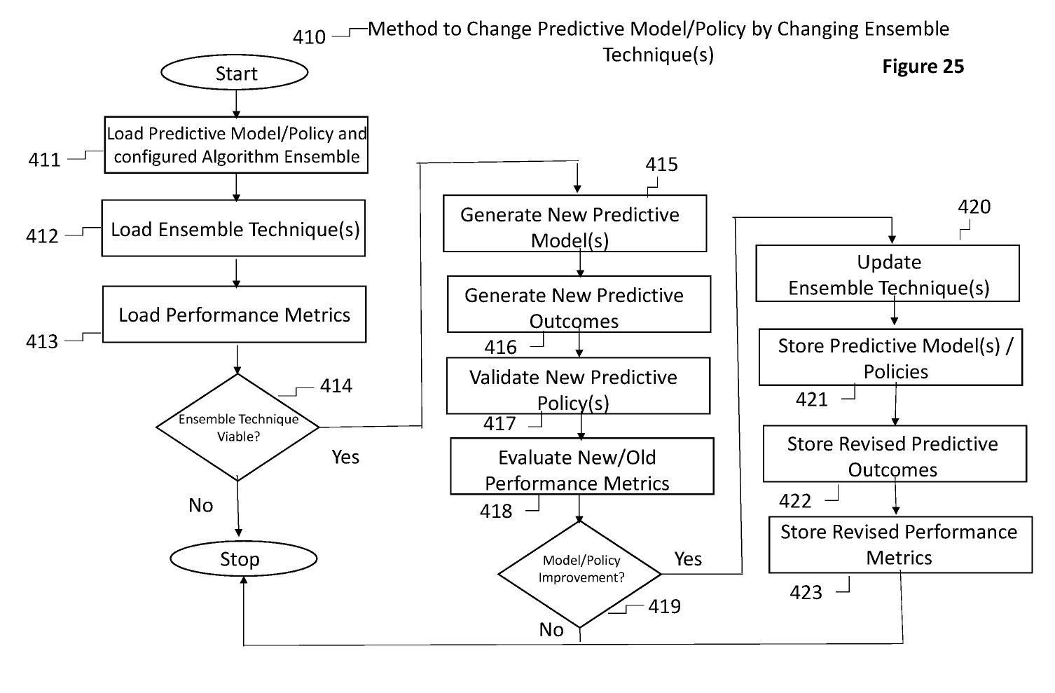

FIG. 25 illustrates one embodiment of AI System Controller 21 and/or Human Monitor interface 53 working in conjunction with Training Engine 39, Seed Knowledge Base 61, Knowledge Base 62, Tools Knowledge Base 63, Predictive Outcomes 64, and Performance Metrics 66, as exemplary Method 410, Method to Change Predictive Model by Changing Ensemble Technique(s). An Ensemble Technique is used to assemble two or more configured Learning Algorithms in a sequence in building a Predictive Model. The method modifies Predictive Models/Policies generated in 240 Method to Create a Predictive or Evaluative Model Using a Single Ensemble Technique.

In Step 411, AI System Controller 21 or Human Monitor interface 53 initiates a process to Modify Predictive Model/Policy by applying new Ensemble Technique(s), and load a single Predictive Model/Policy based on its unique identifier, and associated Predictive Model/Policy Algorithm Ensemble based on their unique identifiers into Training Engine 39 for processing. In one embodiment, AI System Controller 21 may access Knowledge Base 62, retrieve a single Predictive Model/Policy based on its unique identifier, and associated Predictive Model/Policy Algorithm Ensemble based on their unique identifiers, and load a single Predictive Model/Policy, and Predictive Model/Policy Algorithm Ensemble used into Training Engine 39 for processing. In another embodiment, Human Monitor interface 53 may access Knowledge Base 62, retrieve a single Predictive Model/Policy based on its unique identifier, and associated Predictive Model/Policy Algorithm Ensemble based on their unique identifiers and load a single Predictive Model/Policy, and associated Predictive Model/Policy Algorithm Ensemble into Training Engine 39 for processing. Other processes may be used to load a single Predictive Model/Policy and associated Predictive Model/Policy Algorithm Ensemble into Training Engine 39 without departing from the spirit and scope of the exemplar method.

In Step 412, AI System Controller 21 or Human Monitor interface 53 may load Ensemble Technique(s) based on their unique identifiers associated with Predictive Model/Policy loaded in Step 411 into Training Engine 39 for processing. In one embodiment, AI System Controller 21 may access Knowledge Base 62, retrieve Ensemble Technique(s) based on their unique identifiers associated with Predictive Model/Policy loaded in Step 411, and load Ensemble Technique(s) into Training Engine 39 for processing. In another embodiment, Human Monitor interface 53 may access Knowledge Base 62, retrieve Ensemble Technique(s) based on their unique identifiers associated with Predictive Model/Policy loaded in Step 411, and load Ensemble Technique(s) into Training Engine 39 for processing. Other processes may be used to load Ensemble Technique(s) associated with Predictive Model/Policy loaded in Step 411 into Training Engine 39 without departing from the spirit and scope of the exemplar method.

In Step 413, AI System Controller 21 or Human Monitor interface 53 may load Performance Metrics associated with Predictive Model/Policy loaded in Step 411 into Training Engine 39 for processing. In one embodiment, AI System Controller 21 may access Knowledge Base 62, retrieve Performance Metrics based on their unique identifiers associated with Predictive Model/Policy loaded in Step 411, and load Performance Metrics into Training Engine 39 for processing. In another embodiment, Human Monitor interface 53 may access Knowledge Base 62, retrieve Performance Metrics associated with Predictive Model/Policy loaded in Step 411, and load Performance Metrics into Training Engine 39 for processing. Other processes may be used to load Performance Metrics associated with Predictive Model/Policy loaded in Step 411 into Training Engine 39 without departing from the spirit and scope of the exemplar method.

In Step 414, Training Engine 39 performs analysis on an Ensemble Technique(s) loaded in Step 412 and determines if the use of another Ensemble Technique is viable. In certain embodiments, Training Engine 39 may use various analysis techniques for analyzing an Ensemble Technique including but not limited to direct comparison between ensemble technique performance, trade-off analysis, and/or contextual prioritization based on prevalence of overfitting and bias. In one embodiment, AI System Controller 21 may access Tools Knowledge Base 63 and/or Seed Knowledge Base 61, determine appropriate analytic computation(s), and load appropriate analytic computation(s) into Training Engine 39 to determine if the use of another Ensemble Technique is viable. If Training Engine 39 determines the use of another Ensemble Technique is viable, AI System Controller 21 then instructs Training Engine 39 to initiate Step 415. If Training Engine 39 determines the use of another Ensemble Technique is not viable, AI System Controller 21 instructs Training Engine 39 to halt the method. Other processes may be used to determine if the use of another Ensemble Technique is viable without departing from the spirit and scope of the exemplar method.

In Step 415, AI System Controller 21 or Human Monitor interface 53 initiates a process to create and train New Predictive Model(s)/Policy(s). In one embodiment, AI System Controller 21 may utilize 240 Method to Create a Predictive or Evaluative Model Using a Single Ensemble Technique. AI System Controller 21 may then utilize 270 Method to Train a Predictive or Evaluative Model to train new Models/Policies. In another embodiment, Human Monitor interface 53 may utilize 240 Method to Create a Predictive or Evaluative Model Using a Single Ensemble Technique. Human Monitor interface 53 may then utilize 270 Method to Train a Predictive or Evaluative Model to train new Models/Policies. Other processes may be used to create and train New Predictive Model(s)/Policy(s) without departing from the spirit and scope of the exemplar method.

In Step 416, AI System Controller 21 or Human Monitor interface 53 initiates a process to generate New Predictive Outcomes based on Predictive Policy(s) created in Step 415. In one embodiment, AI System Controller 21 may utilize 290 Method to Utilize Predictive Policies to Generate Predictive Outcomes to generate and store a New Predictive Outcome. In another embodiment, Human Monitor interface 53 may utilize 290 Method to Utilize Predictive Policies to Generate Predictive Outcomes to generate and store a New Predictive Outcome. Other processes may be used to generate New Predictive Outcomes without departing from the spirit and scope of the exemplar method.

In Step 417, AI System Controller 21 or Human Monitor interface 53 initiates a process to validate New Predictive Policy(s). In one embodiment, AI System Controller 21 may utilize 310 Method to Validate Predictive Policies to validate a New Predictive Policy. In another embodiment, Human Monitor interface 53 may utilize 310 Method to Validate Predictive Policies to validate a New Predictive Policy. Other processes may be used to validate a New Predictive Policies without departing from the spirit and scope of the exemplar method.

In Step 418, Training Engine 39 evaluates New Performance Metrics generated in step 417 to old Performance Metrics loaded in Step 413 to determine if a New Predictive Model/Policy(s) generated in Step 415 is superior to predictive performance of Predictive Model/Policy loaded in Step 411. In one embodiment, AI System Controller 21 may access Knowledge Base 62, and load New Performance Metrics and its unique identifier for a New Predictive Model/Policy into Training Engine 39. In this embodiment, Training Engine 39 determines if loaded New Performance Metrics is superior to Performance Metrics loaded in Step 413. In another embodiment, Human Monitor interface 53 may access Knowledge Base 62, and load New Performance Metrics and its unique identifier for a New Predictive Model/Policy into Training Engine 39. In this embodiment, Training Engine 39 evaluates and determines if loaded New Performance Metrics is superior to Performance Metrics loaded in Step 413. Other processes may be used to evaluate New Performance Metrics generated in step 417 to determine if a New Predictive Model/Policy is superior in predictive performance to an older Predictive Model/Policy's predictive performance without departing from the spirit and scope of the exemplar method.

In Step 419, AI System Controller 21 determines if there is a significant improvement of Performance Metrics evaluated in Step 418. Types of Significant Improvement calculations utilized may include but not limited to Chi Square, Degrees of Freedom, T-Tests, etc. In one embodiment, AI System Controller 21 may access Seed Knowledge Base 61 and/or Tools Knowledge Base 63, and load appropriate Significant Difference calculations into Training Engine 39. In this embodiment, Training Engine 39 evaluates and determines if a New Predictive Model/Policy's predictive performance is a significant difference of improvement over a previous older Predictive Model/Policy's predictive performance. If a significant difference of improvement utilizing the New Predictive Model/Policy's predictive performance exists, AI System Controller 21 instructs Training Engine 39 to initiate Step 420. If a significant improvement utilizing the New Predictive Model/Policy's predictive performance does not exist, AI System Controller 21 instructs Training Engine 39 to halt the method. Other processes may be used to determine if a New Predictive Model/Policy predictive performance is a significant difference of improvement over a previous older Predictive Model/Policy's predictive performance without departing from the spirit and scope of the exemplar method.

In Step 420, the Ensemble Technique(s) generated in Step 415 is stored as Revised Ensemble Technique(s) in Knowledge Base 62. In one embodiment, AI System Controller 21 may instruct Training Engine 39 to assign a new unique identifier to Revised Ensemble Technique(s) and store Revised Ensemble Technique(s) and its unique identifier in Knowledge Base 62. In another embodiment, Human Monitor interface 53 may instruct Training Engine 39 to assign a new unique identifier to Revised Ensemble Technique(s) and store Revised Ensemble Technique(s) and its unique identifier in Knowledge Base 62. Other processes may be used to update the Ensemble Technique(s) in Knowledge Base 62 without departing from the spirit and scope of the exemplar method.

In Step 421, the New Predictive Model/Policy generated in Step 415 is stored as the Modified Predictive Model/Policy in Knowledge Base 62. In one embodiment, AI System Controller 21 may instruct Training Engine 39 to assign a unique identifier to Modified Predictive Model/Policy and store Modified Predictive Model/Policy and its unique identifier in Knowledge Base 62. In another embodiment, Human Monitor interface 53 may instruct Training Engine 39 to assign a unique identifier to Modified Predictive Model/Policy and store Modified Predictive Model/Policy and its unique identifier in Knowledge Base 62. Other processes may be used to store Modified Predictive Model/Policy without departing from the spirit and scope of the exemplar method.

In Step 422, New Predictive Outcome(s) generated in Step 416 is stored as the Revised Predictive Outcome in Knowledge Base 62 and/or Predictive Outcome 64. In one embodiment, AI System Controller 21 may instruct Training Engine 39 to assign a unique identifier to Revised Predictive Outcome(s) and store Revised Predictive Outcome(s) and its unique identifier in Knowledge Base 62 and/or Predictive Outcome 64. In another embodiment, Human Monitor interface 53 may instruct Training Engine 39 to assign a unique identifier to Revised Predictive Outcome(s) and store Revised Predictive Outcome(s) and its unique identifier in Knowledge Base 62 and/or Predictive Outcome 64. Other processes may be used to store Revised Predictive Outcome without departing from the spirit and scope of the exemplar method.

In Step 423, New Performance Metrics generated in Step 417 is stored as Revised Performance Metrics in Knowledge Base 62 and/or Performance Metrics 66. In one embodiment, AI System Controller 21 may instruct Training Engine 39 to assign a unique identifier to Revised Performance Metrics and store Revised Performance Metrics and its unique identifier in Knowledge Base 62 and/or Performance Metrics 66. In another embodiment, Human Monitor interface 53 may instruct Training Engine 39 to assign a unique identifier to Revised Performance Metrics and store Revised Performance Metrics and its unique identifier in Knowledge Base 62 and/or Performance Metrics 66. Other processes may be used to store Performance Metrics without departing from the spirit and scope of the exemplar method.

Modifications, additions, or omissions may be made to the Method to Change Predictive Model/Policy by Changing Ensemble Technique(s) without departing from the scope of the method. The method may include more, fewer, or other steps. Additionally, steps may be performed in any suitable order.

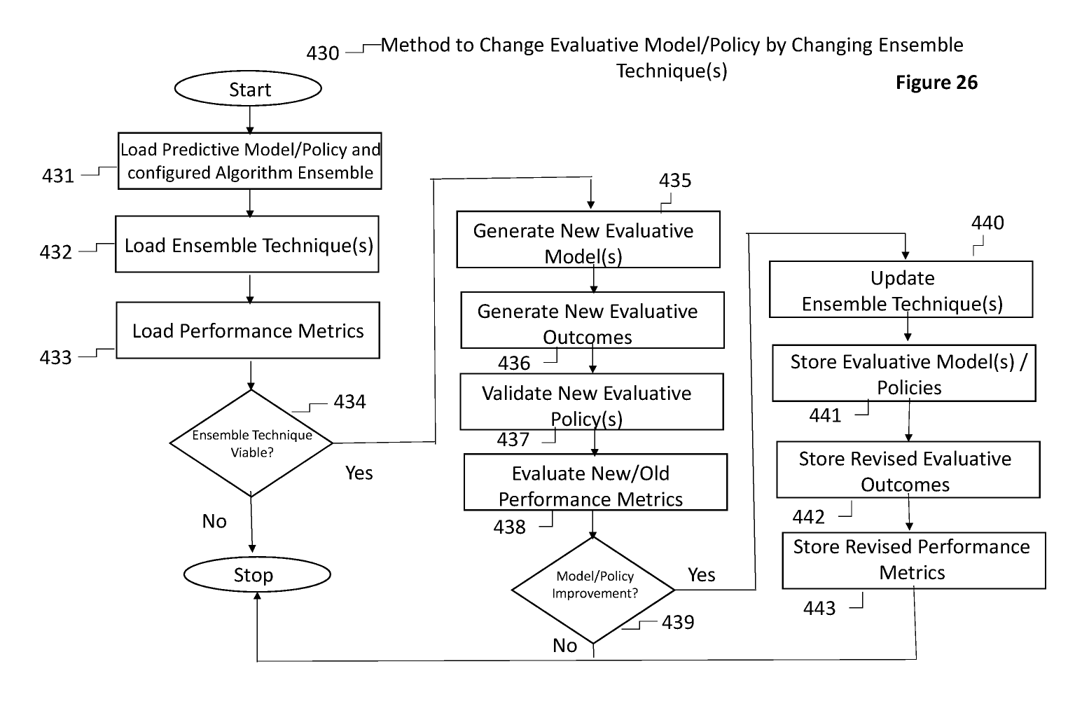

FIG. 26 illustrates one embodiment of AI System Controller 21 and/or Human Monitor interface 53 working in conjunction with Training Engine 39, Seed Knowledge Base 61, Knowledge Base 62, Tools Knowledge Base 63, Evaluative Outcomes 65, and Performance Metrics 66, as exemplary Method 430, Method to Change Evaluative Model/Policy by Changing Ensemble Technique(s). An Ensemble Technique is used to assemble two or more configured Learning Algorithms in a sequence in building an Evaluative Model. The method modifies Evaluative Models/Policies generated in 240 Method to Create a Predictive or Evaluative Model Using a Single Ensemble Technique.

In Step 431, AI System Controller 21 or Human Monitor interface 53 initiates a process to Modify Evaluative Model/Policy by applying new Ensemble Technique(s), and load a single Predictive Model/Policy based on its unique identifier, and associated Evaluative Model/Policy Algorithm Ensemble based on their unique identifiers into Training Engine 39 for processing. In one embodiment, AI System Controller 21 may access Knowledge Base 62, retrieve a single Evaluative Model/Policy based on its unique identifier, and associated Evaluative Model/Policy Algorithm Ensemble based on their unique identifiers, and load a single Evaluative Model/Policy, and Evaluative Model/Policy Algorithm Ensemble used into Training Engine 39 for processing. In another embodiment, Human Monitor interface 53 may access Knowledge Base 62, retrieve a single Evaluative Model/Policy based on its unique identifier, and associated Evaluative Model/Policy Algorithm Ensemble based on their unique identifiers and load a single Evaluative Model/Policy and associated Evaluative Model/Policy Algorithm Ensemble into Training Engine 39 for processing. Other processes may be used to load a single Evaluative Model/Policy and associated Evaluative Model/Policy Algorithm Ensemble into Training Engine 39 without departing from the spirit and scope of the exemplar method.

In Step 432, AI System Controller 21 or Human Monitor interface 53 may load Ensemble Technique(s) based on their unique identifiers associated with Evaluative Model/Policy loaded in Step 431 into Training Engine 39 for processing. In one embodiment, AI System Controller 21 may access Knowledge Base 62, retrieve Ensemble Technique(s) based on their unique identifiers associated with Evaluative Model/Policy loaded in Step 431, and load Ensemble Technique(s) into Training Engine 39 for processing. In another embodiment, Human Monitor interface 53 may access Knowledge Base 62, retrieve Ensemble Technique(s) based on their unique identifiers associated with Evaluative Model/Policy loaded in Step 431, and load Ensemble Technique(s) into Training Engine 39 for processing. Other processes may be used to load Ensemble Technique(s) associated with Predictive Model/Policy loaded in Step 411 into Training Engine 39 without departing from the spirit and scope of the exemplar method.

In Step 433, AI System Controller 21 or Human Monitor interface 53 may load Performance Metrics associated with Evaluative Model/Policy loaded in Step 431 into Training Engine 39 for processing. In one embodiment, AI System Controller 21 may access Knowledge Base 62, retrieve Performance Metrics based on their unique identifiers associated with Evaluative Model/Policy loaded in Step 431, and load Performance Metrics into Training Engine 39 for processing. In another embodiment, Human Monitor interface 53 may access Knowledge Base 62, retrieve Performance Metrics associated with Evaluative Model/Policy loaded in Step 431, and load Performance Metrics into Training Engine 39 for processing. Other processes may be used to load Performance Metrics associated with Predictive Model/Policy loaded in Step 431 into Training Engine 39 without departing from the spirit and scope of the exemplar method.

In Step 434, Training Engine 39 performs analysis on an Ensemble Technique(s) loaded in Step 432 and determines if the use of another Ensemble Technique is viable. In certain embodiments, Training Engine 39 may use various analysis techniques for analyzing an Ensemble Technique including but not limited to direct comparison between ensemble technique performance, trade-off analysis, and/or contextual prioritization based on prevalence of overfitting and bias. In one embodiment, AI System Controller 21 may access Tools Knowledge Base 63 and/or Seed Knowledge Base 61, determine appropriate analytic computation(s), and load appropriate analytic computation(s) into Training Engine 39 to determine if the use of another Ensemble Technique is viable. In certain embodiments, Training Engine 39 may use various analysis techniques for analyzing an Ensemble Technique including but not limited to direct comparison between ensemble technique performance, trade-off analysis, and/or contextual prioritization based on prevalence of overfitting and bias. If Training Engine 39 determines the use of another Ensemble Technique is viable, AI System Controller 21 then instructs Training Engine 39 to initiate Step 435. If Training Engine 39 determines the use of another Ensemble Technique is not viable, AI System Controller 21 instructs Training Engine 39 to halt the method. Other processes may be used to determine if the use of another Ensemble Technique is viable without departing from the spirit and scope of the exemplar method.

In Step 435, AI System Controller 21 or Human Monitor interface 53 initiates a process to create and train New Evaluative Model(s)/Policy(s). In one embodiment, AI System Controller 21 may utilize 240 Method to Create a Predictive or Evaluative Model Using a Single Ensemble Technique. AI System Controller 21 may then utilize 270 Method to Train a Predictive or Evaluative Model to train new Models/Policies. In another embodiment, Human Monitor interface 53 may utilize 240 Method to Create a Predictive or Evaluative Model Using a Single Ensemble Technique. Human Monitor interface 53 may then utilize 270 Method to Train a Predictive or Evaluative Model to train new Models/Policies. Other processes may be used to create and train New Predictive Model(s)/Policy(s) without departing from the spirit and scope of the exemplar method.

In Step 436, AI System Controller 21 or Human Monitor interface 53 initiates a process to generate New Evaluative Outcomes based on Evaluative Policy(s) created in Step 435. In one embodiment, AI System Controller 21 may utilize 300 Method to Utilize Evaluative Policies to Generate Evaluative Outcomes to generate and store New Evaluative Outcomes. In another embodiment, Human Monitor interface 53 may utilize 300 Method to Utilize Evaluative Policies to Generate Evaluative Outcomes to generate and store New Evaluative Outcomes. Other processes may be used to generate New Evaluative Outcomes without departing from the spirit and scope of the exemplar method.

In Step 437, AI System Controller 21 or Human Monitor interface 53 initiates a process to validate New Evaluative Policy(s). In one embodiment, AI System Controller 21 may 320 Method to Validate Evaluative Policies to validate a New Evaluative Policy. In another embodiment, Human Monitor interface 53 may utilize 320 Method to Validate Evaluative Policies to validate a New Evaluative Policy. Other processes may be used to validate a New Evaluative Policies without departing from the spirit and scope of the exemplar method.

In Step 438, Training Engine 39 evaluates New Performance Metrics generated in step 437 to Performance Metrics loaded in Step 433 to determine if a New Evaluative Model/Policy(s) generated in Step 435 is superior to predictive performance of Evaluative Model/Policy loaded in Step 431. In one embodiment, AI System Controller 21 may access Knowledge Base 62, and load New Performance Metrics and its unique identifier for a New Evaluative Model/Policy into Training Engine 39. In this embodiment, Training Engine 39 determines if loaded New Performance Metrics is superior to Performance Metrics loaded in Step 433. In another embodiment, Human Monitor interface 53 may access Knowledge Base 62, and load New Performance Metrics and its unique identifier for a New Evaluative Model/Policy into Training Engine 39. In this embodiment, Training Engine 39 evaluates and determines if loaded New Performance Metrics is superior to Performance Metrics loaded in Step 433. Other processes may be used to evaluate New Performance Metrics generated in step 437 to determine if a New Predictive Model/Policy is superior in predictive performance to an older Predictive Model/Policy's predictive performance without departing from the spirit and scope of the exemplar method.

In Step 439, AI System Controller 21 determines if there is a significant improvement of Performance Metrics evaluated in Step 438. Types of Significant Improvement calculations utilized may include but not limited to Chi Square, Degrees of Freedom, T-Tests, etc. In one embodiment, AI System Controller 21 may access Seed Knowledge Base 61 and/or Tools Knowledge Base 63, and load appropriate Significant Difference calculations into Training Engine 39. In this embodiment, Training Engine 39 evaluates and determines if a New Evaluative Model/Policy's predictive performance is a significant difference of improvement over a previous older Evaluative Model/Policy's predictive performance. If a significant difference of improvement utilizing the New Evaluative Model/Policy's predictive performance exists, AI System Controller 21 instructs Training Engine 39 to initiate Step 440. If a significant improvement utilizing the New Evaluative Model/Policy's predictive performance does not exist, AI System Controller 21 instructs Training Engine 39 to halt the method. Other processes may be used to determine if a New Evaluative Model/Policy predictive performance is a significant difference of improvement over a previous older Evaluative Model/Policy's predictive performance without departing from the spirit and scope of the exemplar method.

In Step 440, the Ensemble Technique(s) generated in Step 435 is stored as Revised Ensemble Technique(s) in Knowledge Base 62. In one embodiment, AI System Controller 21 may instruct Training Engine 39 to assign a new unique identifier to Revised Ensemble Technique(s) and store Revised Ensemble Technique(s) and its unique identifier in Knowledge Base 62. In another embodiment, Human Monitor interface 53 may instruct Training Engine 39 to assign a new unique identifier to Revised Ensemble Technique(s) and store Revised Ensemble Technique(s) and its unique identifier in Knowledge Base 62. Other processes may be used to update the Ensemble Technique(s) in Knowledge Base 62 without departing from the spirit and scope of the exemplar method.

In Step 441, the New Predictive Model/Policy generated in Step 435 is stored as the Modified Evaluative Model/Policy in Knowledge Base 62. In one embodiment, AI System Controller 21 may instruct Training Engine 39 to assign a unique identifier to Modified Evaluative Model/Policy and store Modified Evaluative Model/Policy and its unique identifier in Knowledge Base 62. In another embodiment, Human Monitor interface 53 may instruct Training Engine 39 to assign a unique identifier to Modified Evaluative Model/Policy and store Modified Evaluative Model/Policy and its unique identifier in Knowledge Base 62. Other processes may be used to store Modified Evaluative Model/Policy without departing from the spirit and scope of the exemplar method.

In Step 442, New Evaluative Outcome(s) generated in Step 436 is stored as the Revised Evaluative Outcome in Knowledge Base 62 and/or Evaluative Outcome 65. In one embodiment, AI System Controller 21 may instruct Training Engine 39 to assign a unique identifier to Revised Evaluative Outcome(s) and store Revised Evaluative Outcome(s) and its unique identifier in Knowledge Base 62 and/or Evaluative Outcome 65. In another embodiment, Human Monitor interface 53 may instruct Training Engine 39 to assign a unique identifier to Revised Evaluative Outcome(s) and store Revised Evaluative Outcome(s) and its unique identifier in Knowledge Base 62 and/or Evaluative Outcome 65. Other processes may be used to store Revised Evaluative Outcome without departing from the spirit and scope of the exemplar method.

In Step 443, New Performance Metrics generated in Step 437 is stored as Revised Performance Metrics in Knowledge Base 62 and/or Performance Metrics 66. In one embodiment, AI System Controller 21 may instruct Training Engine 39 to assign a unique identifier to Revised Performance Metrics and store Revised Performance Metrics and its unique identifier in Knowledge Base 62 and/or Performance Metrics 66. In another embodiment, Human Monitor interface 53 may instruct Training Engine 39 to assign a unique identifier to Revised Performance Metrics and store Revised Performance Metrics and its unique identifier in Knowledge Base 62 and/or Performance Metrics 66. Other processes may be used to store Performance Metrics without departing from the spirit and scope of the exemplar method.

Modifications, additions, or omissions may be made to the Method to Change Evaluative Model/Policy by Changing Ensemble Technique(s) without departing from the scope of the method. The method may include more, fewer, or other steps. Additionally, steps may be performed in any suitable order.

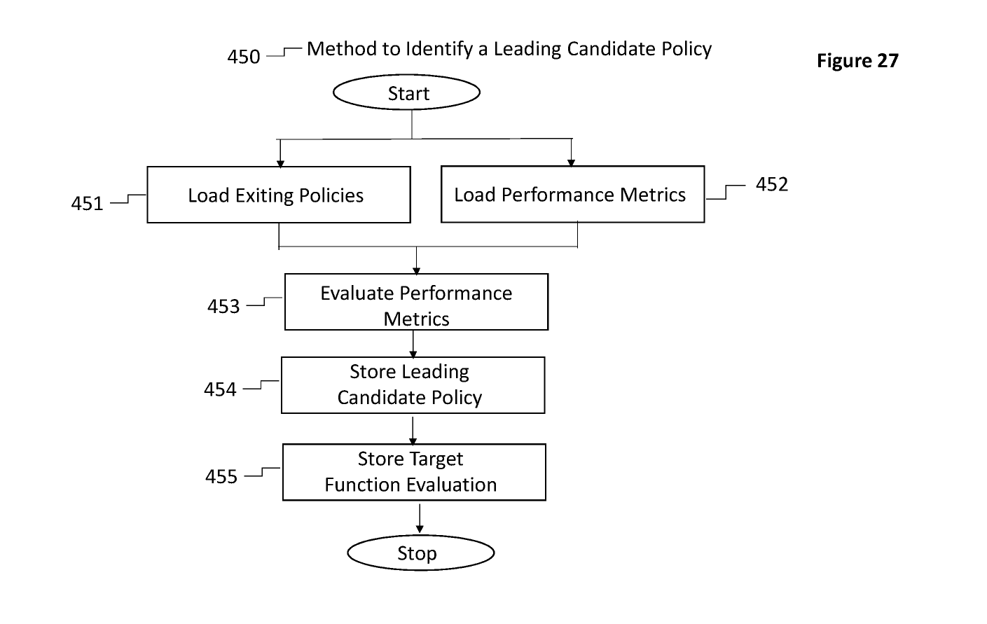

FIG. 27 illustrates one embodiment of AI System Controller 21 and/or Human Monitor interface 53 working in conjunction with Validation Engine 38, Knowledge Base 62, and Performance Metrics 66, as exemplary Method 450, Method to Identify a Leading Candidate Policy. A Leading Candidate Policy is a Predictive Policy or an Evaluative Policy that corresponds to the best overall predictive performance. A Leading Candidate Policy may be utilized by 460 Method to Perform Training Refinement, or 470 Method to Optimize a Policy.

In Step 451, AI System Controller 21 or Human Monitor interface 53 initiates a process to identify a Leading Candidate Policy by evaluating Performance Metric(s) and/or Revised Performance Metrics for an identified set of existing Policies and/or Modified Policies, and load an identified set of existing Policies and/or Modified Policies into Validation Engine 38 for processing. In one embodiment, AI System Controller 21 may access Knowledge Base 62, retrieve an identified set of existing Policies and/or Modified Policies based on their unique identifiers, and load the identified set of Policies and/or Modified Policies into Validation Engine 38 for processing. In another embodiment, Human Monitor interface 53 may access Knowledge Base 62, retrieve an identified set of existing Policies, based on their unique identifiers, and load the identified set of Policies and/or Modified Policies into Validation Engine 38 for processing. Other processes may be used to load an identified set of Policies and/or Modified Policies into Validation Engine 38 without departing from the spirit and scope of the exemplar method.

In Step 452, AI System Controller 21 or Human Monitor interface 53 may load Performance Metric(s) and/or Revised Performance Metrics based on their unique identifiers for Policies and/or Modified Policies loaded in Step 451 into Validation Engine 38. In one embodiment, AI System Controller 21 may access Performance Metrics 66, retrieve Performance Metric(s) and/or Revised Performance Metrics based on their unique identifiers for Policies and/or Modified Policies loaded in Step 451, and load Performance Metric(s) and/or Revised Performance Metrics into Validation Engine 38 for processing. In another embodiment, Human Monitor interface 53 may access Performance Metrics 66, retrieve Performance Metric(s) and/or Revised Performance Metrics based on their unique identifiers for Policies and/or Modified Policies loaded in Step 451, and load Performance Metric(s) and/or Revised Performance Metrics into Validation Engine 38 for processing. Other processes may be used to load Performance Metric(s) and/or Revised Performance Metrics for Policies and/or Modified Policies loaded in Step 451 into Validation Engine 38 without departing from the spirit and scope of the exemplar method.

In Step 453, Validation Engine 38 evaluates Performance Metric(s) and/or Revised Performance Metrics loaded in Step 452 to determine a Leading Candidate Policy. The Policy or Modified Policy with superior Performance Metric(s) is identified as a Leading Candidate Policy. In some embodiments, superior performance is defined as having the highest value among all Policies or Modified Policies, such as when measuring accuracy. In other embodiments, superior performance is defined as having the lowest value among all Policies or Modified Policies, such as when measuring mean-squared error. Validation Engine 38 assigns a unique identifier to the identified Leading Candidate Policy. Other processes may be used to determine a Leading Candidate Policy without departing from the spirit and scope of the exemplar method.

In Step 454, the identified Leading Candidate Policy is stored in Knowledge Base 62. In one embodiment, AI System Controller 21 may instruct Validation Engine 38 to store the identified Leading Candidate Policy and its unique identifier in Knowledge Base 62. In another embodiment, Human Monitor interface 53 may instruct Validation Engine 38 to store the identified Leading Candidate Policy and its unique identifier in Knowledge Base 62. Other processes may be used to store the identified Leading Candidate Policy without departing from the spirit and scope of the exemplar method.

In Step 455, Performance Metrics for the identified Leading Candidate Policy is stored as Target Function Evaluation in Knowledge Base 62 and/or Performance Metrics 66. In one embodiment, AI System Controller 21 may instruct Validation Engine 38 to identify Performance Metrics associated with a Leading Candidate Policy as Target Function Evaluation, assign Target Function Evaluation a unique Identifier, and store Target Function Evaluation and its unique identifier in Knowledge Base 62 and/or Performance Metrics 66. In another embodiment, Human Monitor interface 53 may instruct Validation Engine 38 to identify Performance Metrics associated with a Leading Candidate Policy as Target Function Evaluation, assign Target Function Evaluation a unique Identifier, and store Target Function Evaluation in Knowledge Base 62 and/or Performance Metrics 66. Other processes may be used to store Target Function Evaluation without departing from the spirit and scope of the exemplar method.

Modifications, additions, or omissions may be made to the Method to Identify a Leading Candidate Policy without departing from the scope of the method. The method may include more, fewer, or other steps. Additionally, steps may be performed in any suitable order.

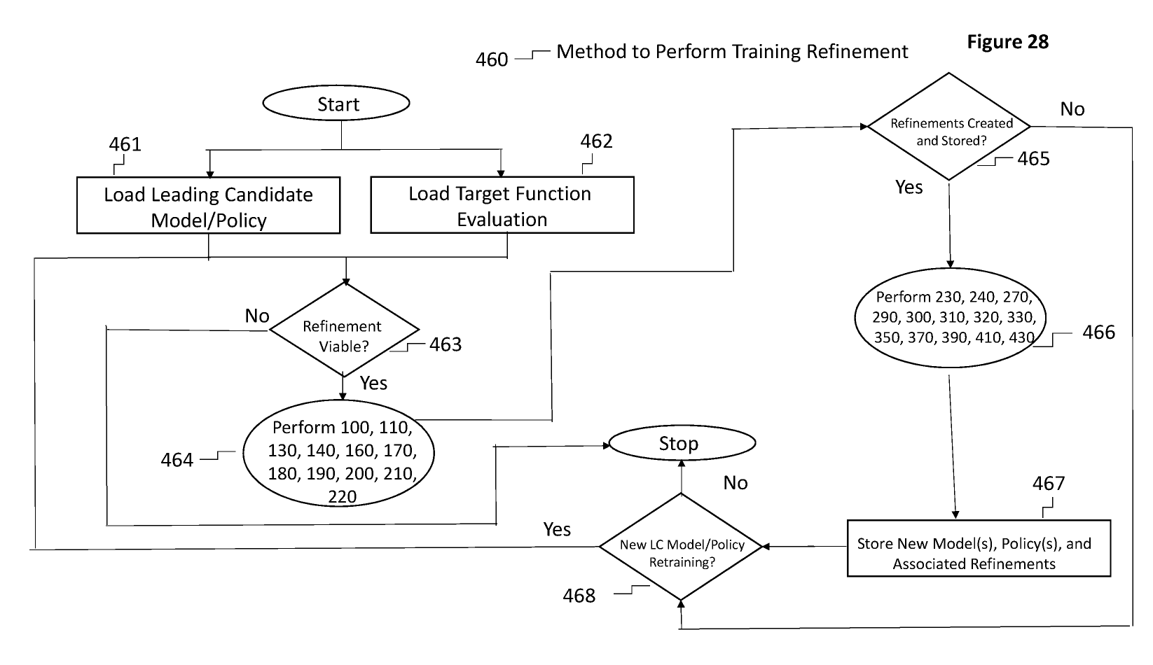

FIG. 28 illustrates one embodiment of AI System Controller 21 and/or Human Monitor interface 53 working in conjunction with Training Engine 39, Seed Knowledge Base 61, Knowledge Base 62, Tools Knowledge Base 63, and Performance Metrics 66, as exemplary Method 460, Method to Perform Training Refinement. Training refinement involves making changes to the existing model composition/configuration to create new Predictive and/or Evaluative Models and Policies. Predictive and/or Evaluative Models and Policies built with refinements may be utilized by 450 Method to Identify a Leading Candidate Policy.

In Step 461, AI System Controller 21 or Human Monitor interface 53 initiates a process to Perform Training Refinement, and load a Leading Candidate Model/Policy into Training Engine 39 for processing. In one embodiment, AI System Controller 21 may access Knowledge Base 62, retrieve a Leading Candidate Model/Policy based on its unique identifier and load a Leading Candidate Model/Policy into Training Engine 39 for processing. In another embodiment, Human Monitor interface 53 may access Knowledge Base 62, retrieve a Leading Candidate Model/Policy based on its unique identifier and load a Leading Candidate Model/Policy into Training Engine 39 for processing. Other processes may be used to load a Leading Candidate Model/Policy into Training Engine 39 without departing from the spirit and scope of the exemplar method.

In Step 462, AI System Controller 21 or Human Monitor interface 53 may load Target Function Evaluation associated with Leading Candidate Model/Policy loaded in Step 461 into Training Engine 39 for processing. In one embodiment, AI System Controller 21 may access Knowledge Base 62 or Performance Metrics 66, retrieve Target Function Evaluation based on its unique identifier associated with Leading Candidate Model/Policy loaded in Step 461, and load Target Function Evaluation into Training Engine 39 for processing. In another embodiment, Human Monitor interface 53 may access Knowledge Base 62 or Performance Metrics 88, retrieve Target Function Evaluation based on its unique identifier associated with associated with Leading Candidate Model/Policy loaded in Step 461, and load Target Function Evaluation into Training Engine 39 for processing. Other processes may be used to load Target Function Evaluation associated with Leading Candidate Model/Policy loaded in Step 461 into Training Engine 39 without departing from the spirit and scope of the exemplar method.

In Step 463, Training Engine 39 performs analysis on a Target Function Evaluation loaded in Step 462 and determines if Training Refinement is viable. In certain embodiments, Training Engine 39 may use various analysis techniques for analyzing a Target Function Evaluation including but not limited to computations such as mean-squared error, candidate revisit amount, deviation residual, and/or iteration cap. In one embodiment, AI System Controller 21 may access Tools Knowledge Base 63 and/or Seed Knowledge Base 61, determine appropriate analytic computation(s), and provide appropriate analytic computation(s) to Training Engine 39 to determine if Training Refinement is viable. If Training Engine 39 determines Training Refinement is viable, AI System Controller 21 instructs Training Engine 39 to initiate Step 464. If Training Engine 39 determines Training Refinement is not viable, AI System Controller 21 instructs Training Engine 39 to halt the method. Other processes may be used to determine if Training Refinement is viable without departing from the spirit and scope of the exemplar method.

In Step 464, AI System Controller 21 or Human Monitor interface 53 initiates a process to make refinements needed to create New Predictive and/or Evaluative Model(s)/Policy(s). In one embodiment, AI System Controller 21 may utilize 100 Method to Perform Structured Data Analysis, 110 Method to Perform Unstructured Data Analysis, 130 Method to Determine Non-Feature Data, 140 Method to Expand Raw Feature Space, and 160 Method to Compute Derived Feature Values from Unstructured Feature Values, to create/modify and store a Refined Feature Space, Refined Feature Generation Ruleset(s), Refined Feature Derivation Ruleset(s), Refined Transformation Ruleset(s), and a Refined Master Rule Set. In another embodiment, AI System Controller 21 may utilize 170 Method to Determine Initial Feature Set to create/modify and store a Refined Feature Set, Refined Feature Selection Ruleset(s), and the Refined Master Rule Set. In another embodiment, AI System Controller 21 may utilize 180 Method to Determine Feature Vectors to create/modify and store Refined Feature Vectors. In another embodiment, AI System Controller 21 may utilize 190 Method to Align Feature Vectors with Prediction Classes to align Feature Vectors with Prediction Classes, create/modify and store a Refined Mapping Ruleset and the Refined Master Rule Set. In another embodiment, AI System Controller 21 may utilize 200 Method to Create Initial Data Points From a Single Feature Vector and 210 Method to Create Initial Data Points From Multiple Aligned Feature Vectors to create/modify and store Refined Data Points, Refined Aggregation Ruleset(s), and the Refined Master Rule Set. In another embodiment, AI System Controller 21 may utilize 220 Method to Create Initial Data Point Structure(s) to create/modify and store Refined Data Point Structure(s), Refined Data Point Structure Ruleset(s), and the Refined Master Rule Set. In yet another embodiment, Human Monitor interface 53 may utilize 100 Method to Perform Structured Data Analysis, 110 Method to Perform Unstructured Data Analysis, 130 Method to Determine Non-Feature Data, 140 Method to Expand Raw Feature Space, and 160 Compute Derived Feature Values from Unstructured Feature Values to create/modify and store a Refined Feature Space, Refined Feature Generation Ruleset(s), Refined Feature Derivation Ruleset(s), Refined Transformation Ruleset(s), and a Refined Master Rule Set. In another embodiment, Human Monitor interface 53 may utilize 170 Method to Determine Initial Feature Set to create/modify and store a Refined Feature Set, Refined Feature Selection Ruleset(s), and the Refined Master Rule Set. In another embodiment, Human Monitor interface 53 may utilize 180 Method to Determine Feature Vectors to create/modify and store Refined Feature Vectors. In another embodiment, Human Monitor interface 53 may utilize 190 Method to Align Feature Vectors with Prediction Classes to align Feature Vectors with Prediction Classes, create/modify and store a Refined Mapping Ruleset and the Refined Master Rule Set. In another embodiment, Human Monitor interface 53 may utilize 200 Method to Create Initial Data Points From a Single Feature Vector and 210 Method to Create Initial Data Points From Multiple Aligned Feature Vectors to create/modify and store Refined Data Points, Refined Aggregation Ruleset(s), and the Refined Master Rule Set. In another embodiment, Human Monitor interface 53 may utilize 220 Method to Create Initial Data Point Structure(s) to create/modify and store Refined Data Point Structure(s), Refined Data Point Structure Ruleset(s), and the Refined Master Rule Set. Other processes may be used to make refinements needed to create New Predictive and/or Evaluative Model(s)/Policy(s) without departing from the spirit and scope of the exemplar method. Processes may be used in any order determined by AI Controller 21 or Human Monitor interface 53 without departing from the spirit or scope of the exemplar method.

In Step 465, AI System Controller 21 determines if refinements were made and stored in Step 464. If refinements were made and stored in Step 464, AI System Controller 21 instructs Training Engine 39 to initiate Step 466. If refinements were not made and stored in Step 464, AI System Controller 21, instructs Training Engine 39 to initiate Step 468. Other processes may be used to determine if refinements were made and stored in Step 464 without departing from the spirit and scope of the exemplar method.

In Step 466, AI System Controller 21 or Human Monitor interface 53 initiates a process to potentially refine a Predictive and/or Evaluative Model/Policy. In one embodiment, AI System Controller 21 may utilize 230 Method to Create a Predictive or Evaluative Model Using a Single Learning Algorithm, to create and store a New Predictive or Evaluative Model based on the use of Initial or Refined inputs. In another embodiment, AI System Controller 21 may utilize 240 Method to Create a Predictive or Evaluative Model Using a Single Ensemble Technique, to create and store a New Predictive or Evaluative Model based on the use of Initial or Refined inputs. In another embodiment, AI System Controller 21 may utilize 270 Method to Train a Predictive or Evaluative Model to train a New Predictive or Evaluative Model based on Initial or Refined inputs and store a New Predictive or Evaluative Policy. In another embodiment, AI System Controller 21 may utilize 290 Method to Utilize Predictive Policies to Generate Predictive Outcomes to generate and store Refined Predictive Outcomes based on Initial or Refined inputs. In another embodiment, AI System Controller 21 may utilize 300 Method to Utilize Evaluative Policies to Generate Evaluative Outcomes to generate and store Refined Evaluative Outcomes based on Initial or Refined inputs. In another embodiment, AI System Controller 21 may utilize 310 Method to Validate Predictive Policies to validate Predictive Policy(s) based on Initial or Refined inputs, and store New Performance Metrics and associated Metric Reports. In another embodiment, AI System Controller 21 may utilize 320 Method to Validate Evaluative Policies to validate Evaluative Policy(s) based on Initial or Refined inputs, and store New Performance Metrics and associated Metric Reports. In another embodiment, AI System Controller 21 may utilize 330 Method to Modify Predictive Model/Policy Learning Algorithm(s) Based on Alteration of Hyperparameters to modify a Predictive Model/Policy based on Initial or Refined inputs, and store revised outputs. In another embodiment, AI System Controller 21 may utilize 350 Method to Modify Evaluative Model/Policy Learning Algorithm(s) Based on Alteration of Hyperparameters to modify an Evaluative Model/Policy based on Initial or Refined inputs, and store revised outputs. In another embodiment, AI System Controller 21 may utilize 370 Method to Change Predictive Model by Adding/Deleting Learning Algorithm(s) to modify a Predictive Model/Policy based on Initial or Refined inputs, and store revised outputs. In another embodiment, AI System Controller 21 may utilize 390 Method to Change Evaluative Model by Adding/Deleting Learning Algorithm(s) to modify an Evaluative Model/Policy based on Initial or Refined inputs, and store revised outputs. In another embodiment, AI System Controller 21 may utilize 410 Method to Change Predictive Model/Policy by Changing Ensemble Technique(s) to modify a Predictive Model/Policy based on Initial or Refined inputs, and store revised outputs. In another embodiment, AI System Controller 21 may utilize 430 Method to Change Evaluative Model/Policy by Changing Ensemble Technique(s) to modify a Evaluative Model/Policy based on Initial or Refined inputs, and store revised outputs. In yet another embodiment, Human Monitor interface 53 may utilize 230 Method to Create a Predictive or Evaluative Model Using a Single Learning Algorithm, to create and store a New Predictive or Evaluative Model based on the use of Initial or Refined inputs. In another embodiment, Human Monitor interface 53 may utilize 240 Method to Create a Predictive or Evaluative Model Using a Single Ensemble Technique, to create and store a New Predictive or Evaluative Model based on the use of Initial or Refined inputs. In another embodiment, Human Monitor interface 53 may utilize 270 Method to Train a Predictive or Evaluative Model to train a New Predictive or Evaluative Model based on Initial or Refined inputs and store a New Predictive or Evaluative Policy. In another embodiment, Human Monitor interface 53 may utilize 290 Method to Utilize Predictive Policies to Generate Predictive Outcomes to generate and store Refined Predictive Outcomes based on Initial or Refined inputs. In another embodiment, Human Monitor interface 53 may utilize 300 Method to Utilize Evaluative Policies to Generate Evaluative Outcomes to generate and store Refined Evaluative Outcomes based on Initial or Refined inputs. In another embodiment, Human Monitor interface 53 may utilize 310 Method to Validate Predictive Policies to validate Predictive Policy(s) based on Initial or Refined inputs, and store New Performance Metrics and associated Metric Reports. In another embodiment, Human Monitor interface 53 may utilize 320 Method to Validate Evaluative Policies to validate Evaluative Policy(s) based on Initial or Refined inputs, and store New Performance Metrics and associated Metric Reports. In another embodiment, Human Monitor interface 53 may utilize 330 Method to Modify Predictive Model/Policy Learning Algorithm(s) Based on Alteration of Hyperparameters to modify a Predictive Model/Policy based on Initial or Refined inputs, and store revised outputs. In another embodiment, Human Monitor interface 53 may utilize 350 Method to Modify Evaluative Model/Policy Learning Algorithm(s) Based on Alteration of Hyperparameters to modify an Evaluative Model/Policy based on Initial or Refined inputs, and store revised outputs. In another embodiment, Human Monitor interface 53 may utilize 370 Method to Change Predictive Model/Policy by Adding/Deleting Learning Algorithm(s) to modify a Predictive Model/Policy based on Initial or Refined inputs, and store revised outputs. In another embodiment, Human Monitor interface 53 may utilize 390 Method to Change Evaluative Model/Policy by Adding/Deleting Learning Algorithm(s) to modify an Evaluative Model/Policy based on Initial or Refined inputs, and store revised outputs. In another embodiment, Human Monitor interface 53 may utilize 410 Method to Change Predictive Model/Policy by Changing Ensemble Technique(s) to modify a Predictive Model/Policy based on Initial or Refined inputs, and store revised outputs. In another embodiment, Human Monitor interface 53 may utilize 430 Method to Change Evaluative Model/Policy by Changing Ensemble Technique(s) to modify an Evaluative Model/Policy based on Initial or Refined inputs, and store revised outputs. Other processes may be used to refine a Predictive and/or Evaluative Model/Policy without departing from the spirit and scope of the exemplar method. Processes may be used in any order determined by AI Controller 21 or Human Monitor interface 53 without departing from the spirit or scope of the exemplar method.

In Step 467, Refined Predictive or Evaluative Model(s) Policy(s), and associated Training Refinements are stored in Knowledge Base 62 for future use. In one embodiment, AI System Controller 21 may instruct Training Engine 39 to assign a unique identifier to Refined Predictive or Evaluative Model(s) Policy(s) created in Step 466. In this embodiment, AI System Controller 21 may instruct Training Engine 39 to assign a unique identifier to Training Refinements determined in Step 464. In this embodiment, AI System Controller 21 may instruct Training Engine 39 to update Knowledge Base 62 with Refined Predictive or Evaluative Model(s) Policy(s) and associated Training Refinements, and their unique identifiers. In another embodiment, Human Monitor interface 53 may instruct Training Engine 39 to assign a unique identifier to Refined Predictive or Evaluative Model(s) Policy(s) created in Step 466. In this embodiment, Human Monitor interface 53 may instruct Training Engine 39 to assign a unique identifier to Training Refinements determined in Step 464. In this embodiment, Human Monitor interface 53 may instruct Training Engine 39 to update Knowledge Base 62 with Refined Predictive or Evaluative Model(s) Policy(s) and associated Training Refinements, and their unique identifiers. Other processes may be used to update Knowledge Base 62 with Refined Model(s) Policy(s), and associated Training Refinements without departing from the spirit and scope of the exemplar method.

In Step 468, AI System Controller 21 determines if Training Refinement should continue. If AI System Controller 21 determines Training Refinement should continue, AI System Controller 21 instructs Training Engine 39 to initiate Step 463. If AI System Controller 21 determines Training Refinement should not continue, AI System Controller 21 instructs Training Engine 39 to halt the method. Other processes may be used to determine if Training Refinement should continue without departing from the spirit and scope of the exemplar method.

Modifications, additions, or omissions may be made to the Method to Perform Training Refinement without departing from the scope of the method. The method may include more, fewer, or other steps. Additionally, steps may be performed in any suitable order.

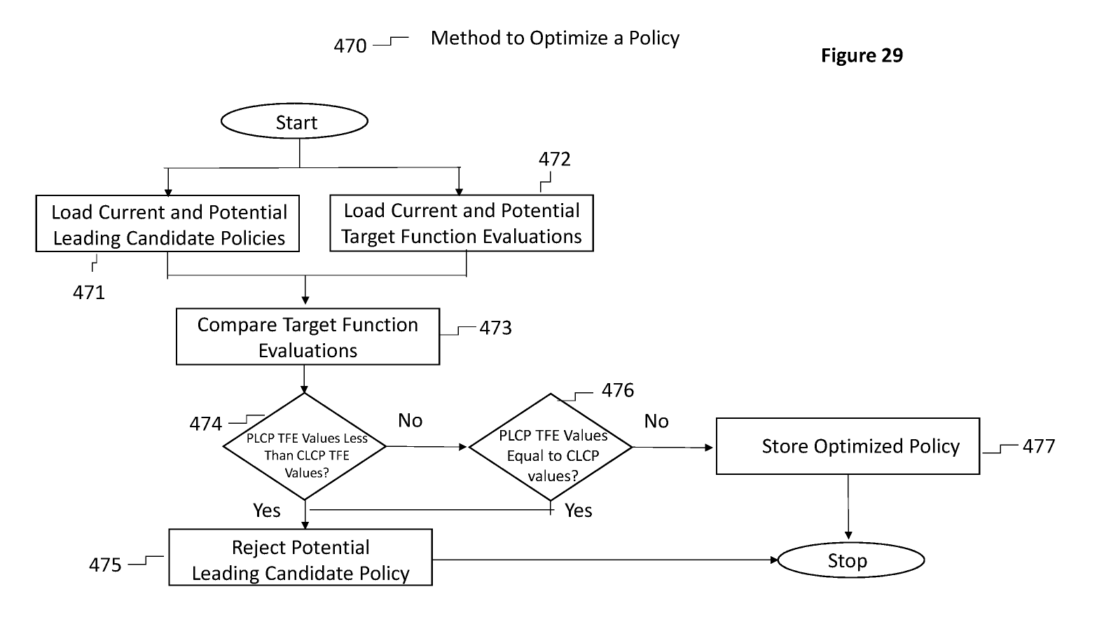

FIG. 29 illustrates one embodiment of AI System Controller 21 and/or Human Monitor interface 53 working in conjunction with Validation Engine 38, Performance Metrics 66, and Knowledge Base 62 as exemplary Method 470, Method to Optimize a Policy. An Optimized Policy is a Predictive or Evaluative Policy that best fits customer data in making predictions of identified Business Outcomes. Optimized Policies may be utilized by 480 Method to Implement a Predictive Policy, or 490 Method to Implement an Evaluative Policy.

In Step 471, AI System Controller 21 or Human Monitor interface 53 initiates a process to determine an Optimize Policy, and load Current and Potential Predictive or Evaluative Leading Candidate Policies. In one embodiment, AI System Controller 21 may access Knowledge Base 62, retrieve Current and Potential Predictive or Evaluative Leading Candidate Policies based on their unique identifiers, and load Current and Potential Predictive or Evaluative Leading Candidate Policies into Validation Engine 38 for processing. In another embodiment, Human Monitor interface 53 may access Knowledge Base 62, retrieve Current and Potential Predictive or Evaluative Leading Candidate Policies based on their unique identifiers, and load Current and Potential Predictive or Evaluative Leading Candidate Policies into Validation Engine 38 for processing. Other processes may be used to load Current and Potential Predictive or Evaluative Leading Candidate Policies into Validation Engine 38 for processing without departing from the spirit and scope of the exemplar method.

In Step 472, AI System Controller 21 or Human Monitor interface 53 may load Current and Potential Target Function Evaluations associated with Current and Potential Leading Candidate Policies loaded in Step 471, based on their unique identifiers. In one embodiment, AI System Controller 21 may access Knowledge Base 62, retrieve Current and Potential Target Function Evaluations associated with Current and Potential Leading Candidate Policies loaded in Step 471 based on their unique identifiers and load Current and Potential Target Function Evaluations into Validation Engine 38 for processing. In another embodiment, AI System Controller 21 may access Knowledge Base 62, retrieve Current and Potential Target Function Evaluations associated with Current and Potential Leading Candidate Policies loaded in Step 471 based on their unique identifiers and load Current and Potential Target Function Evaluations into Validation Engine 38 for processing. Examples of Target Functions include precision, recall, mean-squared error, R², etc. Other processes may be used to load Current and Potential Target Function Evaluations into Validation Engine 38 without departing from the spirit and scope of the exemplar method.

In Step 473, AI System Controller 21 or Human Monitor interface 53 may compare Current Target Function Evaluation values and Potential Target Function Evaluation values loaded in Step 472. In one embodiment, AI System Controller 21 may instruct Validation Engine 38 to compare Current Target Function Evaluation values and Potential Target Function Evaluation values loaded in Step 472. In another embodiment, Human Monitor interface 53 may instruct Validation Engine 38 to compare Current Target Function Evaluation values loaded in Step 471 and Potential Target Function Evaluation values loaded in Step 472. Comparison of Current Target Function Evaluation values and Potential Target Function Evaluation values is accomplished by determining if Potential Target Function Evaluation values are less than, greater than, or equal to Current Target Function Evaluation values. Other processes may be used to compare Current Target Function Evaluation values and Potential Target Function Evaluation values without departing from the spirit and scope of the exemplar method.

In Step 474, AI System Controller 21 determines if Potential Target Function Evaluation are superior to Current Target Function Evaluation values compared in Step 473. If Potential Target Function Evaluation values are less than Current Target Function Evaluation values, AI System Controller 21 instructs Validation Engine 38 to initiate Step 475. If Potential Target Function Evaluation values are greater than or equal to Current Target Function Evaluation values, AI System Controller 21 instructs Validation Engine 38 to initiate Step 476. Other processes may be used to determine if Potential Target Function Evaluation values are superior to Current Target Function Evaluation values without departing from the spirit and scope of the exemplar method.

In Step 475, AI System Controller or Human Monitor interface 53 may reject Potential Leading Candidate Policy as an Optimized Policy and remove from Knowledge Base 62. In one embodiment, if Potential Leading Candidate Policy's Target Function Evaluation values are less than or equal to Current Leading Candidate Policy's Target Function Evaluation values, AI System Controller 21 may reject Potential Leading Candidate Policy as an Optimized Policy and may instruct Validation Engine 38 to remove Potential Leading Candidate Policy from Knowledge Base 62, and associated Target Function Evaluation from Performance Metrics 66. In another embodiment, if Potential Leading Candidate Policy's Target Function Evaluation values are less than or equal to Current Leading Candidate Policy's Target Function Evaluation values, Human Monitor interface 53 may reject Potential Leading Candidate Policy as an Optimized Policy and may instruct Validation Engine 38 to remove Potential Leading Candidate Policy from Knowledge Base 62, and associated Target Function Evaluation from Performance Metrics 66. Other processes may be used to reject Potential Leading Candidate Policy as an Optimized Policy and remove from Knowledge Base 62 without departing from the spirit and scope of the exemplar method.

In Step 476, AI System Controller 21 determines if Potential Target Function Evaluation values are equal to Current Target Function Evaluation values. If Potential Target Function Evaluation values are equal to Current Target Function Evaluation values, AI System Controller 21 instructs Validation Engine 38 to initiate Step 475. If Potential Target Function Evaluation values are not equal to Current Target Function Evaluation values, AI System Controller 21 instructs Validation Engine 38 to initiate Step 477. Other processes may be used to 21 determine if Potential Target Function Evaluation values are equal to Current Target Function Evaluation values without departing from the spirit and scope of the exemplar method.

In Step 477, AI System Controller or Human Monitor interface 53 may store Potential Leading Candidate Policy as an Optimized Policy, and associated Current Target Function Evaluation as an Optimized Target Function Evaluation. In one embodiment, AI System Controller 21 may instruct Validation Engine 38 to assign a unique identifier to the Optimized Policy, and store Optimized Policy in Knowledge Base 62. In this embodiment, AI System Controller 21 may instruct Validation Engine 38 to assign a unique identifier to the Optimized Target Function Evaluation, and store Optimized Target Function Evaluation in Performance Metrics 66. In another embodiment, Human Monitor interface 53 may instruct Validation Engine 38 to assign a unique identifier to the Optimized Policy, and store Optimized Policy in Knowledge Base 62. In this embodiment, Human Monitor interface 53 may instruct Validation Engine 38 to assign a unique identifier to the Optimized Target Function Evaluation, and store Optimized Target Function Evaluation in Performance Metrics 66. Other processes may be used to store Potential Leading Candidate Policy as an Optimized Policy and associated Current Target Function Evaluation as an Optimized Target Function Evaluation without departing from the spirit and scope of the exemplar method.

Modifications, additions, or omissions may be made to the Method to Optimize a Policy without departing from the scope of the method. The method may include more, fewer, or other steps. Additionally, steps may be performed in any suitable order.

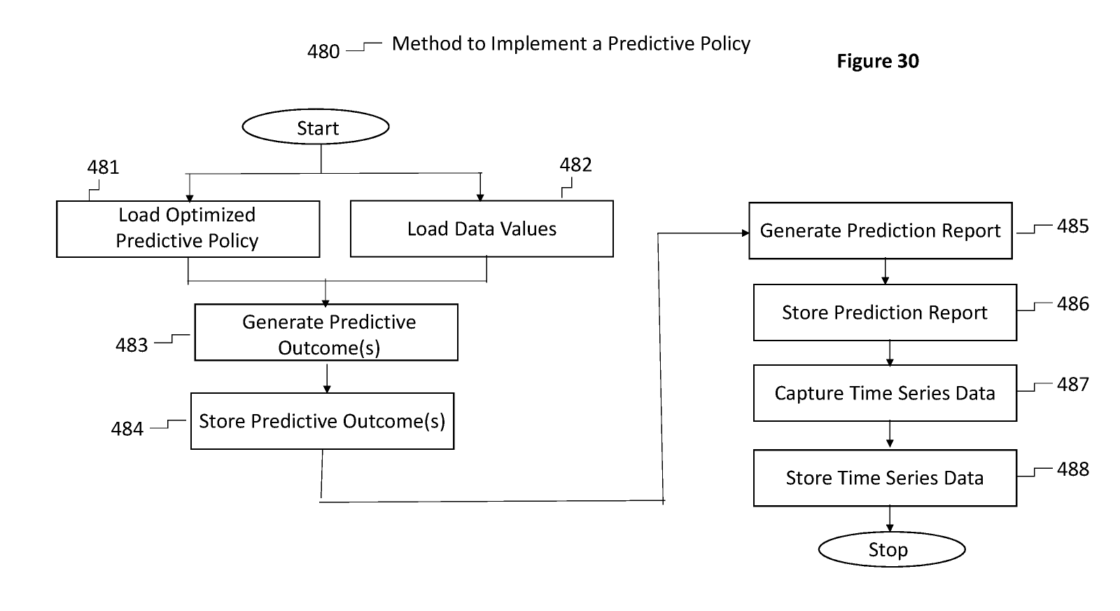

FIG. 30 illustrates one embodiment of AI System Controller 21 and/or Human Monitor interface 53 working in conjunction with Implementation Engine 40, Knowledge Base 62, Predictive Outcomes 64, Client Database 51, Dialer/DB 52, Prediction Report 67, and Time Series Data 70 as exemplary Method 480, Method to Implement a Predictive Policy.

In Step 481, AI System Controller 21 or Human Monitor interface 53 initiates a process to implement an Optimized Predictive Policy into a customer's system, and load an Optimized Predictive Policy generated in 470 Method to Optimize a Policy into Implementation Engine 40 for processing. In one embodiment, AI System Controller 21 may access Knowledge Base 62, retrieve an Optimized Predictive Policy based on its unique identifier, and load the Optimized Predictive Policy into Implementation Engine 40 for processing. In another embodiment, Human Monitor interface 53 may access Knowledge Base 62, retrieve an Optimized Predictive Policy based on its unique identifier, and load the Optimized Predictive Policy into Implementation Engine 40 for processing. Other processes may be used to load an Optimized Predictive Policy into Implementation Engine 40 for processing without departing from the spirit and scope of the exemplar method.

In Step 482, AI System Controller 21 or Human Monitor interface 53 may load New Data Values for Structured and Unstructured Data for the Optimized Predictive Policy loaded in Step 481 into Implementation Engine 40. New Data Values for Structured and Unstructured Data are data not processed and utilized previously. In one embodiment, AI System Controller 21 may access Knowledge Base 62, retrieve New Data Values for Structured and Unstructured Data for the Optimized Predictive Policy loaded in Step 481, and load New Data Values for Structured and Unstructured Data into Implementation Engine 40 for processing. In another embodiment, Human Monitor interface 53 may access Knowledge Base 62, retrieve New Data Values for Structured and Unstructured Data for the Optimized Predictive Policy loaded in Step 481, and load New Data Values for Structured and Unstructured Data into Implementation Engine 40 for processing. Other processes may be used to load New Data Values for Structured and Unstructured Data for the Optimized Predictive Policy loaded in Step 481 into Implementation Engine 40 without departing from the spirit and scope of the exemplar method.

In Step 483, Implementation Engine 40 generates Predictive Outcome(s). In one embodiment, utilizing New Data Values loaded in Step 482, Implementation Engine 40 may utilize 290 Method to Utilize Predictive Policies to Generate Predictive Outcomes. In Method 290, Predictive Policy input is replaced with an Optimized Predictive Policy loaded in Step 481. Other processes may be used to generate Predictive Outcome(s) without departing from the spirit and scope of the exemplar method.

In Step 484, Predictive Outcome(s) generated in Step 483 is stored in Knowledge Base 62 and Predictive Outcomes 64. In one embodiment, AI System Controller 21 may instruct Implementation Engine 40 to assign a unique identifier to Predictive Outcome(s) generated in Step 483 and store Predictive Outcome(s) and its unique identifier in Knowledge Base 62 and Predictive Outcomes 64. In another embodiment, Human Monitor interface 53 may instruct Implementation Engine 40 to assign a unique identifier to Predictive Outcome(s) generated in Step 483 and store Predictive Outcome(s) and its unique identifier in Knowledge Base 62 and Predictive Outcomes 64. Other processes may be used to store Predictive Outcome(s) without departing from the spirit and scope of the exemplar method.

In Step 485, Implementation Engine 40 generates a Prediction Report. Prediction Reports may include but are not limited to a database table containing ranked predictions of entities to contact for sales, collection of debts, etc., a tabular text file containing ranked predictions of entities to contact for sales, collection of debts and so forth of a Call Center's dialing system with information on who to contact for sales, collection of debts, etc. In one embodiment, Implementation Engine 40 utilizes Prediction Outcome(s) generated in Step 483 to generate a Prediction Report and assign it a unique identifier. In this embodiment, AI System Controller 21 may send Prediction Report to Human Monitor interface 53, and/or Client Database 51, and/or Dialer/DB 52. Other processes may be used to generate a Prediction Report without departing from the spirit and scope of the exemplar method.

In Step 486, Prediction Report and its unique identifier is stored in Prediction Report 67. In one embodiment, AI System Controller 21 may instruct Implementation Engine 40 to store Prediction Report and its unique identifier in Prediction Report 67. In another embodiment, Human Monitor interface 53 may instruct Implementation Engine 40 to store Prediction Report and its unique identifier in Prediction Report 67. Other processes may be used to store Prediction Report without departing from the spirit and scope of the exemplar method.

In Step 487, AI Controller may capture Time Series Data for a Prediction Report generated in Step 486. Examples of Time Series Data includes but is not limited to data related to detection of large changes in prediction performance, finding unusual correlations between Structured and Unstructured data values and their Non-Feature data characteristics, etc. over time. Time Series Data may be utilized by 510 Method to Recalibrate an Implemented Predictive Policy. In one embodiment, AI Controller 21 may capture Time Series Data on a continuous basis and assign a unique identifier based on pre-determined blocks of time, for example, 1 minute, 5 minutes, 1 hour, etc. In another embodiment, AI Controller 21 may capture Time Series Data in accordance with a pre-determined schedule and assign a unique identifier based on the schedule. In this embodiment, AI System Controller 21 may send Time Series Data to Human Monitor interface 53. Other processes may be used to capture Time Series Data without departing from the spirit and scope of the exemplar method.

In Step 488, Time Series Data collected and their unique identifiers are stored in Time Series Data 70. In one embodiment, AI System Controller 21 may store collected Time Series Data and their unique identifiers in Time Series Data 70 on a continuous basis. In another embodiment, AI System Controller 21 may store collected Time Series Data and their unique identifiers in Time Series Data 70 based on a pre-determined schedule. Other processes may be used to store collected Time Series Data without departing from the spirit and scope of the exemplar method. Modifications, additions, or omissions may be made to the Method to Implement a Predictive Policy without departing from the scope of the method. The method may include more, fewer, or other steps. Additionally, steps may be performed in any suitable order.

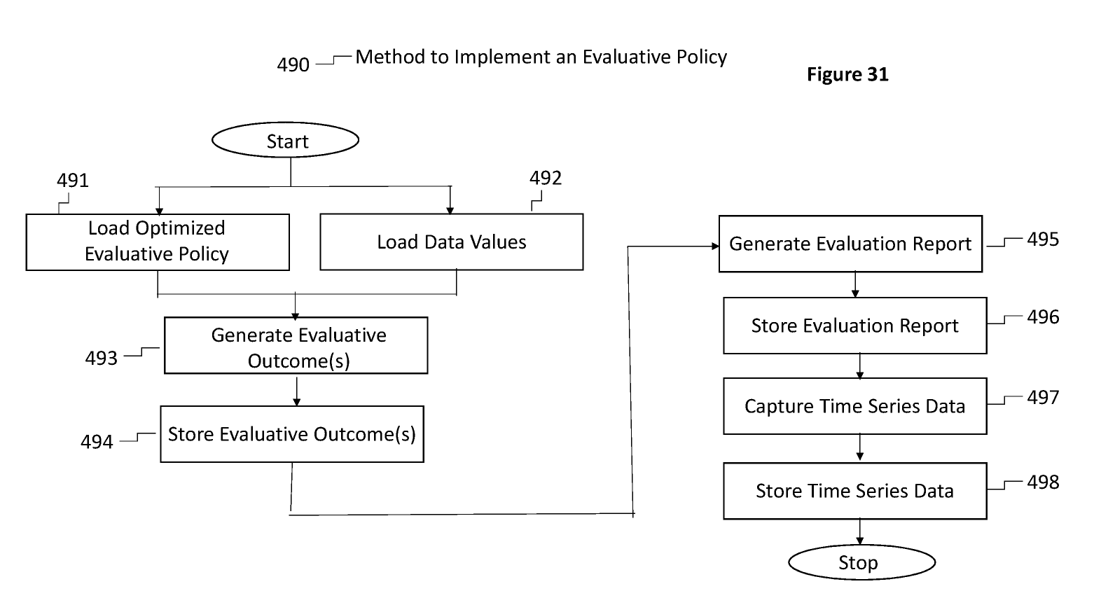

FIG. 31 illustrates one embodiment of AI System Controller 21 and/or Human Monitor interface 53 working in conjunction with Implementation Engine 40, Knowledge Base 62, Evaluative Outcomes 65, Client Database 51, Dialer/DB 52, Evaluation Report 68, and Time Series Data 70 as exemplary Method 490, Method to Implement an Evaluative Policy in a Customer's System.

In Step 491, AI System Controller 21 or Human Monitor interface 53 initiates a process to implement an Optimized Evaluative Policy generated in 470 Method to Optimize a Policy, and load an Optimized Evaluative Policy into Implementation Engine 40 for processing. In one embodiment, AI System Controller 21 may access Knowledge Base 62, retrieve an Optimized Evaluative Policy, and load the Optimized Evaluative Policy based on its unique identifier into Implementation Engine 40 for processing. In another embodiment, Human Monitor interface 53 may access Knowledge Base 62, retrieve an Optimized Evaluative Policy based on its unique identifier, and load the identified Prediction Policy into Implementation Engine 40 for processing. Other processes may be used to load an Optimized Evaluative Policy into Implementation Engine 40 for processing without departing from the spirit and scope of the exemplar method.

In Step 492, AI System Controller 21 or Human Monitor interface 53 may load New Data Values for Structured and Unstructured Data for the Optimized Evaluative Policy loaded in Step 491 into Implementation Engine 40. New Data Values for Structured and Unstructured Data are data not processed and utilized previously. In one embodiment, AI System Controller 21 may access Knowledge Base 62, retrieve New Data Values for Structured and Unstructured Data for the Optimized Evaluative Policy loaded in Step 491, and load New Data Values for Structured and Unstructured Data into Implementation Engine 40 for processing. In another embodiment, Human Monitor interface 53 may access Knowledge Base 62, retrieve New Data Values for Structured and Unstructured Data for the Optimized Evaluative Policy loaded in Step 491, and load New Data Values for Structured and Unstructured Data into Implementation Engine 40 for processing. Other processes may be used to load New Data Values for Structured and Unstructured Data for the Optimized Evaluative Policy loaded in Step 491 into Implementation Engine 40 without departing from the spirit and scope of the exemplar method.

In Step 493, Implementation Engine 40 generates Evaluative Outcome(s). In one embodiment utilizing New Data Values loaded in Step 492, Implementation Engine 40 may utilize 300 Method to Utilize Evaluative Policies to Generate Evaluative Outcomes as described by Step 304. In Method 300, Evaluative Policy input is replaced with an Optimized Evaluative Policy loaded in Step 491. Other processes may be used to generate Evaluative Outcome(s) without departing from the spirit and scope of the exemplar method.

In Step 494, Evaluative Outcome(s) generated in Step 493 is stored in Knowledge Base 62 and Evaluative Outcomes 65. In one embodiment, AI System Controller 21 may instruct Implementation Engine 40 to assign a unique identifier to Evaluative Outcome(s) generated in Step 493 and its unique identifier in Knowledge Base 62 and Evaluative Outcomes 65. In another embodiment, Human Monitor interface 53 may instruct Implementation Engine 40 to assign a unique identifier to Evaluative Outcome(s) generated in Step 493 and store Evaluative Outcome(s) and its unique identifier in Knowledge Base 62 and Evaluative Outcomes 65. Other processes may be used to store Evaluative Outcome(s) without departing from the spirit and scope of the exemplar method.

In Step 495, Implementation Engine 40 generates an Evaluation Report. Evaluation Reports may include but are not limited to a database table containing evaluations of Floor Agent or customer emotional-based behaviors, a tabular text file containing evaluations of Floor Agent or customer emotional-based behaviors, update of a Call Center's Quality Assurance Application containing evaluations of Floor Agent or customer emotional-based behaviors, etc. In one embodiment, Implementation Engine 40 utilizes Evaluative Outcome(s) generated in Step 493 to generate an Evaluation Report and assign it a unique identifier. In this embodiment, AI System Controller 21 may send Evaluation Report to Human Monitor interface 53, and/or Client Database 51, and/or Dialer/DB 52. Other processes may be used to generate an Evaluation Report without departing from the spirit and scope of the exemplar method.

In Step 496, Evaluation Report and its unique identifier is stored in Evaluation Report 68. In one embodiment, AI System Controller 21 may instruct Implementation Engine 40 to store Evaluation Report and its unique identifier in Evaluation Report 68. In another embodiment, Human Monitor interface 53 may instruct Implementation Engine 40 to store Evaluation Report and its unique identifier in Evaluation Report 68. Other processes may be used to store Evaluation Report without departing from the spirit and scope of the exemplar method.

In Step 497, AI Controller may capture Time Series Data for an Evaluation Report generated in Step 496. Examples of Time Series Data includes but is not limited to data related to detection of large changes in prediction performance, finding unusual correlations between Structured and Unstructured data values and their Non-Feature data characteristics, etc. over time. Time Series Data may be utilized by 520 Method to Recalibrate an Implemented Evaluative Policy. In one embodiment, AI Controller 21 may capture Time Series Data on a continuous basis and assign a unique identifier based on pre-determined blocks of time, for example, 1 minute, 5 minutes, 1 hour, etc. In another embodiment, AI Controller 21 may capture Time Series Data in accordance with a pre-determined schedule and assign a unique identifier based on the schedule. In this embodiment, AI System Controller 21 may send Time Series Data to Human Monitor interface 53. Other processes may be used to capture Time Series Data without departing from the spirit and scope of the exemplar method.

In Step 498, Time Series Data collected and their unique identifiers are stored in Time Series Data 70. In one embodiment, AI System Controller 21 may store collected Time Series Data and their unique identifiers in Time Series Data 70 on a continuous basis. In another embodiment, AI System Controller 21 may store collected Time Series Data and their unique identifiers in Time Series Data 70 based on a pre-determined schedule. Other processes may be used to store collected Time Series Data without departing from the spirit and scope of the exemplar method.

Modifications, additions, or omissions may be made to the Method to implement Evaluation Policy without departing from the scope of the method. The method may include more, fewer, or other steps. Additionally, steps may be performed in any suitable order.

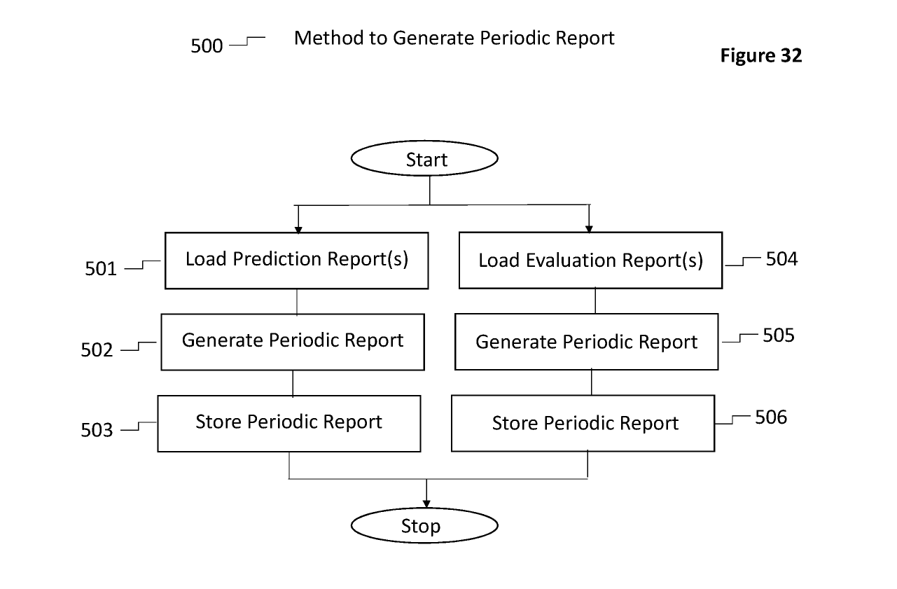

FIG. 32 illustrates one embodiment of AI System Controller 21 and/or Human Monitor interface 53 working in conjunction with Implementation Engine 40, Client Database 51, Prediction Report 67, Evaluation Report 68, and Periodic Report 69 as exemplary Method 500, Method to Generate Periodic Report. A Periodic Report summarizes Prediction Report(s) and contains recommended changes to Business Directives.

In Step 501, AI System Controller 21 or Human Monitor interface 53 initiates a process to generate a Periodic Report, and load Prediction Report(s) based on their unique identifiers into Implementation Engine 40 for processing. In one embodiment, AI System Controller 21 may access Prediction Report 67, retrieve Prediction Report(s) based on their unique identifiers, and load the Prediction Report(s) into Implementation Engine 40 for processing. In another embodiment, Human Monitor interface 53 may access Prediction Report 67, retrieve Prediction Report(s) based on their unique identifiers, and load the Prediction Report(s) into Implementation Engine 40 for processing. Other processes may be used to load Prediction Report(s) into Implementation Engine 40 for processing without departing from the spirit and scope of the exemplar method.

In Step 502, Implementation Engine 40 generates a Periodic Report based on Prediction Report(s) loaded in Step 501, containing recommendations of changes to Business Directives, and assigns a unique identifier to the Periodic Report. In one embodiment, Implementation Engine 40 summarizes Prediction Report(s) loaded in Step 501 and based on the contents of Prediction Report(s) recommends changes to Business Directives. In this embodiment, AI System Controller 21 may assign a unique identifier to the Periodic Report. In this embodiment, AI System Controller 21 may send Periodic Report to Human Monitor interface 53, and/or Client Database 51. Other processes may be used to generate a Periodic Report without departing from the spirit and scope of the exemplar method.

In Step 503, Periodic Report generated in Step 502, and its unique identifier is stored in Periodic Report 69. In one embodiment, AI System Controller 21 may instruct Implementation Engine 40 to store Periodic Report and its unique identifier in Periodic Report 67. In another embodiment, Human Monitor interface 53 may instruct Implementation Engine 40 to store Periodic Report and its unique identifier in Periodic Report 67. Other processes may be used to store Periodic Report without departing from the spirit and scope of the exemplar method.

In Step 504, AI System Controller 21 or Human Monitor interface 53 loads Evaluation Report(s) into Implementation Engine 40 for processing. In one embodiment, AI System Controller 21 may access Evaluation Report 68, retrieve Evaluation Report(s) based on their unique identifiers, and load the Evaluation Report(s) into Implementation Engine 40 for processing. In another embodiment, Human Monitor interface 53 may access Evaluation Report 68, retrieve Evaluation Report(s) based on their unique identifiers, and load the Evaluation Report(s) into Implementation Engine 40 for processing. Other processes may be used to load Evaluation Report(s) into Implementation Engine 40 for processing without departing from the spirit and scope of the exemplar method.

In Step 505, Implementation Engine 40 generates a Periodic Report based on Evaluation Report(s) loaded in Step 504, containing recommendations of changes to Business Directives and assigns a unique identifier to the Periodic Report. In one embodiment, Implementation Engine 40 summarizes Evaluation Report(s) loaded in Step 504 and based on the contents of Evaluation Report(s) recommends changes to Business Directives. In this embodiment, AI System Controller 21 may assign a unique identifier to the Periodic Report. In this embodiment, AI System Controller 21 may send Periodic Report to Human Monitor interface 53, and/or Client Database 51. Other processes may be used to generate a Periodic Report without departing from the spirit and scope of the exemplar method.

In Step 506, Periodic Report generated in Step 505 and its unique identifier is stored in Periodic Report 69. In one embodiment, AI System Controller 21 may instruct Implementation Engine 40 to store Periodic Report and its unique identifier in Periodic Report 67. In another embodiment, Human Monitor interface 53 may instruct Implementation Engine 40 to store Periodic Report and its unique identifier in Periodic Report 67. Other processes may be used to store Periodic Report without departing from the spirit and scope of the exemplar method.

Modifications, additions, or omissions may be made to the Method to Generate Periodic Report without departing from the scope of the method. The method may include more, fewer, or other steps. Additionally, steps may be performed in any suitable order.

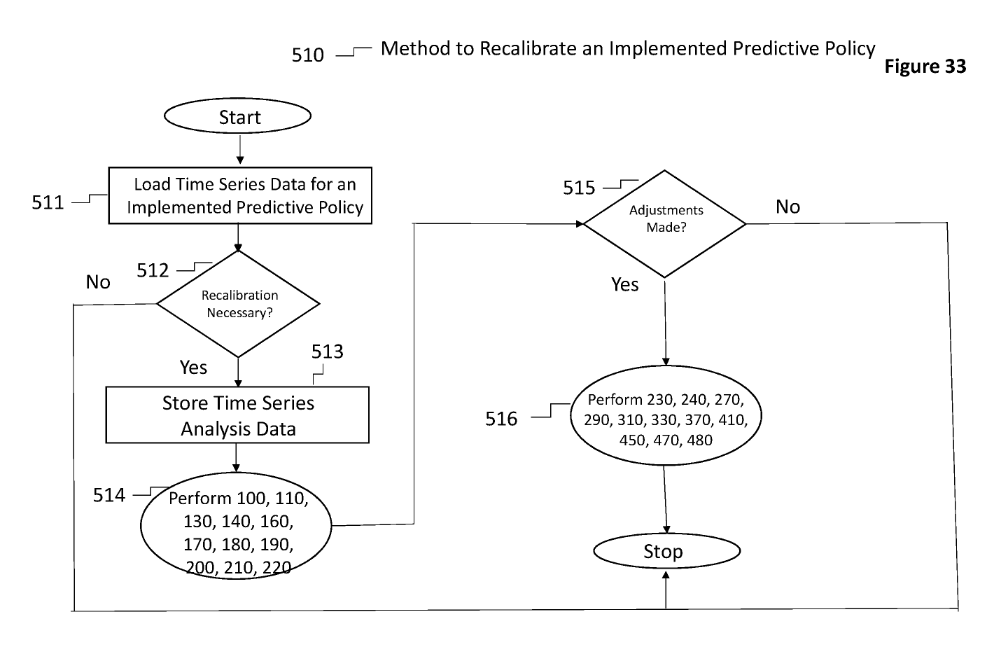

FIG. 33 illustrates one embodiment of AI System Controller 21 and/or Human Monitor interface 53 working in conjunction with Recalibration Engine 41, Seed Knowledge Base 61, Knowledge Base 62, Tools Knowledge Base 63, and Time Series Data 70, as exemplary Method 510, Method to Recalibrate an Implemented Predictive Policy. Over time, the Structured and Unstructured data values may significantly change lowering the effectiveness of a Predictive Policy. Changes in Structured and Unstructured data values may be caused by environment changes, such as economic conditions, changes in Business Operations, such as addition and/or deletion of Books of Business. These changes drive the recalibration of Implemented Predictive Policies.

In Step 511, AI System Controller 21 or Human Monitor interface 53 initiates a process to Recalibrate an Implemented Predictive Policy, and load Time Series Data for an Implemented Predictive Policy into Recalibration Engine 41 for processing. In one embodiment, AI System Controller 21 may access Time Series Data 70, retrieve Time Series Data for an Implemented Predictive Policy based on unique identifiers, and load Time Series Data for an Implemented Predictive Policy into Recalibration Engine 41 for processing. In another embodiment, Human Monitor interface 53 may access Time Series Data 70, retrieve Time Series Data for an Implemented Predictive Policy based on unique identifiers and load Time Series Data for an Implemented Predictive Policy into Recalibration Engine 41 for processing. Other processes may be used to load Time Series Data for an Implemented Predictive Policy into Recalibration Engine 41 without departing from the spirit and scope of the exemplar method.

In Step 512, Recalibration Engine 41 performs analysis on Time Series Data loaded in Step 511 for an Implemented Predictive Policy and determines if recalibration is necessary. In certain embodiments, Recalibration Engine 41 may use various analysis techniques for analyzing Time Series Data for an Implemented Predictive Policy including but not limited to detection of large changes in predictive performance over a set period of time, finding unusual correlations between Structured and Unstructured data values and their Non-Feature data characteristics over a set period of time, etc. In one embodiment, AI System Controller 21 may access Tools Knowledge Base 63 and/or Seed Knowledge Base 61, determine appropriate analytic computation(s) based on time sequences, and provide appropriate analytic computation(s) to Recalibration Engine 41 for use in determining if recalibration of an implemented Predictive Policy is necessary. If Recalibration Engine 41 determines recalibration is necessary, AI System Controller 21 instructs Recalibration Engine 41 to initiate Step 513. If Recalibration Engine 41 determines Recalibration is not necessary, AI System Controller 21 instructs Recalibration Engine 41 to halt the method. Other processes may be used to determine if Recalibration is necessary without departing from the spirit and scope of the exemplar method.

In Step 513, Time Series Analysis data is assigned a unique identifier and is stored in Seed Knowledge Base 61 and/or Knowledge Base 62 for future use. In one embodiment, AI System Controller 21 may instruct Recalibration Engine 41 to assign a unique identifier to Time Series Analysis data and store Time Series Analysis data in Seed Knowledge Base 61 and/or Knowledge Base 62. In another embodiment, Human Monitor interface 53 may instruct Recalibration Engine 41 assign a unique identifier to Time Series Analysis data and store Time Series Analysis data in Seed Knowledge Base 61 and/or Knowledge Base 62. Other processes may be used to store Time Series Analysis data in Seed Knowledge Base 61 and/or Knowledge Base 62 without departing from the spirit and scope of the exemplar method.

In Step 514, AI System Controller 21 or Human Monitor interface 53 initiates a process to make adjustments needed to create or modify Refined Predictive Model(s)/Policy(s). In one embodiment, AI System Controller 21 may utilize one or more of the following Methods to perform adjustments: 100 Method to Perform Structured Data Analysis, 110 Method to Perform Unstructured Data Analysis, 130 Method to Determine Non-Feature Data, 140 Method to Expand Raw Feature Space, 160 Method to Compute Derived Feature Values from Unstructured Feature Values, 170 Method to Determine Initial Feature Set, 180 Method to Determine Feature Vectors, 190 Method to Align Feature Vectors with Prediction Classes, 200 Method to Create Initial Data Points From a Single Feature Vector, 210 Method to Create Initial Data Points From Multiple Aligned Feature Vectors and/or 220 Method to Create Initial Data Point Structure(s). In another embodiment, Human Monitor interface 53 may utilize one or more of the following Methods to perform adjustments: 100 Method to Perform Structured Data Analysis, 110 Method to Perform Unstructured Data Analysis, 130 Method to Determine Non-Feature Data, 140 Method to Expand Raw Feature Space, 160 Method to Compute Derived Feature Values from Unstructured Feature Values, 170 Method to Determine Initial Feature Set, 180 Method to Determine Feature Vectors, 190 Method to Align Feature Vectors with Prediction Classes, 200 Method to Create Initial Data Points From a Single Feature Vector, 210 Method to Create Initial Data Points From Multiple Aligned Feature Vectors and/or 220 Method to Create Initial Data Point Structure(s). Other processes may be used to adjust data needed to create or modify Refined Predictive Model(s)/Policy(s) without departing from the spirit and scope of the exemplar method. Processes may be used in any order determined by AI Controller 21 or Human Monitor interface 53 without departing from the spirit or scope of the exemplar method.

In Step 515, AI System Controller 21 determines if adjustments were made and stored in Step 514. If adjustments were made and stored in Step 514, AI System Controller 21 instructs Recalibration Engine 41 to initiate Step 516. If adjustments were not made and stored in Step 514, AI System Controller 21, instructs Recalibration Engine 41 to halt the Method. Other processes may be used to determine if adjustments were made in Step 514 without departing from the spirit and scope of the exemplar method.

In Step 516, AI System Controller 21 or Human Monitor interface 53 initiates a process to create/refine/implement Refined Predictive Model(s)/Policy(s). In one embodiment, AI System Controller 21 may utilize one or more of the following Methods to create/refine/implement Refined Predictive Model(s)/Policy(s): 230 Method to Create a Predictive or Evaluative Model Using a Single Learning Algorithm, 240 Method to Create a Predictive or Evaluative Model Using a Single Ensemble Technique, 270 Method to Train a Predictive or Evaluative Model, 290 Method to Utilize Predictive Policies to Generate Predictive Outcomes, 310 Method to Validate Predictive Policies, 330 Method to Modify Predictive Model/Policy Learning Algorithm(s) Based on Alteration of Hyperparameters, 370 Method to Change Predictive Model/Policy by Adding/Deleting Learning Algorithm(s), 410 Method to Change Predictive Model/Policy by Changing Ensemble Technique(s), 450 Method to Identify a Leading Candidate Policy, 460 Method to Perform Training Refinement, 470 Method to Optimize a Policy, and/or 480 Method to Implement a Predictive Policy. In another embodiment, Human Monitor interface 53 may utilize one or more of the following Methods to create/refine/implement Refined Predictive Model(s)/Policy(s): 230 Method to Create a Predictive or Evaluative Model Using a Single Learning Algorithm, 240 Method to Create a Predictive or Evaluative Model Using a Single Ensemble Technique, 270 Method to Train a Predictive or Evaluative Model, 290 Method to Utilize Predictive Policies to Generate Predictive Outcomes, 310 Method to Validate Predictive Policies, 330 Method to Modify Predictive Model/Policy Learning Algorithm(s) Based on Alteration of Hyperparameters, 370 Method to Change Predictive Model/Policy by Adding/Deleting Learning Algorithm(s), 410 Method to Change Predictive Model/Policy by Changing Ensemble Technique(s), 450 Method to Identify a Leading Candidate Policy, 460 Method to Perform Training Refinement, 470 Method to Optimize a Policy, and/or 480 Method to Implement a Predictive Policy. Other processes may be used to create/refine/implement Refined Predictive Model(s)/Policy(s) without departing from the spirit and scope of the exemplar method. Processes may be used in any order determined by AI Controller 21 or Human Monitor interface 53 without departing from the spirit or scope of the exemplar method.

Modifications, additions, or omissions may be made to the Method to Recalibrate an Implemented Predictive Policy without departing from the scope of the method. The method may include more, fewer, or other steps. Additionally, steps may be performed in any suitable order.

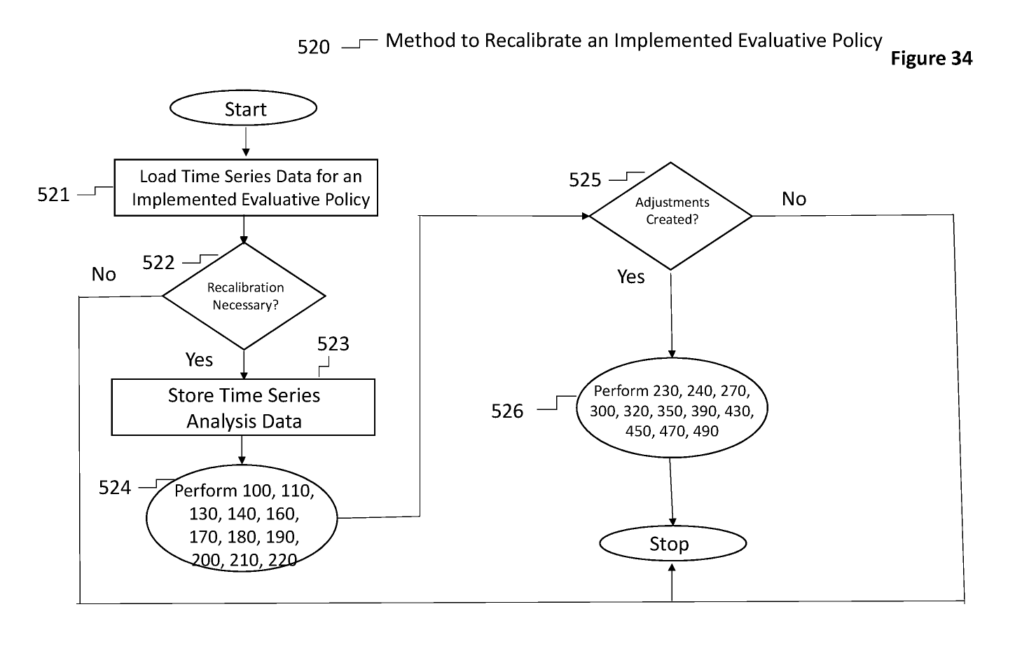

FIG. 34 illustrates one embodiment of AI System Controller 21 and/or Human Monitor interface 53 working in conjunction with Recalibration Engine 41, Seed Knowledge Base 61, Knowledge Base 62, Tools Knowledge Base 63, and Time Series Data 70, as exemplary Method 520, Method to Recalibrate an Implemented Evaluative Policy. Over time, the Structured and Unstructured data values may significantly change lowering the effectiveness of an Evaluative Policy. Changes in Structured and Unstructured data values may be caused by environment changes, such as economic conditions, changes in Business Operations, such as addition and/or deletion Floor Agents. These changes drive the recalibration of Implemented Evaluative Policies.

In Step 521, AI System Controller 21 or Human Monitor interface 53 initiates a process to Recalibrate an Implemented Evaluative Policy, and load Time Series Data for an Implemented Evaluative Policy into Recalibration Engine 41 for processing. In one embodiment, AI System Controller 21 may access Time Series Data 70, retrieve Time Series Data for an Implemented Evaluative Policy based on unique identifiers, and load Time Series Data for an Implemented Evaluative Policy into Recalibration Engine 41 for processing. In another embodiment, Human Monitor interface 53 may access Time Series Data 70, retrieve Time Series Data for an Implemented Evaluative Policy based on unique identifiers, and load Time Series Data for an Implemented Evaluative Policy into Recalibration Engine 41 for processing. Other processes may be used to load Time Series Data for an Implemented Evaluative Policy into Recalibration Engine 41 without departing from the spirit and scope of the exemplar method.

In Step 522, Recalibration Engine 41 performs analysis on Time Series Data loaded in Step 522 for an Implemented Evaluative Policy and determines if recalibration is necessary. In certain embodiments, Recalibration Engine 41 may use various analysis techniques for analyzing Time Series Data for an Implemented Evaluative Policy including but not limited to detection of large changes in predictive performance over a set period of time, finding unusual correlations between Structured and Unstructured data values and their Non-Feature data characteristics over a set period of time, etc. In one embodiment, AI System Controller 21 may access Tools Knowledge Base 63 and/or Seed Knowledge Base 61, determine appropriate analytic computation(s) based on time sequences, and provide appropriate analytic computation(s) to Recalibration Engine 41 for use in determining if recalibration of an Implemented Evaluative Policy is necessary. If Recalibration Engine 41 determines recalibration is necessary, AI System Controller 21 instructs Recalibration Engine 41 to initiate Step 523. If Recalibration Engine 41 determines recalibration is not necessary, AI System Controller 21 instructs Recalibration Engine 41 to halt the method. Other processes may be used to determine if Recalibration is necessary without departing from the spirit and scope of the exemplar method.

In Step 523, Time Series Analysis data is assigned a unique identifier and stored in Seed Knowledge Base 61 and Knowledge Base 62 for future use. In one embodiment, AI System Controller 21 may instruct Recalibration Engine 41 assign a unique identifier to Time Series Analysis data and store Time Series Analysis data in Seed Knowledge Base 61 and/or Knowledge Base 62. In another embodiment, Human Monitor interface 53 may instruct Recalibration Engine 41 assign a unique identifier to Time Series Analysis data and store Time Series Analysis data in Seed Knowledge Base 61 and/or Knowledge Base 62. Other processes may be used to store Time Series Analysis data in Seed Knowledge Base 61 and/or Knowledge Base 62 without departing from the spirit and scope of the exemplar method.

In Step 524, AI System Controller 21 or Human Monitor interface 53 initiates a process to make adjustments needed to create or modify Refined Evaluative Model(s)/Policy(s). In one embodiment, AI System Controller 21 may utilize one or more of the following Methods to perform adjustments: 100 Method to Perform Structured Data Analysis, 110 Method to Perform Unstructured Data Analysis, 130 Method to Determine Non-Feature Data, 140 Method to Expand Raw Feature Space, 160 Method to Compute Derived Feature Values from Unstructured Feature Values, 170 Method to Determine Initial Feature Set, 180 Method to Determine Feature Vectors, 190 Method to Align Feature Vectors with Prediction Classes, 200 Method to Create Initial Data Points From a Single Feature Vector, 210 Method to Create Initial Data Points From Multiple Aligned Feature Vectors and/or 220 Method to Create Initial Data Point Structure(s). In another embodiment, Human Monitor interface 53 may utilize one or more of the following Methods to perform adjustments: 100 Method to Perform Structured Data Analysis, 110 Method to Perform Unstructured Data Analysis, 130 Method to Determine Non-Feature Data, 140 Method to Expand Raw Feature Space, 160 Method to Compute Derived Feature Values from Unstructured Feature Values, 170 Method to Determine Initial Feature Set, 180 Method to Determine Feature Vectors, 190 Method to Align Feature Vectors with Prediction Classes, 200 Method to Create Initial Data Points From a Single Feature Vector, 210 Method to Create Initial Data Points From Multiple Aligned Feature Vectors and/or 220 Method to Create Initial Data Point Structure(s). Other processes may be used to adjust data needed to create or modify Refined Evaluative Model(s)/Policy(s) without departing from the spirit and scope of the exemplar method. Processes may be used in any order determined by AI Controller 21 or Human Monitor interface 53 without departing from the spirit or scope of the exemplar method.

In Step 525, AI System Controller 21 determines if adjustments were made and stored in Step 524. If adjustments were made and stored in Step 524, AI System Controller 21 instructs Recalibration Engine 41 to initiate Step 526. If adjustments were not made and stored in Step 524, AI System Controller 21, instructs Recalibration Engine 41 to halt the Method. Other processes may be used to determine if adjustments were made and stored in Step 524 without departing from the spirit and scope of the exemplar method.

In Step 526, AI System Controller 21 or Human Monitor interface 53 initiates a process to create/refine/implement Refined Evaluative Model(s)/Policy(s). In one embodiment, AI System Controller 21 may utilize one or more of the following Methods to create/refine/implement Refined Predictive Model(s)/Policy(s): 230 Method to Create a Predictive or Evaluative Model Using a Single Learning Algorithm, 240 Method to Create a Predictive or Evaluative Model Using a Single Ensemble Technique, 270 Method to Train a Predictive or Evaluative Model, 300 Method to Utilize Evaluative Policies to Generate Evaluative Outcomes, 320 Method to Validate Evaluative Policies, 350 Method to Modify Evaluative Model/Policy Learning Algorithm(s) Based on Alteration of Hyperparameters, 390 Method to Change Evaluative Model/Policy by Adding/Deleting Learning Algorithm(s), 430 Method to Change Evaluative Model/Policy by Changing Ensemble Technique(s), 450 Method to Identify a Leading Candidate Policy, 460 Method to Perform Training Refinement, 470 Method to Optimize a Policy, and/or 490 Method to Implement an Evaluative Policy. In another embodiment, Human Monitor interface 53 may utilize one or more of the following Methods to create/refine/implement Refined Predictive Model(s)/Policy(s): 230 Method to Create a Predictive or Evaluative Model Using a Single Learning Algorithm, 240 Method to Create a Predictive or Evaluative Model Using a Single Ensemble Technique, 270 Method to Train a Predictive or Evaluative Model, 300 Method to Utilize Evaluative Policies to Generate Evaluative Outcomes, 320 Method to Validate Evaluative Policies, 350 Method to Modify Evaluative Model/Policy Learning Algorithm(s) Based on Alteration of Hyperparameters, 390 Method to Change Evaluative Model/Policy by Adding/Deleting Learning Algorithm(s), 430 Method to Change Evaluative Model/Policy by Changing Ensemble Technique(s), 450 Method to Identify a Leading Candidate Policy, 460 Method to Perform Training Refinement, 470 Method to Optimize a Policy, and/or 490 Method to Implement an Evaluative Policy. Other processes may be used to create/refine/implement Refined Evaluative Model(s)/Policy(s) without departing from the spirit and scope of the exemplar method. Processes may be used in any order determined by AI Controller 21 or Human Monitor interface 53 without departing from the spirit or scope of the exemplar method.

Modifications, additions, or omissions may be made to the Method to Recalibrate an Implemented Evaluative Policy without departing from the scope of the method. The method may include more, fewer, or other steps. Additionally, steps may be performed in any suitable order.

Certain terms are defined below.
Adjustments—Changes made to Rulesets (and correspondingly any input of the overall process) for the purposes of recalibration.
Aggregation Ruleset—(as in Initial Aggregation Ruleset or Refined Aggregation Ruleset) Algorithms that dictate how and which feature vectors are mathematically combined to form data points. The initial form is a pre-set specification to be evaluated, possibly edited, and executed by the Human Monitor interface, while the refined form is automatically maintained, modified, and executed by the AI System Controller which takes over after the first data points are calculated.
AI System Controller—Central logic component which fully automates and coordinates the execution of all procedures and methodologies involved in the overall process of analyzing various structured and unstructured data ultimately to build predictive and/or evaluative mathematical models, and train, implement, and dynamically improve predictive and/or evaluative policies for the purpose of enhancing one or more business processes. It is mainly comprised of all Rulesets plus a Master Rule Set governing the sequence of execution of the others.
Data Point—A feature vector specifically to be used for model training, validation, or evaluation, either formed directly or by aggregation.
Data Point Structure—A collection of Data Points
Data Point Structure Ruleset—(as in Initial Data Point Structure Ruleset or Refined Data Point Structure Ruleset) Algorithms that dictate which data points to include in a data point structure. The initial form is a pre-set specification to be evaluated, possibly edited, and executed by the Human Monitor interface, while the refined form is automatically maintained, modified, and executed by the AI System Controller which takes over after the first data point structure(s) are determined.
Derived Feature—(1) A feature formed by a combination of structured and/or unstructured features that retains the same Non-Feature data values as the input features. For example, a call record's call duration, derived from call end time and call start time, is associated to the same agent ID as the end and start times for that record. (2) A feature formed by a combination of unstructured features that may not retain the same Non-Feature data values as the input features. For example, a derived feature defined as the average of probabilities of expressed happiness over all voice segments in a call cannot be associated with the same start and stop times as its individual inputs.
Emotional Model—A mathematical model that takes a numerical representation of an audio signal containing voice and maps it to the most likely emotion or behavior being expressed therein. Often constructed by a trained machine learning classifier taking as input a signal-based feature vector and providing as output an array of classification probabilities such that the emotion or behavior corresponding to the highest probability is considered the one being expressed.
Evaluation Report—A periodic listing of an implemented evaluative policy's evaluative outcomes, typically packaged with supporting data and analytics, utilized as a guide for managing business operations.
Evaluative Outcome—A computational assessment on the subject of interest, meant to provide an automated rating or categorization for an as-yet unknown but deterministic quality. For example, when the subjects of interest are a business' floor agents, an evaluative policy might output evaluative outcomes that provide a rating of the agent's performance—a quantity that is fixed but has yet to be assessed.
Evaluative Policy—A policy that maps data points to evaluative outcomes.
Feature Derivation Ruleset—(as in Initial Feature Derivation Ruleset or Refined Feature Derivation Ruleset) Algorithms that dictate how and which structured and/or unstructured features are combined to form new, derived features (see Derived Features (1)). The initial form is a pre-set specification to be evaluated, possibly edited, and executed by the Human Monitor interface, while the refined form is automatically maintained, modified, and executed by the AI System Controller which takes over after the first derived feature(s) are calculated.
Feature Selection Ruleset—(as Initial Feature Selection Ruleset or Refined Feature Selection Ruleset) Algorithms that dictate which features within the feature space to include in a feature set. The initial form is a pre-set specification to be evaluated, possibly edited, and executed by the Human Monitor interface, while the refined form is automatically maintained, modified, and executed by the AI System Controller which takes over after the first feature set(s) are determined.
Feature Set—(as in Initial Feature Set or Refined Feature Set) A subset of features from the feature space of which feature vectors are comprised (when designated in a specific order).
Initial—(as in Initial Data Point, Initial Data Point Structure, Initial Ruleset, etc.) A qualification that indicates the state of the item before training refinement or recalibration occurs. Some Rulesets are only in their initial states until their first execution is carried out (but still prior to model training); see individual Ruleset entries for details.
Leading Candidate Policy—The highest performing/“fittest” policy at any given iteration of training refinement.
Mapping Ruleset—(as in Initial Mapping Ruleset or Refined Mapping Ruleset) Algorithms that assign a prediction class to a feature vector or a data point. The initial form is a pre-set specification to be evaluated, possibly edited, and executed by the Human Monitor interface, while the refined form is automatically maintained, modified, and executed by the AI System Controller which takes over after the first mappings are performed.
Master Rule Set—(as in Initial Master Rule Set or Refined Master Rule Set) Collection of all other Rulesets. In its initial form prior to training refinement or recalibration and its refined form thereafter.
Non-Feature Generation Ruleset—(as in Initial Non-Feature Generation Ruleset or Refined Non-Feature Generation Ruleset) A set of specifications and/or calculations that designate which data items, whether structured or unstructured, are not to be considered for inclusion in the raw feature space and which may or may not be used to filter, derive, transform, aggregate, or correlate features, feature vectors, data points, or data point structures. The initial form is a pre-set specification to be evaluated, possibly edited, and executed by the Human Monitor interface, while the refined form is automatically maintained, modified, and executed by the AI System Controller which takes over after training refinement or recalibration.
Optimized Evaluative Policy—The highest performing/“fittest” evaluative policy resulting from training refinement or recalibration. The same as the leading candidate policy after the last iteration of training refinement.
Optimized Predictive Policy—The highest performing/“fittest” predictive policy resulting from training refinement or recalibration. The same as the leading candidate policy after the last iteration of training refinement.
Policy—A trained machine learning model that maps data points to likelihoods of prediction class membership.
Prediction Report—A periodic listing of an implemented predictive policy's predictive outcomes, typically packaged with supporting data and analytics, providing a set of business directives meant to elicit the desirable outcomes and avoid or mitigate the undesirable outcomes.
Predictive Outcome—A computational assessment on the subject of interest, meant to indicate the result of an event which has yet to occur. For example, when the subjects of interest are a business' customers, a predictive policy might output predictive outcomes that estimate the likeliness of a customer to make a purchase if called—a quantity that cannot be known until that customer is called.
Predictive Policy—A policy that maps data points to predictive outcomes.
Raw Feature Space—The set of all possible features.
Refined—(as in Initial Data Point, Initial Data Point Structure, Initial Ruleset, etc.) A qualification that indicates the state of an item after training refinement or recalibration occurs. Some Rulesets transition to their refined states immediately after their first execution is carried out (but still prior to model training); see individual Ruleset entries for details.
Refinements—Changes made to Rulesets (and correspondingly any input of the overall process) for the purposes of training refinement.
Ruleset—Any decision logic that may be executed to create, designate, determine, or otherwise provide the required inputs of a particular method that would otherwise be manually carried out by the Human Monitor interface.
Singular Derived Feature—Synonym for features derived by the transformation ruleset.
Structured Feature Generation Ruleset—(as in Initial Structured Feature Generation Ruleset or Refined Structured Feature Generation Ruleset) A set of specifications and/or calculations that designate which structured data items are to be considered for inclusion in the raw feature space. The initial form is a pre-set specification to be evaluated, possibly edited, and executed by the Human Monitor interface, while the refined form is automatically maintained, modified, and executed by the AI System Controller which takes over after training refinement or recalibration.
Target Function Evaluation—Performance metric that indicates comparable policy performance, used to select the highest performing/“fittest” policy during training refinement or recalibration.
Transformation Ruleset—(as in Initial Transformation Ruleset or Refined Transformation Ruleset) Algorithms that dictate how and which unstructured features are combined to form new, derived features (see Derived Features (2)). The initial form is a pre-set specification to be evaluated, possibly edited, and executed by the Human Monitor interface, while the refined form is automatically maintained, modified, and executed by the AI System Controller which takes over after the first derived feature(s) are calculated.
Unstructured Feature Generation Ruleset—(as Initial Unstructured Feature Generation Ruleset or Refined Unstructured Feature Generation Ruleset) A set of specifications and/or calculations that designate which unstructured data items are to be considered for inclusion in the raw feature space. The initial form is a pre-set specification to be evaluated, possibly edited, and executed by the Human Monitor interface, while the refined form is automatically maintained, modified, and executed by the AI System Controller which takes over after training refinement or recalibration.
Validation Data Point Structure—Data point structure used exclusively by validation methods. Likewise, no data point structure used for training a model can be used, whole or in part, as a validation data point structure when validating that particular model.

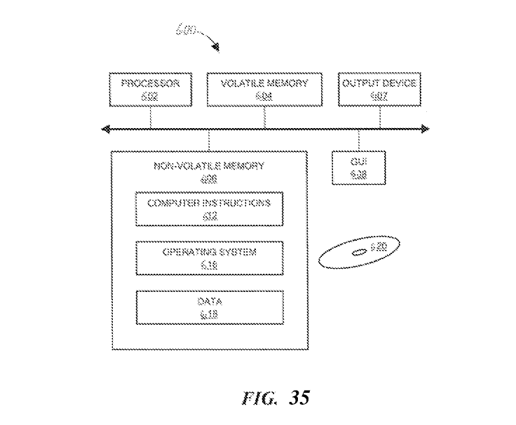

FIG. 35 shows an exemplary computer 800 that can perform at least part of the processing described herein. The computer 800 includes a processor 802, a volatile memory 804, a non-volatile memory 806 (e.g., hard disk), an output device 807 and a graphical user interface (GUI) 808 (e.g., a mouse, a keyboard, a display, for example). The non-volatile memory 806 stores computer instructions 812, an operating system 816 and data 818. In one example, the computer instructions 812 are executed by the processor 802 out of volatile memory 804. In one embodiment, an article 820 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

From the foregoing detailed descriptions of the Figures, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data that cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A computer implemented method for processing business and voice data in a call center, comprising of an Artificial Intelligent Controller utilized to configure, provide logic for, and manage system components and methods to predict or evaluate business outcomes.

2. The method of claim 1 wherein processing of business and voice data further comprises an Artificial Intelligent Controller utilized to configure, provide logic for, and manage system components and methods to analyze business and voice data comprising of:
receiving structured business data;
receiving call data and call metadata;
determining structured features;
generating unstructured data from call data;
determining unstructured features;
generating derived non-feature data from structured business data, call data and metadata, and unstructured data;
generating a raw feature space from structured business data, call data and call metadata, and unstructured data; and
generating derived features from existing features in the raw feature space.

3. The method of claim 1 wherein predict or evaluate business outcomes further comprises use of an Artificial Intelligent Controller utilized to configure, provide logic for, and manage system components and methods to generate inputs for model building comprising of:
receiving raw feature space;
analyzing raw feature space;
generating initial feature set comprising of feature vectors generated by raw feature space analysis;
associating feature vectors with prediction classes;
generating initial data point(s) comprising of a single feature vector aligned with a prediction class, or an aggregate of feature vectors aligned with a prediction class; and
generating of initial data point structure comprising of data points(s).

4. The method of claim 1 wherein predict or evaluate business outcomes further comprises use of an Artificial Intelligent Controller utilized to configure, provide logic for, and manage system components and methods to generate predictive or evaluative model(s) comprising of:
receiving learning algorithm(s);
receiving hyperparameter set(s);
configuring learning algorithm; and
generating predictive or evaluative model(s).

5. The method of claim 1 wherein predict or evaluate business outcomes further comprises use of an Artificial Intelligent Controller utilized to configure, provide logic for, and manage system components and methods to generate predictive or evaluative model(s) comprising of:
receiving initial data point structure;
receiving learning algorithm(s);
receiving hyperparameter set(s);
receiving ensemble technique(s);
configuring learning algorithm; and
generating predictive or evaluative model(s).

6. The method of claim 1 wherein predict or evaluate business outcomes further comprises use of an Artificial Intelligent Controller utilized to configure, provide logic for, and manage system components and methods to train predictive or evaluative model(s) comprising of:
receiving predictive or evaluative model;
receiving initial data point structure(s);
training predictive or evaluative model(s); and
generating predictive or evaluative policy(s).

7. The method of claim 1 wherein predict or evaluate business outcomes further comprises use of an Artificial Intelligent Controller utilized to configure, provide logic for, and manage system components and methods to generate predictive or evaluative outcome(s) comprising of:
receiving data point;
receiving predictive or evaluative policy; and
generating predictive or evaluative outcome(s).

8. The method of claim 1 wherein predict or evaluate business outcomes further comprises use of an Artificial Intelligent Controller utilized to configure, provide logic for, and manage system components and methods to validate predictive or evaluative policy(s) comprising of:
receiving predictive or evaluative policy(s);
receiving validation data point structure(s);
receiving data points;
generating outcomes; and
generating performance metrics.

9. The method of claim 1 wherein predict or evaluate business outcomes further comprises use of an Artificial Intelligent Controller utilized to configure, provide logic for, and manage system components and methods to modify predictive or evaluative policy comprising of:
receiving predictive or evaluative policy;
receiving hyperparameter set(s);
receiving performance metrics;
analyzing hyperparameter(s);
modifying hyperparameter;
generating new predictive or evaluative model(s);
training new predictive or evaluative model(s);
generating new predictive or evaluative outcome(s);
validating new predictive or evaluative policy(s);
comparing new and old predictive or evaluative outcomes; and
determining predictive or evaluative policy improvement.

10. The method of claim 1 wherein predict or evaluate business outcomes further comprises use of an Artificial Intelligent Controller utilized to configure, provide logic for, and manage system components and methods to modify predictive or evaluative policy comprising of:
receiving predictive or evaluative policy;
receiving algorithm ensemble;
receiving hyperparameter set(s);
receiving performance metrics;
adding or deleting algorithm(s);
generating new predictive or evaluative model(s);
training new predictive or evaluative model(s);
generating new predictive or evaluative outcome(s);
validating new predictive or evaluative policy(s);
comparing new and old predictive or evaluative outcomes; and
determining predictive or evaluative policy improvement.

11. The method of claim 1 wherein predict or evaluate business outcomes further comprises use of an Artificial Intelligent Controller utilized to configure, provide logic for, and manage system components and methods to modify predictive or evaluative policy comprising of:
receiving predictive or evaluative policy;
receiving configured algorithm ensemble;
receiving ensemble techniques;
receiving performance metrics;
evaluating ensemble techniques;
generating new predictive or evaluative model(s);
training new predictive or evaluative model(s);
generating new predictive or evaluative outcome(s);
validating new predictive or evaluative policy(s);
comparing new and old predictive or evaluative outcomes; and
determining predictive or evaluative policy improvement.

12. The method of claim 1 wherein predict or evaluate business outcomes further comprises use of an Artificial Intelligent Controller utilized to configure, provide logic for, and manage system components and methods to identify a leading candidate predictive or evaluative policy comprising of:
receiving predictive or evaluative policy;
receiving performance metrics; and
evaluating performance metrics.
